(19) United States
(12) Patent Application Publication
(10) Pub. No.: US 2026/0164064 A1
(43) Pub. Date: Jun. 11, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Zhipin DENG, Beijing (CN); Kai ZHANG, Los Angeles, CA (US); Li ZHANG, Los Angeles, CA (US)

(21) Appl. No.: 19/180,947

(22) Filed: Apr. 16, 2025

Related U.S. Application Data
(63) Continuation of application No. PCT/CN2023/124820, filed on Oct. 16, 2023.

(30) Foreign Application Priority Data
Oct. 17, 2022 (WO) PCT/CN2022/125735

(51) Int. Cl. H04N 19/61; H04N 19/11; H04N 19/176

(52) U.S. Cl. CPC H04N 19/61; H04N 19/11; H04N 19/176

(57) ABSTRACT

Embodiments of the present disclosure provide a solution for video processing. A method for video processing is proposed. The method comprises: obtaining, for a conversion between a current video block of a video and a bitstream of the video, an intra mode for the current video block, the intra mode being determined based on at least one of the following: information associated with neighboring samples of the current video block, or a prediction associated with the current video block; applying a transform process on the current video block based on the intra mode; and performing the conversion based on the applying.

### CROSS REFERENCE TO RELATED APPLICATIONS

This application is a continuation of International Application No. PCT/CN2023/124820, filed on Oct. 16, 2023, which claims the benefit of International Application No. PCT/CN2022/125735, filed on Oct. 17, 2022. The entire contents of these applications are hereby incorporated by reference in their entireties.

### FIELDS

Embodiments of the present disclosure relates generally to video processing techniques, and more particularly, to video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: obtaining, for a conversion between a current video block of a video and a bitstream of the video, an intra mode for the current video block, the intra mode being determined based on at least one of the following: information associated with neighboring samples of the current video block, or a prediction associated with the current video block; applying a transform process on the current video block based on the intra mode; and performing the conversion based on the applying.

According to the method in accordance with the first aspect of the present disclosure, an intra mode used for a transform process is determined by considering information associated with neighboring samples of a video block and/or a prediction associated with the video block. Compared with the conventional solution, the proposed method can advantageously improve the coding efficiency.

In a second aspect, another method for video processing is proposed. The method comprises: obtaining, for a conversion between a current video block of a video and a bitstream of the video, information regarding applying a Karhunen-Loeve transform (KLT) on the current video block, the information being dependent on transform coefficients of the current video block; and performing the conversion based on the information.

According to the method in accordance with the second aspect of the present disclosure, information regarding applying a KLT on a video block is dependent on transform coefficients of the video block. Compared with the conventional solution, the proposed method can advantageously improve the coding efficiency.

In a third aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a fourth aspect, a non-transitory computer-readable storage medium is proposed. The non-transitory computer-readable storage medium stores instructions that cause a processor to perform a method in accordance with the first aspect of the present disclosure.

In a fifth aspect, another non-transitory computer-readable recording medium is proposed. The non-transitory computer-readable recording medium stores a bitstream of a video which is generated by a method performed by an apparatus for video processing. The method comprises: obtaining an intra mode for a current video block of the video, the intra mode being determined based on at least one of the following: information associated with neighboring samples of the current video block, or a prediction associated with the current video block; applying a transform process on the current video block based on the intra mode; and generating the bitstream based on the applying.

In a sixth aspect, a method for storing a bitstream of a video is proposed. The method comprises: obtaining an intra mode for a current video block of the video, the intra mode being determined based on at least one of the following: information associated with neighboring samples of the current video block, or a prediction associated with the current video block; applying a transform process on the current video block based on the intra mode; generating the bitstream based on the applying; and storing the bitstream in a non-transitory computer-readable recording medium.

In a seventh aspect, another non-transitory computer-readable recording medium is proposed. The non-transitory computer-readable recording medium stores a bitstream of a video which is generated by a method performed by an apparatus for video processing. The method comprises: obtaining information regarding applying a Karhunen-Loeve transform (KLT) on a current video block of the video, the information being dependent on transform coefficients of the current video block; and generating the bitstream based on the information.

In an eighth aspect, a method for storing a bitstream of a video is proposed. The method comprises: obtaining information regarding applying a Karhunen-Loeve transform (KLT) on a current video block of the video, the information being dependent on transform coefficients of the current video block; generating the bitstream based on the information; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates positions of spatial merge candidate;

FIG. 5 illustrates candidate pairs considered for redundancy check of spatial merge candidates;

FIG. 6 illustrates motion vector scaling for temporal merge candidate;

FIG. 7 illustrates candidate positions for temporal merge candidate, C₀ and C₁;

FIG. 8 illustrates MMVD search point;

FIG. 9 illustrates extended CU region used in BDOF;

FIG. 10 illustrates symmetrical MVD mode;

FIG. 11 illustrates control point based affine motion model;

FIG. 12 illustrates affine MVF per subblock;

FIG. 13 illustrates locations of inherited affine motion predictors;

FIG. 14 illustrates control point motion vector inheritance;

FIG. 15 illustrates locations of candidates position for constructed affine merge mode;

FIG. 16 is an illustration of motion vector usage for proposed combined method;

FIG. 17 illustrates subblock MV VSB and pixel Δv(i,j);

FIG. 18A illustrates spatial neighboring blocks used by ATVMP;

FIG. 18B illustrates deriving sub-CU motion field by applying a motion shift from spatial neighbor and scaling the motion information from the corresponding collocated sub-CUs;

FIG. 19 illustrates extended CU region used in BDOF;

FIG. 20 illustrates decoding side motion vector refinement;

FIG. 21 illustrates top and left neighboring blocks used in CIIP weight derivation;

FIG. 22 illustrates examples of the GPM splits grouped by identical angles;

FIG. 23 illustrates uni-prediction MV selection for geometric partitioning mode;

FIG. 24 illustrates exemplified generation of a bending weight w₀ using geometric partitioning mode;

FIG. 25 illustrates spatial neighboring blocks used to derive the spatial merge candidates;

FIG. 26 illustrates template matching performs on a search area around initial MV;

FIG. 27 illustrates diamond regions in the search area;

FIG. 28 illustrates frequency responses of the interpolation filter and the VVC interpolation filter at half-pel phase;

FIG. 29 illustrates template and reference samples of the template in reference pictures;

FIG. 30 illustrates template and reference samples of the template for block with sub-block motion using the motion information of the subblocks of the current block;

FIG. 31 illustrates padding candidates for the replacement of the zero-vector in the IBC list.

FIG. 32 illustrates IBC reference region depending on current CU position;

FIG. 33 illustrates reference area for IBC when CTU (m,n) is coded. The blue block denotes the current CTU; green blocks denote the reference area; and the white blocks denote invalid reference area;

FIG. 34 illustrates first HPT and the second HPT;

FIG. 35 illustrates spatial neighbors for deriving affine merge/AMVP candidates;

FIG. 36 illustrates from non-adjacent neighbors to the first type of constructed affine merge/AMVP candidates;

FIG. 37 illustrates Low-Frequency Non-Separable Transform (LFNST) process;

FIG. 38 illustrates SBT position, type and transform type;

FIG. 39 illustrates the ROI for LFNST 16;

FIG. 40 illustrates the ROI for LFNST 8;

FIG. 41 illustrates discontinuity measure;

FIG. 42 illustrates a flowchart of a method for video processing in accordance with embodiments of the present disclosure;

FIG. 43 illustrates a flowchart of a method for video processing in accordance with embodiments of the present disclosure; and

FIG. 44 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

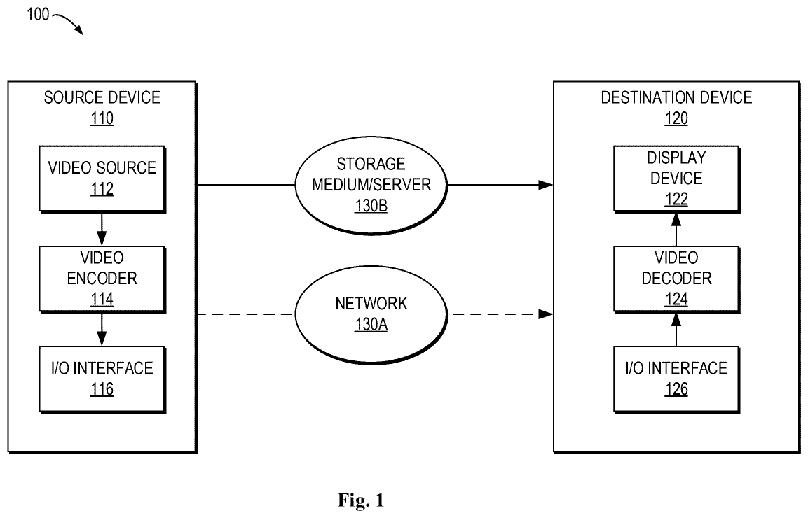

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

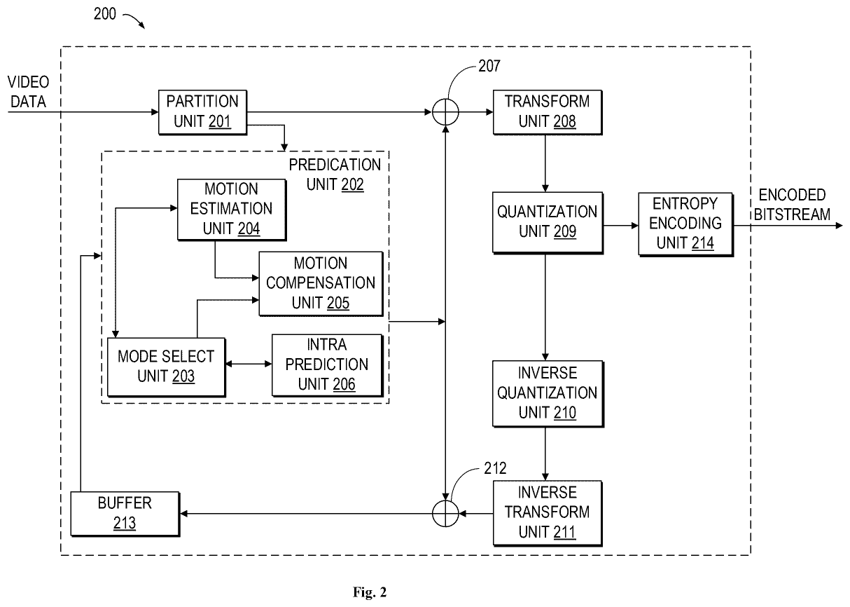

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

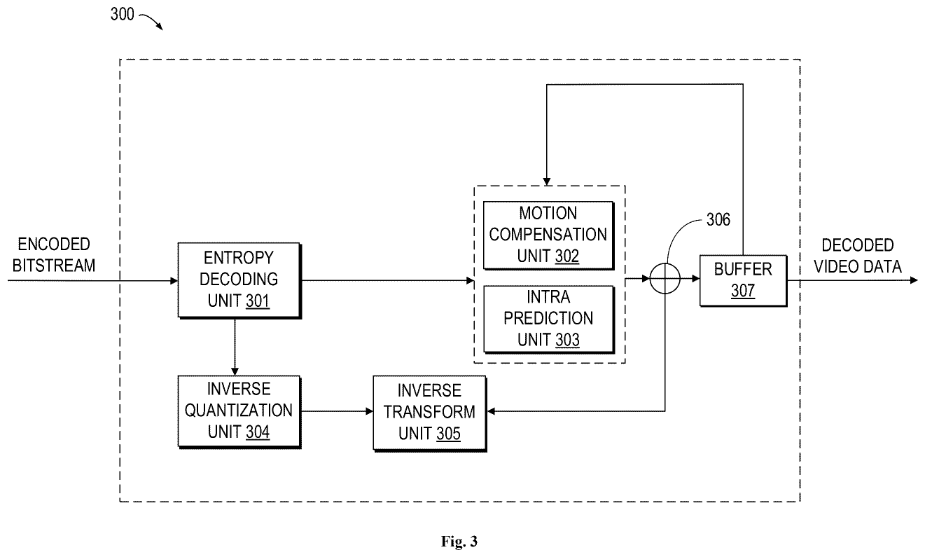

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

Embodiments of the present disclosure are related to video coding technologies. Specifically, it is about coding techniques related to transform, screen content coding, and local illuminance compensation in image/video coding. It may be applied to the existing video coding standard like HEVC, VVC, ECM, and etc. It may be also applicable to future video coding standards or video codec.

### 2. INTRODUCTION

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting. In January 2021, JVET established an Exploration Experiment (EE), targeting at enhanced compression efficiency beyond VVC capability with novel traditional algorithms. ECM was built soon after as the common software base for longer-term exploration work towards the next generation video coding standard.

### 2.1. Inter Prediction Coding Tools

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring Cus, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction;
Merge mode with MVD (MMVD);
Symmetric MVD (SMVD) signalling;
Affine motion compensated prediction;
Subblock-based temporal motion vector prediction (SbTMVP);
Adaptive motion vector resolution (AMVR);
Motion field storage: 1/16^{th} luma sample MV storage and 8×8 motion field compression;
Bi-prediction with CU-level weight (BCW);
Bi-directional optical flow (BDOF);
Decoder side motion vector refinement (DMVR);
Geometric partitioning mode (GPM);
Combined inter and intra prediction (CIIP).

The following text provides the details on those inter prediction methods specified in VVC.

### 2.1.1. Extended Merge Prediction

In VVC, the merge candidate list is constructed by including the following five types of candidates in order:
1) Spatial MVP from spatial neighbour Cus;
2) Temporal MVP from collocated Cus;
3) History-based MVP from an FIFO table;
4) Pairwise average MVP;
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all Cus within a certain size of area.

### 2.1.1.1. Spatial Candidates Derivation

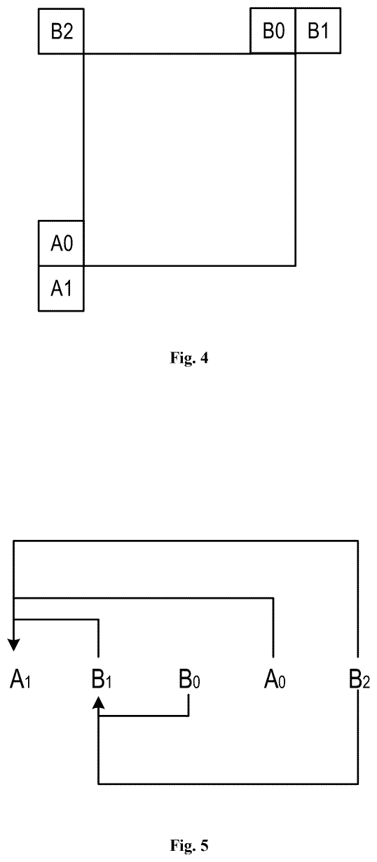

The derivation of spatial merge candidates in VVC is same to that in HEVC except the positions of first two merge candidates are swapped. A maximum of four merge candidates are selected among candidates located in the positions depicted in FIG. 4. The order of derivation is B₀, A₀, B₁, A₁ and B₂. Position B₂ is considered only when one or more than one Cus of position B₀, A₀, B₁, A₁ are not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. Instead, only the pairs linked with an arrow in FIG. 5 are considered and a candidate is only added to the list if the corresponding candidate used for redundancy check has not the same motion information.

### 2.1.1.2. Temporal Candidates Derivation

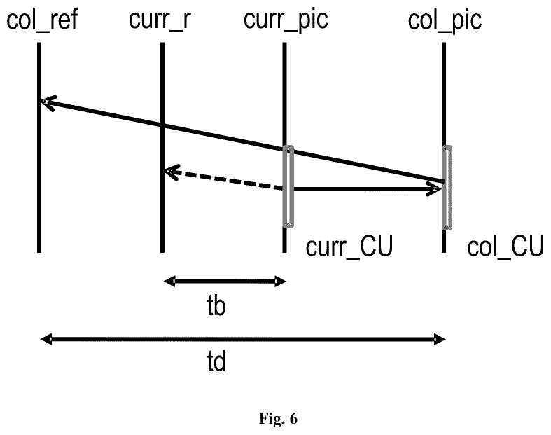

In this step, only one candidate is added to the list. Particularly, in the derivation of this temporal merge candidate, a scaled motion vector is derived based on co-located CU belonging to the collocated referenncee picture. The reference picture list to be used for derivation of the co-located CU is explicitly signalled in the slice header. The scaled motion vector for temporal merge candidate is obtained as illustrated by the dotted line in FIG. 6, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

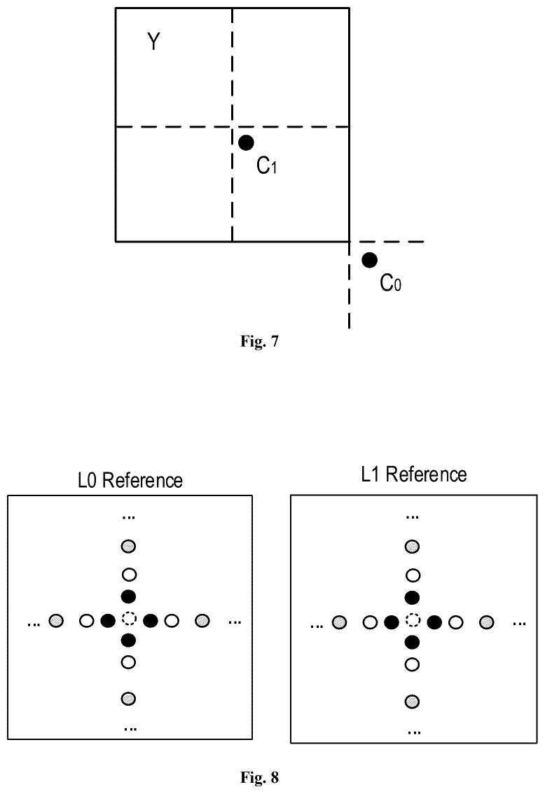

The position for the temporal candidate is selected between candidates C₀ and C₁, as depicted in FIG. 7. If CU at position C₀ is not available, is intra coded, or is outside of the current row of CTUs, position C₁ is used. Otherwise, position C₀ is used in the derivation of the temporal merge candidate.

### History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1. Number of HMPV candidates is used for merge list generation is set as (N<=4)?M: (8−N), wherein N indicates number of existing candidates in the merge list and M indicates number of available HMVP candidates in the table.
2. Once the total number of available merge candidates reaches the maximally allowed merge candidates minus 1, the merge candidate list construction process from HMVP is terminated.

### 2.1.1.3. Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid.

When the merge list is not full after pair-wise average merge candidates are added, the zero MVPs are inserted in the end until the maximum merge candidate number is encountered.

### 2.1.1.4. Merge Estimation Region

Merge estimation region (MER) allows independent derivation of merge candidate list for the Cus in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>>Log 2ParMrgLevel is great than (yCb>>Log 2ParMrgLevel) and where (xCb, yCb) is the top-left luma sample position of the current CU in the picture and (cbWidth, cbHeight) is the CU size. The MER size is selected at encoder side and signalled as log 2_parallel_merge_level_minus2 in the sequence parameter set.

2.1.2. Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a skip flag and merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The merge candidate flag is signalled to specify which one is used.

Distance index specifies motion magnitude information and indicate the pre-defined offset from the starting point. As shown in FIG. 8, an offset is added to either horizontal component or vertical component of starting MV. The relation of distance index and pre-defined offset is specified in Table 1.

TABLE 1
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 2. It's noted that the meaning of MVD sign could be variant according to the information of starting MVs. When the starting MVs is a uni-prediction MV or bi-prediction MVs with both lists point to the same side of the current picture (i.e. POCs of two references are both larger than the POC of the current picture, or are both smaller than the POC of the current picture), the sign in Table 2 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), the sign in Table 2 specifies the sign of MV offset added to the list0 MV component of starting MV and the sign for the list1 MV has opposite value.

TABLE 2
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

2.1.2.1. Bi-Prediction with CU-Level Weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

$${P}_{bi - pred} = ( ( 8 - w ) * {P}_{0} + w * {P}_{1} + 4 ) >> 3 \qquad ( 2 - 1 )$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to Cus with 256 or more luma samples (i.e., CU width times CU height is greater than or equal to 256). For low-delay pictures, all 5 weights are used. For non-low-delay pictures, only 3 weights (w∈{3,4,5}) are used.
At the encoder, fast search algorithms are applied to find the weight index without significantly increasing the encoder complexity. These algorithms are summarized as follows. When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, e.g. equal weight.

### 2.1.2.2. Bi-Directional Optical Flow (BDOF)

The bi-directional optical flow (BDOF) tool is included in VVC. BDOF, previously referred to as BIO, was included in the JEM. Compared to the JEM version, the BDOF in VVC is a simpler version that requires much less computation, especially in terms of number of multiplications and the size of the multiplier.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order.
The distances (i.e. POC difference) from two reference pictures to the current picture are same.
Both reference pictures are short-term reference pictures.
The CU is not coded using affine mode or the ATMVP merge mode.
CU has more than 64 luma samples.
Both CU height and CU width are larger than or equal to 8 luma samples.
BCW weight index indicates equal weight.
WP is not enabled for the current CU.
CIIP mode is not used for the current CU.

BDOF is only applied to the luma component. As its name indicates, the BDOF mode is based on the optical flow concept, which assumes that the motion of an object is smooth. For each 4×4 subblock, a motion refinement (vₓ, v_{y}) is calculated by minimizing the difference between the L0 and L1 prediction samples. The motion refinement is then used to adjust the bi-predicted sample values in the 4×4 subblock. The following steps are applied in the BDOF process.

First, the horizontal and vertical gradients,

$$\frac{\partial {I}^{( k )}}{\partial x} ( i , j ) and \frac{\partial {I}^{( k )}}{\partial y} ( i , j ) , k = 0 , 1 ,$$

of the two prediction signals are computed by directly calculating the difference between two neighboring samples, i.e.,

$$\frac{\partial {I}^{( k )}}{\partial x} ( i , j ) = ( ( {I}^{( k )} ( i + 1 , j ) ) shift 1 ) - ( {I}^{( k )} ( i - 1 , j ) ) shift 1 ) ) \qquad ( 2 - 2 )$$

$$\frac{\partial {I}^{( k )}}{\partial y} ( i , j ) = ( ( {I}^{( k )} ( i , j + 1 ) ) shift 1 ) - ( {I}^{( k )} ( i , j - 1 ) ) shift 1 ) )$$

where I^{(k)}(i, j) are the sample value at coordinate (i, j) of the prediction signal in list k, k=0,1, and shift1 is calculated based on the luma bit depth, bitDepth, as shift1=max(6, bitDepth−6).

Then, the auto- and cross-correlation of the gradients, S₁, S₂, S₃, S₅ and S₆, are calculated as:

$${S}_{1} = {\sum }_{( i , j ) ∈ Ω} Abs ( {ψ}_{x} ( i , j ) ) , {S}_{3} = {\sum }_{( i , j ) ∈ Ω} θ ( i , j ) \cdot Sign ( {ψ}_{x} ( i , j ) ) \qquad ( 2 - 3 )$$

$${S}_{2} = {\sum }_{( i , j ) ∈ Ω} {ψ}_{x} ( i , j ) \cdot Sign ( {ψ}_{y} ( i , j ) )$$

$${S}_{5} = {\sum }_{( i , j ) ∈ Ω} Abs ( {ψ}_{y} ( i , j ) ) , {S}_{6} = {\sum }_{( i , j ) ∈ Ω} θ ( i , j ) \cdot Sign ( {ψ}_{y} ( i , j ) )$$

$$where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) >> {n}_{a} \qquad ( 2 - 4 )$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) >> {n}_{a}$$

$$θ ( i , j ) = ( {I}^{( 1 )} ( i , j ) >> {n}_{b} ) - ( {I}^{( 0 )} ( i , j ) >> {n}_{b} )$$

where Ω is a 6×6 window around the 4×4 subblock, and the values of nₐ and n_{b} are set equal to min(1, bitDepth−11) and min(4, bitDepth−8), respectively.

The motion refinement (vₓ, v_{y}) is then derived using the cross- and auto-correlation terms using the following:

$${v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{a}} ) >> ⌊ {log}_{2} {S}_{1} ⌋ ) ) : 0 \qquad ( 2 - 5 )$$

$${v}_{y} = {S}_{5} > 0 ? clip 3 ( - {th}_{BIO}^{′} , {th}_{BIO}^{′} , - ( ( {S}_{6} \cdot {2}^{{n}_{b} - {n}_{a}} - ( ( {v}_{x} {S}_{2 , m} ) << {n}_{{S}_{2}} + {v}_{x} {S}_{2 , s} ) / 2 ) >> ⌊ {log}_{2} {S}_{5} ⌋ ) ) : 0$$

where

$${S}_{2 , m} = {S}_{2} >> {n}_{{S}_{2}} , {S}_{2 , s} = {S}_{2} \& ( {2}^{{n}_{{s}_{2}}} - 1 ) , {th}_{BIO}^{′} = {2}^{max ( 5 , BD - 7 )} .$$

└⋅┘ is the floor function, and n_{S}_{₂}=12.

Based on the motion refinement and the gradients, the following adjustment is calculated for each sample in the 4×4 subblock:

$$b ( x , y ) = rnd ( \text{} ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 ) \qquad ( 2 - 6 )$$

Finally, the BDOF samples of the CU are calculated by adjusting the bi-prediction samples as follows:

$${pred}_{BDOF} ( x , y ) = ( {I}^{( 0 )} ( x , y ) + {I}^{( 1 )} ( x , y ) + b ( x , y ) + {o}_{offset} ) >> shift \qquad ( 2 - 7 )$$

These values are selected such that the multipliers in the BDOF process do not exceed 15-bit, and the maximum bit-width of the intermediate parameters in the BDOF process is kept within 32-bit.

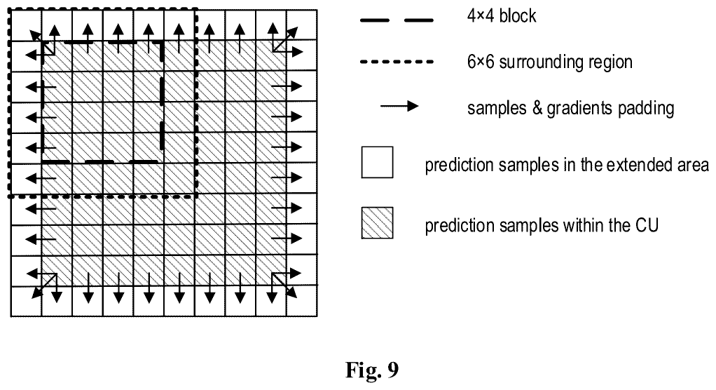

In order to derive the gradient values, some prediction samples I^{(k)}(i, j) in list k (k=0,1) outside of the current CU boundaries need to be generated. As depicted in FIG. 9, the BDOF in VVC uses one extended row/column around the CU's boundaries. In order to control the computational complexity of generating the out-of-boundary prediction samples, prediction samples in the extended area (white positions) are generated by taking the reference samples at the nearby integer positions (using floor(operation on the coordinates) directly without interpolation, and the normal 8-tap motion compensation interpolation filter is used to generate prediction samples within the CU (gray positions). These extended sample values are used in gradient calculation only. For the remaining steps in the BDOF process, if any sample and gradient values outside of the CU boundaries are needed, they are padded (i.e. repeated) from their nearest neighbors.

When the width and/or height of a CU are larger than 16 luma samples, it will be split into subblocks with width and/or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8*W*(H>>1), where W indicates the subblock width, and H indicates subblock height. To avoid the additional complexity of SAD calculation, the SAD between the initial L0 and L1 prediction samples calculated in DVMR process is re-used here.

If BCW is enabled for the current block, i.e., the BCW weight index indicates unequal weight, then bi-directional optical flow is disabled. Similarly, if WP is enabled for the current block, i.e., the luma_weight_lx_flag is 1 for either of the two reference pictures, then BDOF is also disabled. When a CU is coded with symmetric MVD mode or CIIP mode, BDOF is also disabled.

### 2.1.2.3. Symmetric MVD Coding (SMVD)

In VVC, besides the normal unidirectional prediction and bi-directional prediction mode MVD signalling, symmetric MVD mode for bi-predictional MVD signalling is applied. In the symmetric MVD mode, motion information including reference picture indices of both list-0 and list-1 and MVD of list-1 are not signaled but derived.

The decoding process of the symmetric MVD mode is as follows:
1) At slice level, variables BiDirPredFlag, RefIdxSymL0 and RefIdxSymL1 are derived as follows:
   If mvd_l1_zero_flag is 1, BiDirPredFlag is set equal to 0.
   Otherwise, if the nearest reference picture in list-0 and the nearest reference picture in list-1 form a forward and backward pair of reference pictures or a backward and forward pair of reference pictures, BiDirPredFlag is set to 1, and both list-0 and list-1 reference pictures are short-term reference pictures. Otherwise BiDirPredFlag is set to 0.
2) At CU level, a symmetrical mode flag indicating whether symmetrical mode is used or not is explicitly signaled if the CU is bi-prediction coded and BiDirPredFlag is equal to 1.

When the symmetrical mode flag is true, only mvp_l0_flag, mvp_l1_flag and MVD0 are explicitly signaled. The reference indices for list-0 and list-1 are set equal to the pair of reference pictures, respectively. MVD1 is set equal to (−MVD0). The final motion vectors are shown in below formula.

$$\{ \begin{matrix}( {mvx}_{0} , {mvy}_{0} ) = ( {mvpx}_{0} + {mvdx}_{0} , {mvpy}_{0} + {mvdy}_{0} ) \\ ( {mvx}_{1} , {mvy}_{1} ) = ( {mvpx}_{1} - {mvdx}_{0} , {mvpy}_{1} - {mvdy}_{0} )\end{matrix} \qquad ( 2 - 8 )$$

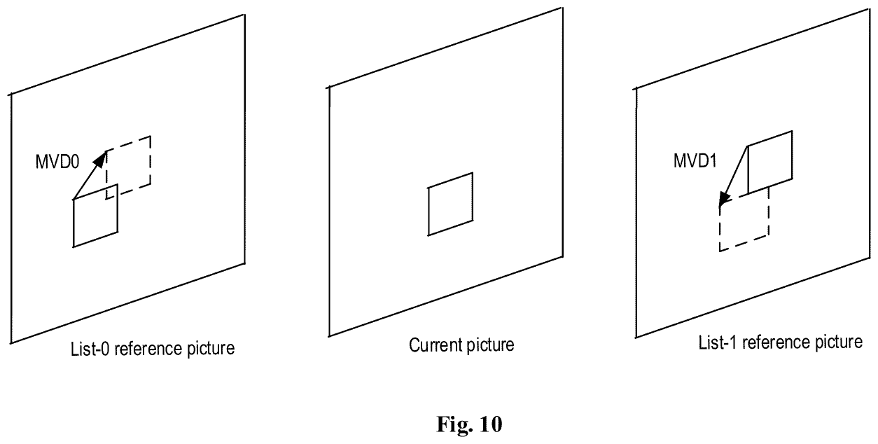

FIG. 10 illustrates symmetrical MVD mode. In the encoder, symmetric MVD motion estimation starts with initial MV evaluation. A set of initial MV candidates comprising of the MV obtained from uni-prediction search, the MV obtained from bi-prediction search and the MVs from the AMVP list. The one with the lowest rate-distortion cost is chosen to be the initial MV for the symmetric MVD motion search.

### 2.1.3. Affine Motion Compensated Prediction

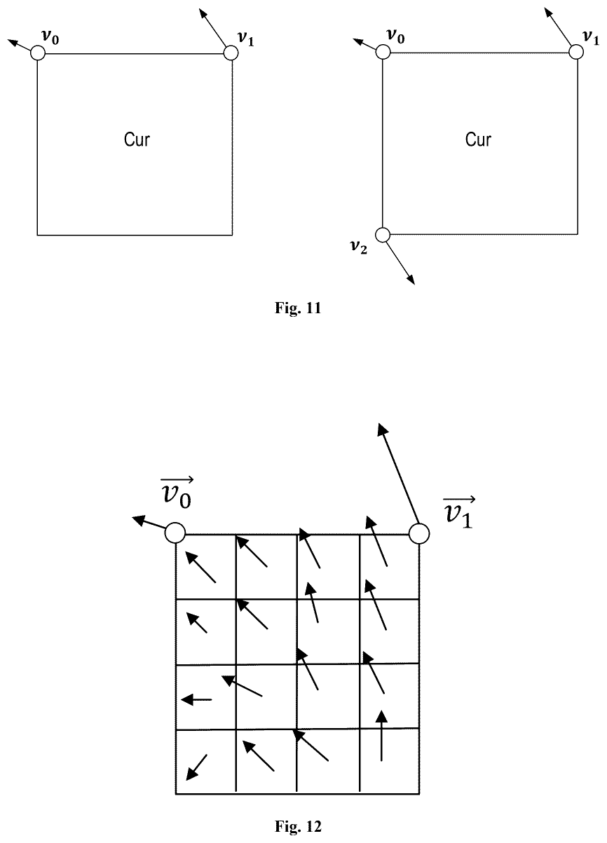

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. As shown FIG. 11, the affine motion field of the block is described by motion information of two control point (4-parameter) or three control point motion vectors (6-parameter).

For 4-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {mv}_{y} = \frac{{mv}_{1 y} - {mv}_{0 y}}{W} x + \frac{{mv}_{1 x} - {mv}_{0 x}}{W} y + {mv}_{0 y}\end{matrix} \qquad ( 2 - 9 )$$

For 6-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} \qquad ( 2 - 10 )$$

Where (mv₀ₓ, mv_{0y}) is motion vector of the top-left corner control point, (mv₁ₓ, mv_{1y}) is motion vector of the top-right corner control point, and (mv₂ₓ, mv_{2y}) is motion vector of the bottom-left corner control point.

In order to simplify the motion compensation prediction, block based affine transform prediction is applied. To derive motion vector of each 4×4 luma subblock, the motion vector of the center sample of each subblock, as shown in FIG. 12, is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region.

As done for translational motion inter prediction, there are also two affine motion inter prediction modes: affine merge mode and affine AMVP mode.

### 2.1.3.1. Affine Merge Prediction

AF_MERGE mode can be applied for Cus with both width and height larger than or equal to 8. In this mode the CPMVs of the current CU is generated based on the motion information of the spatial neighboring Cus. There can be up to five CPMVP candidates and an index is signalled to indicate the one to be used for the current CU. The following three types of CPVM candidate are used to form the affine merge candidate list:
Inherited affine merge candidates that extrapolated from the CPMVs of the neighbour Cus;
Constructed affine merge candidates CPMVPs that are derived using the translational MVs of the neighbour Cus;
Zero MVs.

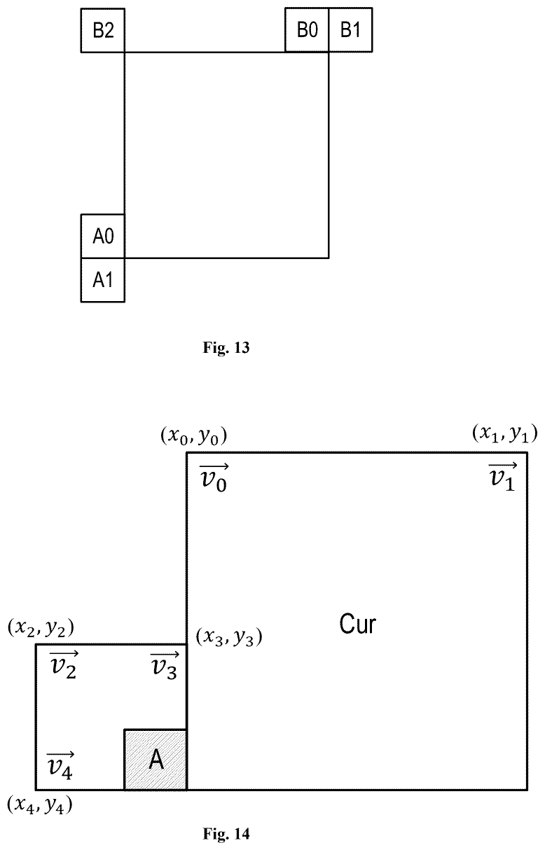

In VVC, there are maximum two inherited affine candidates, which are derived from affine motion model of the neighboring blocks, one from left neighboring Cus and one from above neighboring Cus. The candidate blocks are shown in FIG. 13. For the left predictor, the scan order is A0->A1, and for the above predictor, the scan order is B0->B1->B2. Only the first inherited candidate from each side is selected. No pruning check is performed between two inherited candidates. When a neighboring affine CU is identified, its control point motion vectors are used to derived the CPMVP candidate in the affine merge list of the current CU. As shown in, if the neighbour left bottom block A is coded in affine mode, the motion vectors v₂, v₃ and v₄ of the top left corner, above right corner and left bottom corner of the CU which contains the block A are attained. When block A is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄. FIG. 14 illustrates control point motion vector inheritance.

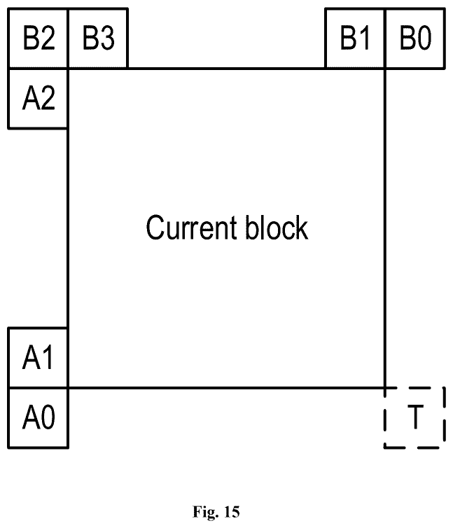

Constructed affine candidate means the candidate is constructed by combining the neighbor translational motion information of each control point. The motion information for the control points is derived from the specified spatial neighbors and temporal neighbor shown in FIG. 15. CPMVₖ (k=1, 2, 3, 4) represents the k-th control point. For CPMV₁, the B2->B3->A2 blocks are checked and the MV of the first available block is used. For CPMV₂, the B1->B0 blocks are checked and for CPMV₃, the A1->A0 blocks are checked. For TMVP is used as CPMV₄ if it's available.

After MVs of four control points are attained, affine merge candidates are constructed based on those motion information. The following combinations of control point MVs are used to construct in order:
{CPMV₁, CPMV₂, CPMV₃}, {CPMV₁, CPMV₂, CPMV₄}, {CPMV₁, CPMV₃, CPMV₄},
{CPMV₂, CPMV₃, CPMV₄}, {CPMV₁, CPMV₂}, {CPMV₁, CPMV₃}.

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

### 2.1.3.2. Affine AMVP Prediction

Affine AMVP mode can be applied for Cus with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AVMP candidate list size is 2 and it is generated by using the following four types of CPVM candidate in order:
Inherited affine AMVP candidates that extrapolated from the CPMVs of the neighbour Cus;
Constructed affine AMVP candidates CPMVPs that are derived using the translational MVs of the neighbour Cus;
Translational MVs from neighboring Cus;
Zero MVs.

The checking order of inherited affine AMVP candidates is same to the checking order of inherited affine merge candidates. The only difference is that, for AVMP candidate, only the affine CU that has the same reference picture as in current block is considered. No pruning process is applied when inserting an inherited affine motion predictor into the candidate list.

Constructed AMVP candidate is derived from the specified spatial neighbors shown in FIG. 15. The same checking order is used as done in affine merge candidate construction. In addition, reference picture index of the neighboring block is also checked. The first block in the checking order that is inter coded and has the same reference picture as in current Cus is used. There is only one When the current CU is coded with 4-parameter affine mode, and mv₀ and mv₁ are both available, they are added as one candidate in the affine AMVP list. When the current CU is coded with 6-parameter affine mode, and all three CPMVs are available, they are added as one candidate in the affine AMVP list. Otherwise, constructed AMVP candidate is set as unavailable.

If affine AMVP list candidates is still less than 2 after valid inherited affine AMVP candidates and constructed AMVP candidate are inserted, mv₀, mv₁ and mv₂ will be added, in order, as the translational MVs to predict all control point MVs of the current CU, when available. Finally, zero MVs are used to fill the affine AMVP list if it is still not full.

### 2.1.3.3. Affine Motion Information Storage

In VVC, the CPMVs of affine Cus are stored in a separate buffer. The stored CPMVs are only used to generate the inherited CPMVPs in affine merge mode and affine AMVP mode for the lately coded Cus. The subblock MVs derived from CPMVs are used for motion compensation, MV derivation of merge/AMVP list of translational MVs and deblocking.

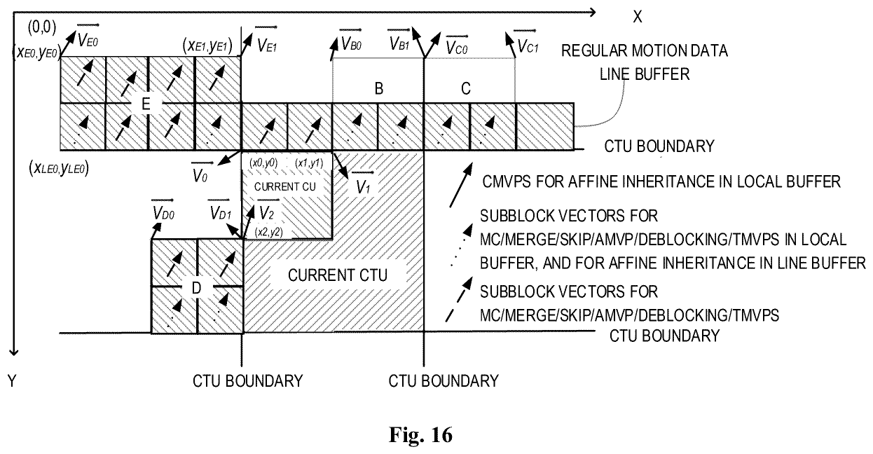

To avoid the picture line buffer for the additional CPMVs, affine motion data inheritance from the Cus from above CTU is treated differently to the inheritance from the normal neighboring Cus. If the candidate CU for affine motion data inheritance is in the above CTU line, the bottom-left and bottom-right subblock MVs in the line buffer instead of the CPMVs are used for the affine MVP derivation. In this way, the CPMVs are only stored in local buffer. If the candidate CU is 6-parameter affine coded, the affine model is degraded to 4-parameter model. As shown in FIG. 16, along the top CTU boundary, the bottom-left and bottom right subblock motion vectors of a CU are used for affine inheritance of the Cus in bottom CTUs.

2.1.3.4. Prediction Refinement with Optical Flow for Affine Mode (PROF)

Subblock based affine motion compensation can save memory access bandwidth and reduce computation complexity compared to pixel based motion compensation, at the cost of prediction accuracy penalty. To achieve a finer granularity of motion compensation, prediction refinement with optical flow (PROF) is used to refine the subblock based affine motion compensated prediction without increasing the memory access bandwidth for motion compensation. In VVC, after the subblock based affine motion compensation is performed, luma prediction sample is refined by adding a difference derived by the optical flow equation. The PROF is described as following four steps:

Step 1) The subblock-based affine motion compensation is performed to generate subblock prediction I(i,j).

Step 2) The spatial gradients gₓ(i, j) and g_{y}(i,j) of the subblock prediction are calculated at each sample location using a 3-tap filter [−1, 0, 1]. The gradient calculation is exactly the same as gradient calculation in BDOF.

$${g}_{x} ( i , j ) = ( I ( i + 1 , j ) >> shift 1 ) - ( I ( i - 1 , j ) ) shift 1 ) \qquad ( 2 - 11 )$$

$${g}_{y} ( i , j ) = ( I ( i , j + 1 ) shift 1 ) - ( I ( i , j - 1 ) ) shift 1 ) \qquad ( 2 - 12 )$$

shift1 is used to control the gradient's precision. The subblock (i.e. 4×4) prediction is extended by one sample on each side for the gradient calculation. To avoid additional memory bandwidth and additional interpolation computation, those extended samples on the extended borders are copied from the nearest integer pixel position in the reference picture.

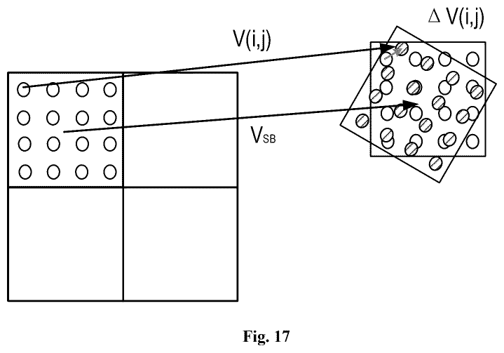

Step 3) The luma prediction refinement is calculated by the following optical flow equation.

$$Δ I ( i , j ) = {g}_{x} ( i , j ) * Δ {v}_{x} ( i , j ) + {g}_{y} ( i , j ) * Δ {v}_{y} ( i , j ) \qquad ( 2 - 13 )$$

where the Δv(i, j) is the difference between sample MV computed for sample location (i, j), denoted by v(i, j), and the subblock MV of the subblock to which sample (i, j) belongs, as shown in FIG. 17. The Δv(i, j) is quantized in the unit of 1/32 luma sample precision.

Since the affine model parameters and the sample location relative to the subblock center are not changed from subblock to subblock, Δv(i, j) can be calculated for the first subblock, and reused for other subblocks in the same CU. Let dx(i, j) and dy(i, j) be the horizontal and vertical offset from the sample location (i, j) to the center of the subblock (x_{SB}, y_{SB}), Δv(x, y) can be derived by the following equation,

$$\{ \begin{matrix}dx ( i , j ) = i - {x}_{SB} \\ dy ( i , j ) = j - {y}_{SB}\end{matrix} \qquad ( 2 - 14 )$$

$$\{ \begin{matrix}Δ {v}_{x} ( i , j ) = C * dx ( i , j ) + D * dy ( i , j ) \\ Δ {v}_{y} ( i , j ) = E * dx ( i , j ) + F * dy ( i , j )\end{matrix} \qquad ( 2 - 15 )$$

In order to keep accuracy, the enter of the subblock (x_{SB}, y_{SB}) is calculated as ((W_{SB}−1)/2, (H_{SB}−1)/2), where W_{SB} and H_{SB} are the subblock width and height, respectively.

For 4-parameter affine model,

$$\{ \begin{matrix}C = F = \frac{{v}_{1 x} - {v}_{0 x}}{w} \\ E = - D = \frac{{v}_{1 y} - {v}_{0 y}}{w}\end{matrix} \qquad ( 2 - 16 )$$

For 6-parameter affine model,

$$\{ \begin{matrix}C = \frac{{v}_{1 x} - {v}_{0 x}}{w} \\ D = \frac{{v}_{2 x} - {v}_{0 x}}{h} \\ E = \frac{{v}_{1 y} - {v}_{0 y}}{w} \\ F = \frac{{v}_{2 y} - {v}_{0 y}}{h}\end{matrix} \qquad ( 2 - 17 )$$

where (v₀ₓ, v_{0y}), (v₁ₓ, v_{1y}), (v₂ₓ, v_{2y}) are the top-left, top-right and bottom-left control point motion vectors, w and h are the width and height of the CU.

Step 4) Finally, the luma prediction refinement ΔI(i, j) is added to the subblock prediction I(i, j). The final prediction I′ is generated as the following equation.

$${I}^{′} ( i , j ) = I ( i , j ) + Δ I ( i , j )$$

PROF is not be applied in two cases for an affine coded CU: 1) all control point MVs are the same, which indicates the CU only has translational motion; 2) the affine motion parameters are greater than a specified limit because the subblock based affine MC is degraded to CU based MC to avoid large memory access bandwidth requirement.

A fast encoding method is applied to reduce the encoding complexity of affine motion estimation with PROF. PROF is not applied at affine motion estimation stage in following two situations: a) if this CU is not the root block and its parent block does not select the affine mode as its best mode, PROF is not applied since the possibility for current CU to select the affine mode as best mode is low; b) if the magnitude of four affine parameters (C, D, E, F) are all smaller than a predefined threshold and the current picture is not a low delay picture, PROF is not applied because the improvement introduced by PROF is small for this case. In this way, the affine motion estimation with PROF can be accelerated.

### 2.1.4. Subblock-Based Temporal Motion Vector Prediction (SbTMVP)

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for Cus in the current picture. The same collocated picture used by TMVP is used for SbTVMP. SbTMVP differs from TMVP in the following two main aspects:
TMVP predicts motion at CU level but SbTMVP predicts motion at sub-CU level;
Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.

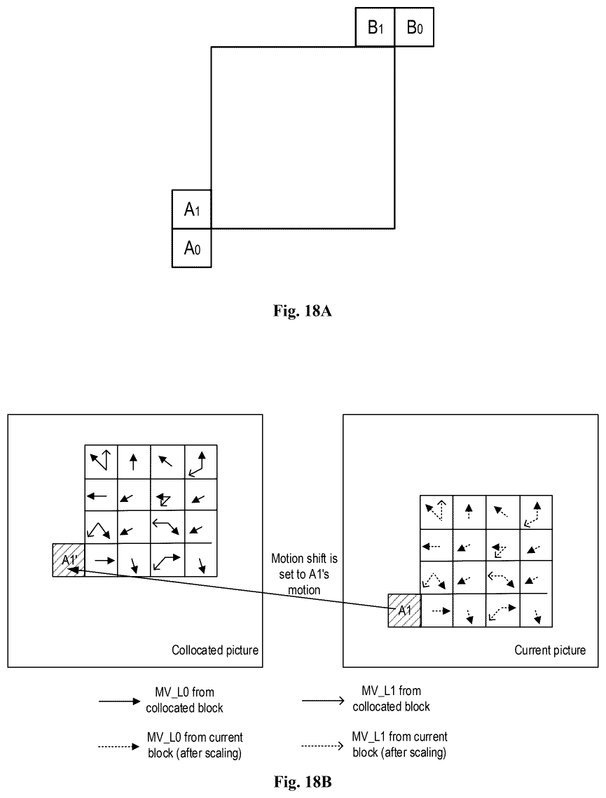

The SbTVMP process is illustrated in FIG. 18. SbTMVP predicts the motion vectors of the sub-Cus within the current CU in two steps. In the first step, the spatial neighbor A1 in FIG. 18 (a) is examined. If A1 has a motion vector that uses the collocated picture as its reference picture, this motion vector is selected to be the motion shift to be applied. If no such motion is identified, then the motion shift is set to (0, 0).

In the second step, the motion shift identified in Step 1 is applied (i.e. added to the current block's coordinates) to obtain sub-CU level motion information (motion vectors and reference indices) from the collocated picture as shown in FIG. 18 (b). The example in FIG. 18 (b) assumes the motion shift is set to block A1's motion. Then, for each sub-CU, the motion information of its corresponding block (the smallest motion grid that covers the center sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU.

In VVC, a combined subblock based merge list which contains both SbTVMP candidate and affine merge candidates is used for the signalling of subblock based merge mode. The SbTVMP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.

The sub-CU size used in SbTMVP is fixed to be 8×8, and as done for affine merge mode, SbTMVP mode is only applicable to the CU with both width and height are larger than or equal to 8.

The encoding logic of the additional SbTMVP merge candidate is the same as for the other merge candidates, that is, for each CU in P or B slice, an additional RD check is performed to decide whether to use the SbTMVP candidate.

### 2.1.5. Adaptive Motion Vector Resolution (AMVR)

In HEVC, motion vector differences (MVDs) (between the motion vector and predicted motion vector of a CU) are signalled in units of quarter-luma-sample when use_integer_mv_flag is equal to 0 in the slice header. In VVC, a CU-level adaptive motion vector resolution (AMVR) scheme is introduced. AMVR allows MVD of the CU to be coded in different precision. Dependent on the mode (normal AMVP mode or affine AVMP mode) for the current CU, the MVDs of the current CU can be adaptively selected as follows:
Normal AMVP mode: quarter-luma-sample, half-luma-sample, integer-luma-sample or four-luma-sample.
Affine AMVP mode: quarter-luma-sample, integer-luma-sample or 1/16 luma-sample.

The CU-level MVD resolution indication is conditionally signalled if the current CU has at least one non-zero MVD component. If all MVD components (that is, both horizontal and vertical MVDs for reference list L0 and reference list L1) are zero, quarter-luma-sample MVD resolution is inferred.

For a CU that has at least one non-zero MVD component, a first flag is signalled to indicate whether quarter-luma-sample MVD precision is used for the CU. If the first flag is 0, no further signaling is needed and quarter-luma-sample MVD precision is used for the current CU. Otherwise, a second flag is signalled to indicate half-luma-sample or other MVD precisions (integer or four-luma sample) is used for normal AMVP CU. In the case of half-luma-sample, a 6-tap interpolation filter instead of the default 8-tap interpolation filter is used for the half-luma sample position. Otherwise, a third flag is signalled to indicate whether integer-luma-sample or four-luma-sample MVD precision is used for normal AMVP CU. In the case of affine AMVP CU, the second flag is used to indicate whether integer-luma-sample or 1/16 luma-sample MVD precision is used. In order to ensure the reconstructed MV has the intended precision (quarter-luma-sample, half-luma-sample, integer-luma-sample or four-luma-sample), the motion vector predictors for the CU will be rounded to the same precision as that of the MVD before being added together with the MVD. The motion vector predictors are rounded toward zero (that is, a negative motion vector predictor is rounded toward positive infinity and a positive motion vector predictor is rounded toward negative infinity).

The encoder determines the motion vector resolution for the current CU using RD check. To avoid always performing CU-level RD check four times for each MVD resolution, in VTM13, the RD check of MVD precisions other than quarter-luma-sample is only invoked conditionally. For normal AVMP mode, the RD cost of quarter-luma-sample MVD precision and integer-luma sample MV precision is computed first. Then, the RD cost of integer-luma-sample MVD precision is compared to that of quarter-luma-sample MVD precision to decide whether it is necessary to further check the RD cost of four-luma-sample MVD precision. When the RD cost for quarter-luma-sample MVD precision is much smaller than that of the integer-luma-sample MVD precision, the RD check of four-luma-sample MVD precision is skipped. Then, the check of half-luma-sample MVD precision is skipped if the RD cost of integer-luma-sample MVD precision is significantly larger than the best RD cost of previously tested MVD precisions. For affine AMVP mode, if affine inter mode is not selected after checking rate-distortion costs of affine merge/skip mode, merge/skip mode, quarter-luma-sample MVD precision normal AMVP mode and quarter-luma-sample MVD precision affine AMVP mode, then 1/16 luma-sample MV precision and 1-pel MV precision affine inter modes are not checked. Furthermore affine parameters obtained in quarter-luma-sample MV precision affine inter mode is used as starting search point in 1/16 luma-sample and quarter-luma-sample MV precision affine inter modes.

2.1.6. B1-Prediction with CU-Level Weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

$${P}_{bi - pred} = ( ( 8 - w ) * {P}_{0} + w * {P}_{1} + 4 ) >> 3 \qquad ( 2 - 18 )$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to Cus with 256 or more luma samples (i.e., CU width times CU height is greater than or equal to 256). For low-delay pictures, all 5 weights are used. For non-low-delay pictures, only 3 weights (w∈{3,4,5}) are used.
At the encoder, fast search algorithms are applied to find the weight index without significantly increasing the encoder complexity. These algorithms are summarized as follows. When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, e.g. equal weight.

### 2.1.7. Bi-Directional Optical Flow (BDOF)

The bi-directional optical flow (BDOF) tool is included in VVC. BDOF, previously referred to as BIO, was included in the JEM. Compared to the JEM version, the BDOF in VVC is a simpler version that requires much less computation, especially in terms of number of multiplications and the size of the multiplier.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order.
The distances (i.e. POC difference) from two reference pictures to the current picture are same.
Both reference pictures are short-term reference pictures.
The CU is not coded using affine mode or the SbTMVP merge mode.
CU has more than 64 luma samples.
Both CU height and CU width are larger than or equal to 8 luma samples.
BCW weight index indicates equal weight.
WP is not enabled for the current CU.
CIIP mode is not used for the current CU.

BDOF is only applied to the luma component. As its name indicates, the BDOF mode is based on the optical flow concept, which assumes that the motion of an object is smooth. For each 4×4 subblock, a motion refinement (vₓ, v_{y}) is calculated by minimizing the difference between the L0 and L1 prediction samples. The motion refinement is then used to adjust the bi-predicted sample values in the 4×4 subblock. The following steps are applied in the BDOF process.

First, the horizontal and vertical gradients,

$$\frac{\partial {I}^{( k )}}{\partial x} ( i , j ) and \frac{\partial {I}^{( k )}}{\partial y} ( i , j ) , k = 0 , 1 ,$$

of the two prediction signals are computed by directly calculating the difference between two neighboring samples, i.e.,

$$\frac{\partial {I}^{( k )}}{\partial x} ( i , j ) = ( ( {I}^{( k )} ( i + 1 , j ) ) shift 1 ) - ( {I}^{( k )} ( i - 1 , j ) ) shift 1 ) ) \qquad ( 2 - 19 )$$

$$\frac{\partial {I}^{( k )}}{\partial y} ( i , j ) = ( ( {I}^{( k )} ( i , j + 1 ) ) shift 1 ) - ( {I}^{( k )} ( i , j - 1 ) ) shift 1 ) )$$

where I^{(k)}(i, j) are the sample value at coordinate (i, j) of the prediction signal in list k, k=0,1, and shift1 is calculated based on the luma bit depth, bitDepth, as shift1=max(6, bitDepth-6).

Then, the auto- and cross-correlation of the gradients, S₁, S₂, S₃, S₅ and S₆, are calculated as

$${S}_{1} = {\sum }_{( i , j ) ∈ Ω} Abs ( {ψ}_{x} ( i , j ) ) , {S}_{3} = {\sum }_{( i , j ) ∈ Ω} θ ( i , j ) \cdot Sign ( {ψ}_{x} ( i , j ) ) \qquad ( 2 - 20 )$$

$${S}_{2} = {\sum }_{( i , j ) ∈ Ω} {ψ}_{x} ( i , j ) \cdot Sign ( {ψ}_{y} ( i , j ) )$$

$${S}_{5} = {\sum }_{( i , j ) ∈ Ω} Abs ( {ψ}_{y} ( i , j ) ) , {S}_{6} = {\sum }_{( i , j ) ∈ Ω} θ ( i , j ) \cdot Sign ( {ψ}_{y} ( i , j ) ) where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a} \qquad ( 2 - 21 )$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a}$$

$$θ ( i , j ) = ( {I}^{( 1 )} ( i , j ) ≫ {n}_{b} ) - ( {I}^{( 0 )} ( i , j ) ≫ {n}_{b} )$$

where Ω is a 6×6 window around the 4×4 subblock, and the values of nₐ and n_{b} are set equal to min(1, bitDepth−11) and min(4, bitDepth−8), respectively.

The motion refinement (vₓ, v_{y}) is then derived using the cross- and auto-correlation terms using the following:

$${v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{a}} ) ≫ ⌊ {log}_{2} {S}_{1} ⌋ ) ) : 0 \qquad ( 2 - 22 )$$

$${v}_{y} = {S}_{5} > 0 ? clip 3 ( - {th}_{BIO}^{′} , {th}_{BIO}^{′} , - ( ( {S}_{6} \cdot {2}^{{n}_{b} - {n}_{a}} - ( ( {v}_{x} {S}_{2 , m} ) ≪ {n}_{{S}_{2}} + {v}_{x} {S}_{2 , s} ) / 2 ) ≫ ⌊ {log}_{2} {S}_{5} ⌋ ) ) : 0$$

where

$${S}_{2 , m} = {S}_{2} ≫ {n}_{{S}_{2}} , {S}_{2 , s} = {S}_{2} \& ( {2}^{{n}_{{s}_{2}}} - 1 ) , {th}_{BIO}^{′} = {2}^{m ax ( 5 , BD - 7 )} .$$

└⋅┘ is the floor function, and n_{S}_{₂}=12.

Based on the motion refinement and the gradients, the following adjustment is calculated for each sample in the 4×4 subblock:

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 ) \qquad ( 2 - 23 )$$

Finally, the BDOF samples of the CU are calculated by adjusting the bi-prediction samples as follows:

$${pred}_{BDOF} ( x , y ) = ( {I}^{( 0 )} ( x , y ) + {I}^{( 1 )} ( x , y ) + b ( x , y ) + {o}_{offset} ) ≫ shift \qquad ( 2 - 24 )$$

These values are selected such that the multipliers in the BDOF process do not exceed 15-bit, and the maximum bit-width of the intermediate parameters in the BDOF process is kept within 32-bit.

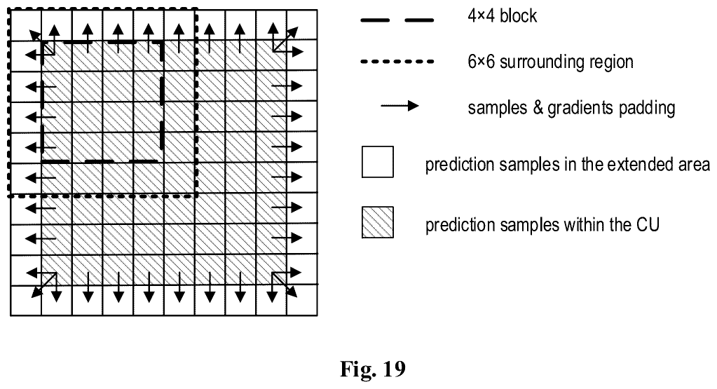

In order to derive the gradient values, some prediction samples I^{(k)}(i, j) in list k (k=0,1) outside of the current CU boundaries need to be generated. As depicted in FIG. 19, the BDOF in VVC uses one extended row/column around the CU's boundaries. In order to control the computational complexity of generating the out-of-boundary prediction samples, prediction samples in the extended area (white positions) are generated by taking the reference samples at the nearby integer positions (using floor(operation on the coordinates) directly without interpolation, and the normal 8-tap motion compensation interpolation filter is used to generate prediction samples within the CU (gray positions). These extended sample values are used in gradient calculation only. For the remaining steps in the BDOF process, if any sample and gradient values outside of the CU boundaries are needed, they are padded (i.e. repeated) from their nearest neighbors.

When the width and/or height of a CU are larger than 16 luma samples, it will be split into subblocks with width and/or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8*W*(H>>1), where W indicates the subblock width, and H indicates subblock height. To avoid the additional complexity of SAD calculation, the SAD between the initial L0 and L1 prediction samples calculated in DVMR process is re-used here.

If BCW is enabled for the current block, i.e., the BCW weight index indicates unequal weight, then bi-directional optical flow is disabled. Similarly, if WP is enabled for the current block, i.e., the luma_weight_lx_flag is 1 for either of the two reference pictures, then BDOF is also disabled. When a CU is coded with symmetric MVD mode or CIIP mode, BDOF is also disabled.

### 2.1.8. Decoder Side Motion Vector Refinement (DMVR)

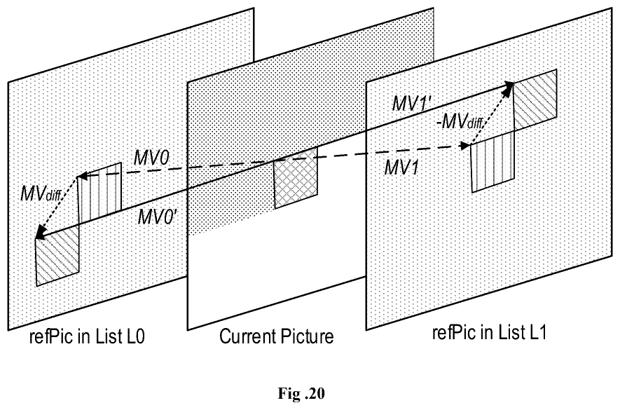

In order to increase the accuracy of the MVs of the merge mode, a bilateral-matching based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. As illustrated in FIG. 20, the SAD between the red blocks based on each MV candidate around the initial MV is calculated. The MV candidate with the lowest SAD becomes the refined MV and used to generate the bi-predicted signal.

In VVC, the DMVR can be applied for the Cus which are coded with following modes and features:
CU level merge mode with bi-prediction MV.
One reference picture is in the past and another reference picture is in the future with respect to the current picture.
The distances (i.e. POC difference) from two reference pictures to the current picture are same.
Both reference pictures are short-term reference pictures.
CU has more than 64 luma samples.
Both CU height and CU width are larger than or equal to 8 luma samples.
BCW weight index indicates equal weight.
WP is not enabled for the current block.
CIIP mode is not used for the current block.

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

### 2.1.8.1. Searching Scheme

In DVMR, the search points are surrounding the initial MV and the MV offset obey the MV difference mirroring rule. In other words, any points that are checked by DMVR, denoted by candidate MV pair (MV0, MV1) obey the following two equations:

$$MV {0}^{′} = M V 0 + MV\_offset \qquad ( 2 - 25 )$$

$$MV {1}^{′} = MV 1 - MV\_offset \qquad ( 2 - 26 )$$

Where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form

$$E ( x , y ) = {A ( x - {x}_{m i n} )}^{2} + {B ( y - {y}_{m i n} )}^{2} + C \qquad ( 2 - 27 )$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{m i n} = ( E ( - 1 , 0 ) - E ( 1 , 0 ) ) / ( 2 ( E ( - 1 , 0 ) + E ( 1 , 0 ) - 2 E ( 0 , 0 ) ) ) \qquad ( 2 - 28 )$$

$${y}_{m i n} = ( E ( 0 , - 1 ) - E ( 0 , 1 ) ) / ( 2 ( ( E ( 0 , - 1 ) + E ( 0 , 1 ) - 2 E ( 0 , 0 ) ) ) \qquad ( 2 - 29 )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

### 2.1.8.2. Bilinear-Interpolation and Sample Padding

In VVC, the resolution of the MVs is 1/16 luma samples. The samples at the fractional position are interpolated using a 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

### 2.1.8.3. Maximum DMVR Processing Unit

When the width and/or height of a CU are larger than 16 luma samples, it will be further split into subblocks with width and/or height equal to 16 luma samples. The maximum unit size for DMVR searching process is limit to 16×16.

### 2.1.9. Combined Inter and Intra Prediction (CIIP)

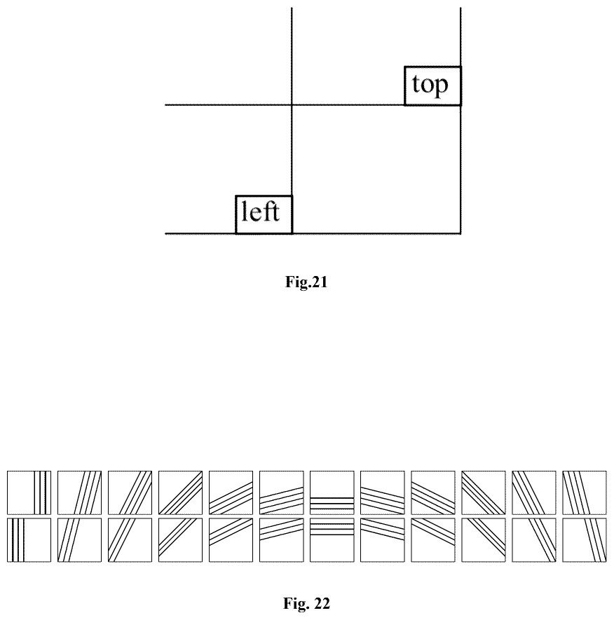

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks (depicted in FIG. 21) as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - w t ) * {P}_{inter} + w t * {P}_{intra} + 2 ) ≫ 2 \qquad ( 2 - 30 )$$

### 2.1.10. Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.

When this mode is used, a CU is split into two parts by a geometrically located straight line (FIG. 22). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights. This is the prediction signal for the whole CU, and transform and quantization process will be applied to the whole CU as in other prediction modes. Finally, the motion field of a CU predicted using the geometric partition modes is stored.

### 2.1.10.1. Uni-Prediction Candidate List Construction

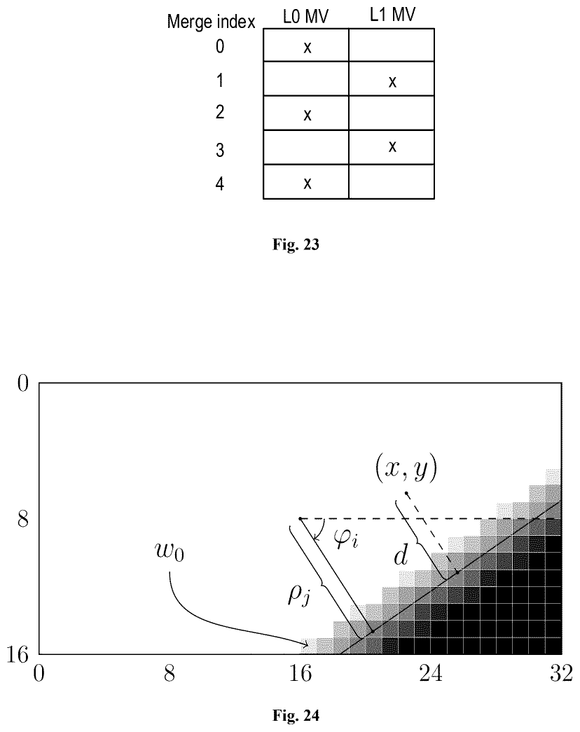

The uni-prediction candidate list is derived directly from the merge candidate list constructed according to the extended merge prediction process. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. These motion vectors are marked with “x” in FIG. 23. In case a corresponding LX motion vector of the n-the extended merge candidate does not exist, the L(1−X) motion vector of the same candidate is used instead as the uni-prediction motion vector for geometric partitioning mode.

### 2.1.10.2. Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j}$$

$${ρ}_{j} = {ρ}_{x , j} cos ( {φ}_{i} ) + {p}_{y , j} sin ( {φ}_{i} )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix}$$

$${ρ}_{y , j} = \{ \begin{matrix}\pm ( j \times h ) ≫ 2 & i \% 16 = 8 or ( i \% 16 \neq 0 and h \geq w ) \\ 0 & otherwise\end{matrix}$$

where i, j are the indices for angle and offset of a geometric partition, which depend on the signaled geometric partition index. The sign of ρ_{x,j} and ρ_{y,j} depend on angle index i.

The weights for each part of a geometric partition are derived as following:

$$w I d x L ( x , y ) = partIdx ? 32 + d ( x , y ) : 32 - d ( x , y )$$

$${w}_{0} ( x , y ) = \frac{Clip 3 ( 0 , 8 ( wIdxL ( x , y ) + 4 ) ) 3 )}{8}$$

$${w}_{1} ( x , y ) = 1 - {w}_{0} ( x , y )$$

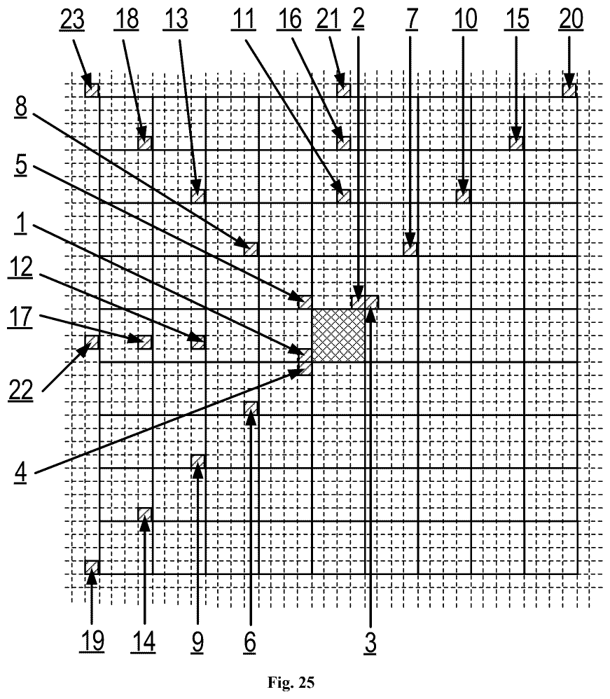

The partIdx depends on the angle index i. One example of weigh w₀ is illustrated in FIG. 24.

### 2.1.10.3. Motion Field Storage for Geometric Partitioning Mode

Mv1 from the first part of the geometric partition, Mv2 from the second part of the geometric partition and a combined My of Mv1 and Mv2 are stored in the motion filed of a geometric partitioning mode coded CU.

The stored motion vector type for each individual position in the motion filed are determined as:

$$sType = abs ( motionIdx ) < 32 ? 2 : ( motionIdx \leq 0 ? ( 1 - partIdx ) : partIdx )$$

where motionIdx is equal to d(4x+2, 4y+2). The partIdx depends on the angle index i.

If sType is equal to 0 or 1, Mv0 or Mv1 are stored in the corresponding motion field, otherwise if sType is equal to 2, a combined My from Mv0 and Mv2 are stored. The combined My are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.

### 2.1.11. Local Illumination Compensation (LIC)

LIC is an inter prediction technique to model local illumination variation between current block and its prediction block as a function of that between current block template and reference block template. The parameters of the function can be denoted by a scale α and an offset β, which forms a linear equation, that is, α*p[x]+β to compensate illumination changes, where p[x] is a reference sample pointed to by MV at a location x on reference picture. Since α and β can be derived based on current block template and reference block template, no signaling overhead is required for them, except that an LIC flag is signaled for AMVP mode to indicate the use of LIC.

The local illumination compensation is used for uni-prediction inter Cus with the following modifications.
Intra neighbor samples can be used in LIC parameter derivation;
LIC is disabled for blocks with less than 32 luma samples;
For both non-subblock and affine modes, LIC parameter derivation is performed based on the template block samples corresponding to the current CU, instead of partial template block samples corresponding to first top-left 16×16 unit;
Samples of the reference block template are generated by using MC with the block MV without rounding it to integer-pel precision.

### 2.1.12. Non-Adjacent Spatial Candidate

The non-adjacent spatial merge candidates are inserted after the TMVP in the regular merge candidate list. The pattern of spatial merge candidates is shown in FIG. 25. The distances between non-adjacent spatial candidates and current coding block are based on the width and height of current coding block. The line buffer restriction is not applied.

### 2.1.13. Template Matching I

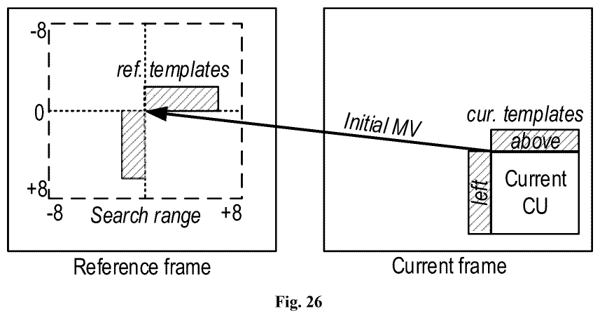

Template matchI(TM) is a decoder-side MV derivation method to refine the motion information of the current CU by finding the closest match between a template (i.e., top and/or left neighbouring blocks of the current CU) in the current picture and a block (i.e., same size to the template) in a reference picture. As illustrated in FIG. 26, a better MV is searched around the initial motion of the current CU within a [−8, +8]-pel search range. The template matching method is used with the following modifications: search step size is determined based on AMVR mode and TM can be cascaded with bilateral matching process in merge modes.

In AMVP mode, an MVP candidate is determined based on template matching error to select the one which reaches the minimum difference between the current block template and the reference block template, and then TM is performed only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 3. This search process ensures that the MVP candidate still keeps the same MV precision as indicated by the AMVR mode after TM process.

TABLE 3
Search patterns of AMVR and merge mode with AMVR.

| | AMVR mode | | | | Merge mode | |
|---|---|---|---|---|---|---|
| | 4- | Full- | Half- | Quarter- | AltIF = | AltIF = |
| Search pattern | pel | pel | pel | pel | 0 | 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

In merge mode, similar search method is applied to the merge candidate indicated by the merge index. As Table 3 shows, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

2.1.14. Multi-Pass Decoder-Side Motion Vector Refinement (mpDMVR)

A multi-pass decoder-side motion vector refinement is applied. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

### 2.1.14.1. First Pass—Block Based Bilateral Matching MV Refinement

In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in horizontal direction and [−sVer, sVer] in vertical direction, wherein, the values of sHor and sVer are determined by the block dimension, and the maximum value of sHor and sVer is 8.

The bilateral matching cost is calculated as: bilCost=mvDistanceCost+sadCost. When the block size cbW*cbH is greater than 64, MRSAD cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range.

The existing fractional sample refinement is further applied to derive the final deltaMV. The refined MVs after the first pass is then derived as:

$$MV 0 \_pass 1 = MV 0 + deltaMV ;$$

$$MV 1 \_pass 1 = MV 1 - deltaMV .$$

### 2.1.14.2. Second Pass—Subblock Based Bilateral Matching MV Refinement

In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2(sbIdx2) and MV1_pass2(sbIdx2)) are derived based on the minimum bilateral matching cost between the two reference subblocks in L0 and L1.

For each subblock, BM performs full search to derive integer sample precision intDeltaMV. The full search has a search range [−sHor, sHor] in horizontal direction and [−sVer, sVer] in vertical direction, wherein, the values of sHor and sVer are determined by the block dimension, and the maximum value of sHor and sVer is 8.

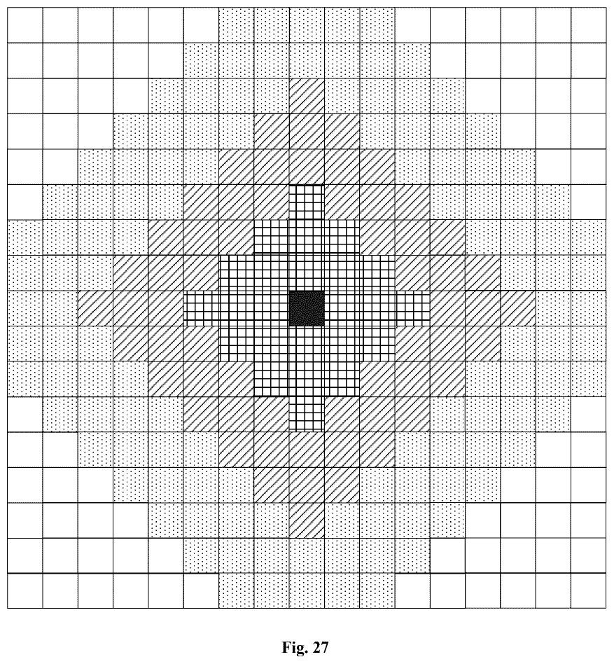

The bilateral matching cost is calculated by applying a cost factor to the SATD cost between two reference subblocks, as: bilCost=satdCost*costFactor. The search area (2*sHor+1)*(2*sVer+1) is divided up to 5 diamond shape search regions shown on FIG. 27. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined.

The existing VVC DMVR fractional sample refinement is further applied to derive the final deltaMV(sbIdx2). The refined MVs at second pass is then derived as:

$$MV0\_pass2 ( sbIdx 2 ) = MV0\_pass1 + deltaMV ( sbIdx 2 ) ;$$

$$MV1\_pass2 ( sbIdx 2 ) = MV1\_pass1 - deltaMV ( sbIdx 2 ) .$$

### 2.1.14.3. Third Pass—Subblock Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32.

The refined MVs (MV0_pass3(sbIdx3) and MV1_pass3(sbIdx3)) at third pass are derived as:

$$MV0\_pass3 ( sbIdx 3 ) = MV0\_pass2 ( sbIdx 2 ) + bioMv ;$$

$$MV1\_pass3 ( sbIdx 3 ) = MV0\_pass2 ( sbIdx 2 ) - bioMv .$$

### 2.1.15. OBMC

When OBMC is applied, top and left boundary pixels of a CU are refined using neighboring block's motion information with a weighted prediction.

Conditions of not applying OBMC are as follows:
When OBMC is disabled at SPS level.
When current block has intra mode or IBC mode.
When current block applies LIC.
When current luma block area is smaller or equal to 32.

A subblock-boundary OBMC is performed by applying the same blending to the top, left, bottom, and right subblock boundary pixels using neighboring subblocks' motion information. It is enabled for the subblock based coding tools:
Affine AMVP modes;
Affine merge modes and subblock-based temporal motion vector prediction (SbTMVP);
Subblock-based bilateral matching.

### 2.1.16. Sample-Based BDOF

In the sample-based BDOF, instead of deriving motion refinement (Vx, Vy) on a block basis, it is performed per sample.

The coding block is divided into 8×8 subblocks. For each subblock, whether to apply BDOF or not is determined by checking the SAD between the two reference subblocks against a threshold. If decided to apply BDOF to a subblock, for every sample in the subblock, a sliding 5×5 window is used and the existing BDOF process is applied for every sliding window to derive Vx and Vy. The derived motion refinement (Vx, Vy) is applied to adjust the bi-predicted sample value for the center sample of the window.

### 2.1.17. Interpolation

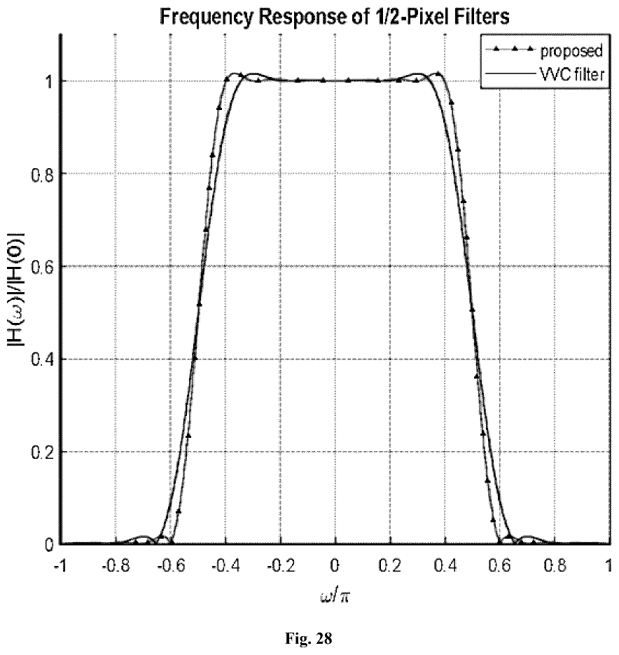

The 8-tap interpolation filter used in VVC is replaced with a 12-tap filter. The interpolation filter is derived from the sine function of which the frequency response is cut off at Nyquist frequency, and cropped by a cosine window function. Table 4 gives the filter coefficients of all 16 phases. FIG. 28 compares the frequency responses of the interpolation filters with the VVC interpolation filter, all at half-pel phase.

TABLE 4
Filter coefficients of the 12-tap interpolation filter

| | | | | | | | | | | | | |
|---|---|---|---|---|---|---|---|---|---|---|---|---|
| 1/16 | −1 | 2 | −3 | 6 | −14 | 254 | 16 | −7 | 4 | −2 | 1 | 0 |
| 2/16 | −1 | 3 | −7 | 12 | −26 | 249 | 35 | −15 | 8 | −4 | 2 | 0 |
| 3/16 | −2 | 5 | −9 | 17 | −36 | 241 | 54 | −22 | 12 | −6 | 3 | −1 |
| 4/16 | −2 | 5 | −11 | 21 | −43 | 230 | 75 | −29 | 15 | −8 | 4 | −1 |
| 5/16 | −2 | 6 | −13 | 24 | −48 | 216 | 97 | −36 | 19 | −10 | 4 | −1 |
| 6/16 | −2 | 7 | −14 | 25 | −51 | 200 | 119 | −42 | 22 | −12 | 5 | −1 |
| 7/16 | −2 | 7 | −14 | 26 | −51 | 181 | 140 | −46 | 24 | −13 | 6 | −2 |
| 8/16 | −2 | 6 | −13 | 25 | −50 | 162 | 162 | −50 | 25 | −13 | 6 | −2 |
| 9/16 | −2 | 6 | −13 | 24 | −46 | 140 | 181 | −51 | 26 | −14 | 7 | −2 |
| 10/16 | −1 | 5 | −12 | 22 | −42 | 119 | 200 | −51 | 25 | −14 | 7 | −2 |
| 11/16 | −1 | 4 | −10 | 19 | −36 | 97 | 216 | −48 | 24 | −13 | 6 | −2 |
| 12/16 | −1 | 4 | −8 | 15 | −29 | 75 | 230 | −43 | 21 | −11 | 5 | −2 |
| 13/16 | −1 | 3 | −6 | 12 | −22 | 54 | 241 | −36 | 17 | −9 | 5 | −2 |
| 14/16 | 0 | 2 | −4 | 8 | −15 | 35 | 249 | −26 | 12 | −7 | 3 | −1 |
| 15/16 | 0 | 1 | −2 | 4 | −7 | 16 | 254 | −14 | 6 | −3 | 2 | −1 |

### 2.1.18. Multi-Hypothesis Prediction (MHP)

In the multi-hypothesis inter prediction mode, one or more additional motion-compensated prediction signals are signaled, in addition to the conventional bi prediction signal. The resulting overall prediction signal is obtained by sample-wise weighted superposition. With the bi prediction signal p_{bi} and the first additional inter prediction signal/hypothesis h₃, the resulting prediction signal p₃ is obtained as follows.

$${p}_{3} = ( 1 - α ) {p}_{bi} + α {h}_{3}$$

The weighting factor α is specified by the new syntax element add_hyp_weight_idx, according to the following mapping.

| add_hyp_weight_idx | α |
|---|---|
| 0 | ¼ |
| 1 | −⅛ |

Analogously to above, more than one additional prediction signal can be used. The resulting overall prediction signal is accumulated iteratively with each additional prediction signal.

$${p}_{n + 1} = ( 1 - {α}_{n + 1} ) {p}_{n} + {α}_{n + 1} {h}_{n + 1}$$

The resulting overall prediction signal is obtained as the last pₙ (i.e., the pₙ having the largest index n). Within this EE, up to two additional prediction signals can be used (i.e., n is limited to 2).

The motion parameters of each additional prediction hypothesis can be signaled either explicitly by specifying the reference index, the motion vector predictor index, and the motion vector difference, or implicitly by specifying a merge index. A separate multi-hypothesis merge flag distinguishes between these two signalling modes.

For inter AMVP mode, MHP is only applied if non-equal weight in BCW is selected in bi-prediction mode.

Combination of MHP and BDOF is possible, however the BDOF is only applied to the bi-prediction signal part of the prediction signal (i.e., the ordinary first two hypotheses).

2.1.19. Adaptive Reordering of Merge Candidates with Template Matching (ARMC-TM)

The merge candidates are adaptively reordered with template mIing (TM). The reordering method is applied to regular merge mode, templaIatching (TM) merge mode, and affine merge mode (excluding the SbTMVP candidate). For the TM merge mode, merge candidates are reordered before the refinement process.

After a merge candidate list is constructed, merge candidates are divided into several subgroups. The subgroup size is set to 5 for regular merge mode and TM merge mode. The subgroup size is set to 3 for affine merge mode. Merge candidates in each subgroup are reordered ascendingly according to cost values based on template matching. For simplification, merge candidates in the last but not the first subgroup are not reordered.

The template matching cost of a merge candidate is measured by the sum of absolute differences (SAD) between samples of a template of the current block and their corresponding reference samples. The template comprises a set of reconstructed samples neighboring to the current block. Reference samples of the template are located by the motion information of the merge candidate.

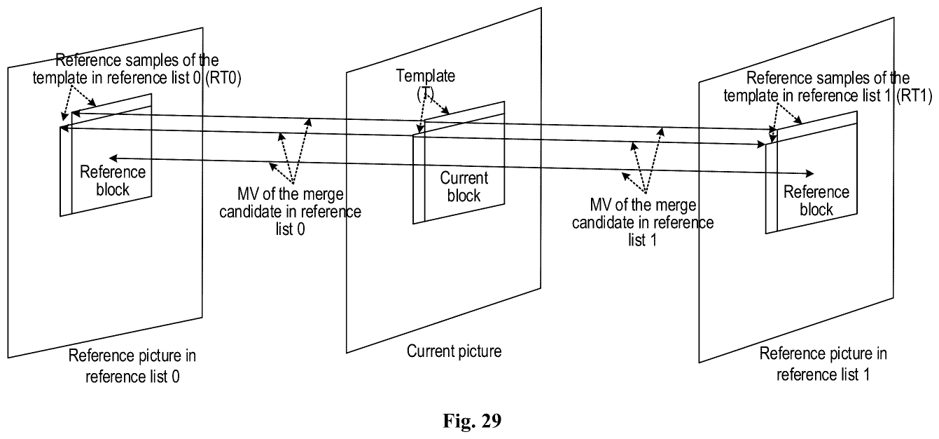

When a merge candidate utilizes bi-directional prediction, the reference samples of the template of the merge candidate are also generated by bi-prediction as shown in FIG. 29.

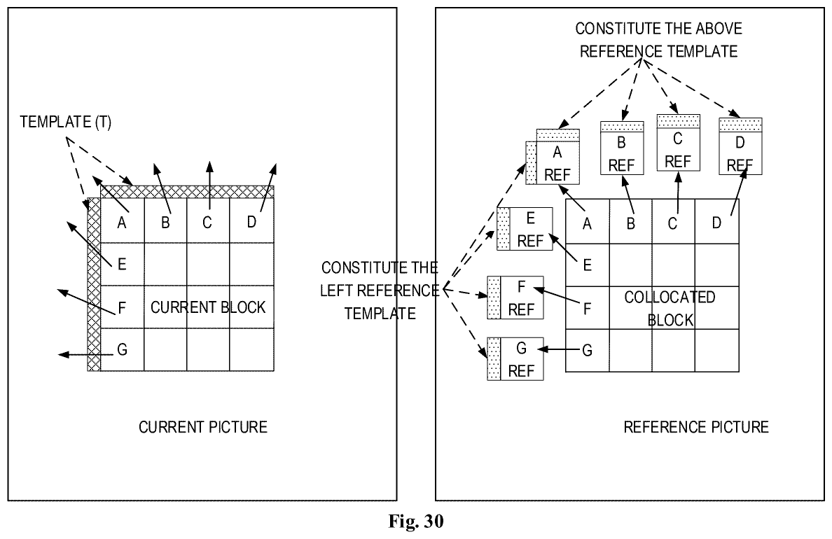

For subblock-based merge candidates with subblock size equal to Wsub×Hsub, the above template comprises several sub-templates with the size of Wsub×1, and the left template comprises several sub-templates with the size of 1×Hsub. As shown in FIG. 30, the motion information of the subblocks in the first row and the first column of current block is used to derive the reference samples of each sub-template.

2.1.20. Geometric Partitioning Mode (GPM) with Merge Motion Vector Differences (MMVD)

GPM in VVC is extended by applying motion vector refinement on top of the existing GPM uni-directional MVs. A flag is first signalled for a GPM CU, to specify whether this mode is used. If the mode is used, each geometric partition of a GPM CU can further decide whether to signal MVD or not. If MVD is signalled for a geometric partition, after a GPM merge candidate is selected, the motion of the partition is further refined by the signalled MVDs information. All other procedures are kept the same as in GPM.

The MVD is signaled as a pair of distance and direction, similar as in MMVD. There are nine candidate distances (¼-pel, ½-pel, 1-pel, 2-pel, 3-pel, 4-pel, 6-pel, 8-pel, 16-pel), and eight candidate directions (four horizontal/vertical directions and four diagonal directions) involved in GPM with MMVD (GPM-MMVD). In addition, when pic_fpel_mmvd_enabled_flag is equal to 1, the MVD is left shifted by 2 as in MMVD.

2.1.21. Geometric Partitioning Mode (GPM) with teIte Matching (TM)

Template matching is applied to GPM. When GPM mode is enabled for a CU, a CU-level flag is signaled to indicate whether TM is applied to both geometric partitions. Motion information for each geometric partition is refined using TM. When TM is chosen, a template is constructed using left, above or left and above neighboring samples according to partition angle, as shown in Table 5. The motion is then refined by minimizing the difference between the current template and the template in the reference picture using the same search pattern of merge mode with half-pel interpolation filter disabled.

TABLE 5
Template for the 1st and 2nd geometric partitions, where A represents using above samples,
L represents using left samples, and L + A represents using both left and above samples.

| Partition angle | 0 | 2 | 3 | ⁴ | 5 | 8 | 11 | 12 | 13 | 14 |
|---|---|---|---|---|---|---|---|---|---|---|
| 1st partition | A | A | A | A | L + ^{A} | L + A | L + A | L + A | A | A |
| 2nd partition | L + A | L + A | L + A | L | L | L | L | L + A | L + A | L + A |
| Partition angle | 16 | 18 | 19 | 20 | ²¹ | 24 | 27 | 28 | 29 | 30 |
| 1st partition | A | A | A | A | L + ^{A} | L + A | L + A | L + A | A | A |
| 2nd partition | L + A | L + A | L + A | L | L | L | L | L + A | L + A | L + A |

A GPM candidate list is constructed as follows:
1. Interleaved List-0 MV candidates and List-1 MV candidates are derived directly from the regular merge candidate list, where List-0 MV candidates are higher priority than List-1 MV candidates. A pruning method with an adaptive threshold based on the current CU size is applied to remove redundant MV candidates.
2. Interleaved List-1 MV candidates and List-0 MV candidates are further derived directly from the regular merge candidate list, where List-1 MV candidates are higher priority than List-0 MV candidates. The same pruning method with the adaptive threshold is also applied to remove redundant MV candidates.
3. Zero MV candidates are padded until the GPM candidate list is full.

The GPM-MMVD and GPM-TM are exclusively enabled to one GPM CU. This is done by firstly signaling the GPM-MMVD syntax. When both two GPM-MMVD control flags are equal to false (i.e., the GPM-MMVD are disabled for two GPM partitions), the GPM-TM flag is signaled to indicate whether the template matching is applied to the two GPM partitions. Otherwise (at least one GPM-MMVD flag is equal to true), the value of the GPM-TM flag is inferred to be false.

2.1.22. GPM with Inter and Intra Prediction (GPM Inter-Intra)

With the GPM inter-intra, pre-defined intra prediction modes against geometric partitioning line can be selected in addition to merge candidates for each non-rectangular split region in the GPM-applied CU. In the proposed method, whether intra or inter prediction mode is determined for each GPM-separated region with a flag from the encoder. When the inter prediction mode, a uni-prediction signal is generated by MVs from the merge candidate list. On the other hand, when the intra prediction mode, a uni-prediction signal is generated from the neighboring pixels for the intra prediction mode specified by an index from the encoder. The variation of the possible intra prediction modes is restricted by the geometric shapes. Finally, the two uni-prediction signals are blended with the same way of ordinary GPM.

### 2.1.23. Adaptive Decoder Side Motion Vector Refinement (Adaptive DMVR)

Adaptive decoder side motion vector refinement method consists of the two new merge modes introduced to refine MV only in one direction, either L0 or L1, of the bi prediction for the merge candidates that meet the DMVR conditions. The multi-pass DMVR process is applied for the selected merge candidate to refine the motion vectors, however either MVD0 or MVD1 is ^{se}t to zero in the 1st pass (i.e. PU level) DMVR.

Like the regular merge mode, merge candidates for the proposed merge modes are derived from the spatial neighboring coded blocks, TMVPs, non-adjacent blocks, HMVPs, and pair-wise candidate. The difference is that only those meet DMVR conditions are added into the candidate list. The same merge candidate list is used by the two proposed merge modes and merge index is coded as in regular merge mode.

### 2.1.24. Bilateral Matching AMVP-MERGE Mode (AMVP-MERGE)

In the AMVP-merge mode, the bi-directional predictor is composed of an AMVP predictor in one direction and a merge predictor in the other direction.

AMVP part of the proposed mode is signaled as a regular uni-directional AMVP, i.e. reference index and MVD are signaled, and it has a derived MVP index if template matching is used (TM_AMVP) or MVP index is signaled when template matching is disabled. Merge index is not signalled, and merge predictor is selected from the candidate list with smallest template or bilateral matching cost.

When the selected merge predictor and the AMVP predictor satisfy DMVR condition, which is there is at least one reference picture from the past and one reference picture from the future relatively to the current picture and the distances from two reference pictures to the current picture are the same, the bilateral matching MV refinement is applied for the merge MV candidate and AMVP MVP as a starting point. Otherwise, if template matching functionality is enabled, template matching MV refinement is applied to the merge predictor or the AMVP predictor which has a higher template matching cost.

The third pass which is 8×8 sub-PU BDOF refinement of the multi-pass DMVR is enabled to AMVP-merge mode coded block.

### 2.1.25. IBC Merge/AMVP List Construction

The IBC merge/AMVP list construction is modified as follows:
Only if an IBC merge/AMVP candidate is valid, it can be inserted into the IBC merge/AMVP candidate list.
Above-right, bottom-left, and above-left spatial candidates and one pairwise average candidate can be added into the IBC merge/AMVP candidate list.
Template based adaptive reordering (ARMC-TM) is applied to IBC merge list.

The HMVP table size for IBC is increased to 25. After up to 20 IBC merge candidates are derived with full pruning, they are reordered together. After reordering, the first 6 candidates with the lowest template matching costs are selected as the final candidates in the IBC merge list.

The zero vectors' candidates to pad the IBC Merge/AMVP list are replaced with a set of BVP candidates located in the IBC reference region. A zero vector is invalid as a block vector in IBC merge mode, and consequently, it is discarded as BVP in the IBC candidate list.

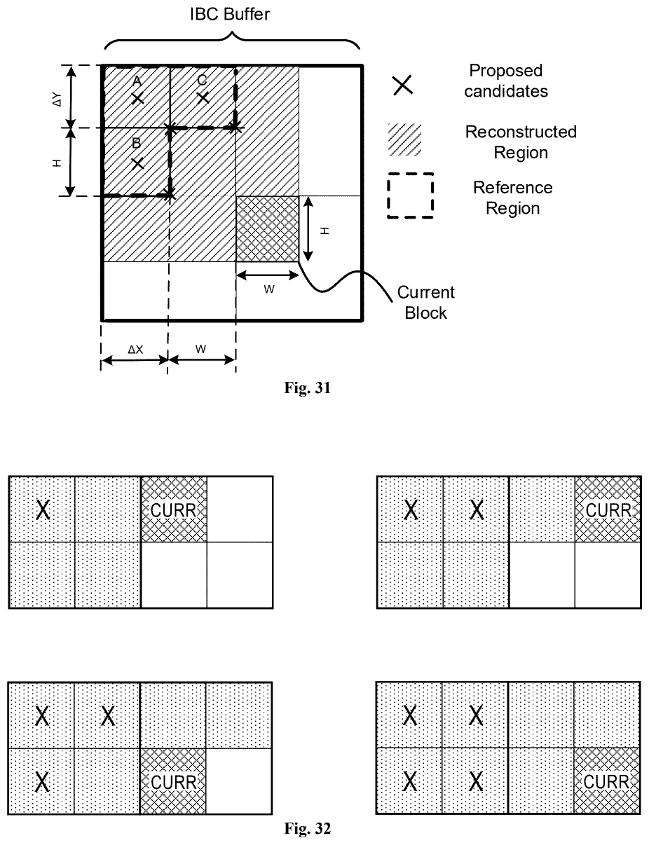

Three candidates are located on the nearest corners of the reference region, and three additional candidates are determined in the middle of the three sub-regions (A, B, and C), whose coordinates are determined by the width, and height of the current block and the ΔX and ΔY parameters, as is depicted in FIG. 31.

2.1.26. IBC with Template Matching

Template Matching is used in IBC for both IBC merge mode and IBC AMVP mode.

The IBC-TM merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0, −H) and top-left (−W, −H), where W is the width and H the height of the current CU.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC-TM merge list. Each of those 3 selected candidates are refined using the Template Matching method and sorted according to their resulting Template Matching cost. Only the 2 first ones are then considered in the motion estimation process as usual.

The Template Matching refinement for both IBC-TM merge and AMVP modes is quite simple since IBC motion vectors are constrained (i) to be integer and (ii) within a reference region as shown in FIG. 32. So, in IBC-TM merge mode, all refinements are performed at integer precision, and in IBC-TM AMVP mode, they are performed either at integer or 4-pel precision depending on the AMVR value. Such a refinement accesses only to samples without interpolation. In both cases, the refined motion vectors and the used template in each refinement step must respect the constraint of the reference region.

### 2.1.27. IBC Reference Area

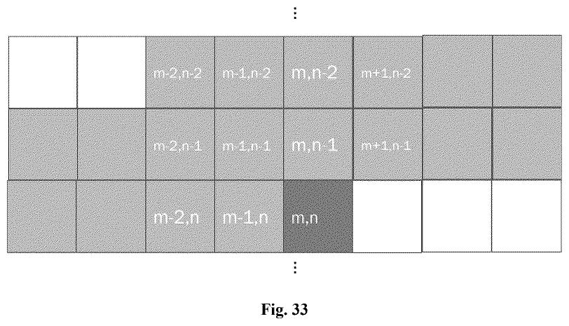

The reference area for IBC is extended to two CTU rows above. FIG. 33 illustrates the reference area for coding CTU (m,n). Specifically, for CTU (m,n) to be coded, the reference area includes CTUs with index (m−2,n−2) . . . (W,n−2),(0,n−1) . . . (W,n−1),(0,n) . . . (m,n), where W denotes the maximum horizontal index within the current tile, slice or picture. This setting ensure that for CTU size being 128, IBC does not require extra memory in the current ETM platform. The per-sample block vector search (or called local search) range is limited to [−(C<<1), C>>2] horizontally and [−C, C>>2] vertically to adapt to the reference area extension, where C denotes the CTU size.

### 2.1.28. MVD Sign Prediction

In this method, possible MVD sign combinations are sorted according to the template matching cost and index corresponding to the true MVD sign is derived and context coded. At decoder side, the MVD signs are derived as following:
1. Parse the magnitude of MVD components;
2. Parse context-coded MVD sign prediction index;
3. Build MV candidates by creating combination between possible signs and absolute MVD value and add it to the MV predictor;
4. Derive MVD sign prediction cost for each derived MV based on template matching cost and sort;
5. Use MVD sign prediction index to pick the true MVD sign.

MVD sign prediction is applied to inter AMVP, affine AMVP, MMVD and affine MMVD modes.

### 2.1.29. Enhanced Bi-Directional Motion Compensation

In bi-directional motion compensation the out of boundary (OOB) prediction samples are discarded and only the non-OOB predictors are used to generate the final predictor. Specifically, let Pos_x_{i,j} and Pos_y_{i,j} denote the position of one prediction sample in one current block,

$${Mv\_x}_{i , j}^{Lx} and {Mv\_y}_{i , j}^{Lx} ( x = 0 , 1 )$$

denote the MV of the current block; Pos_{LeftBdry}, Pos_{RightBdry}, Pos_{TopBdry} and Pos_{BottomBdry} are the positions of four boundaries of the picture. One prediction sample is regarded as OOB when at least one of the following conditions is satisfied:

$$( {Pos\_x}_{i , j} + {Mv\_x}_{i , j}^{Lx} ) > ( {Pos}_{RightBdry} + half\_pixel ) ,$$

$$( {Pos\_x}_{i , j} + {Mv\_x}_{i , j}^{Lx} ) < ( {Pos}_{LeftBdry} - half\_pixel ) ,$$

$$( {Pos\_y}_{i , j} + {Mv\_y}_{i , j}^{Lx} ) > ( {Pos}_{BottomBdry} + half\_pixel ) ,$$

$$( {Pos\_y}_{i , j} + {Mv\_y}_{i , j}^{Lx} ) < ( {Pos}_{TopBdry} - half\_pixel )$$

where half_pixel is equal to 8 that represents the half-pel sample distance in the 1/16-pel sample precision.

After examining the OOB condition for each sample, the final prediction samples of one bi-directional block is generated as follows:

| | |
|---|---|
| $If {P}_{i , j}^{L 0} is OOB and {P}_{i , j}^{L 1} is non - OOB$ | |
| | ${P}_{i , j}^{final} = {P}_{i , j}^{L 1}$ |
| $else if {P}_{i , j}^{L 0} is non - OOB and {P}_{i , j}^{L 1} is OOB$ | |
| | ${P}_{i , j}^{final} = {P}_{i , j}^{L 0}$ |
| else | |
| ${P}_{i , j}^{final} = ( {P}_{i , j}^{L 0} + {P}_{i , j}^{L 1} + 1 ) >> 1$ | |

OOB checking process is also applicable when BCW is enabled.

### 2.1.30. Block Level Reference Picture List Reordering

A block level reference picture reordering method based on template matching is used. For the uni-prediction AMVP mode, the reference pictures in List 0 and List 1 are interweaved to generate a joint list. For each hypothesis of the reference picture in the joint list template matching is performed to calculate the cost. The joint list is reordered based on ascending order of the template matching cost. The index of the selected reference picture in the reordered joint list is signaled in the bitstream. For the bi-prediction AMVP mode, a list of pairs of reference pictures from List 0 and List 1 is generated and similarly reordered based on the template matching cost. The index of the selected pair is signaled.

### 2.1.31. History-Parameter-Based Affine Model Inheritance and Non-Adjacent Affine Mode

History-parameter-based affine model inheritance (HAMI) allows the affine model to be inherited from a previously affine-coded block which may not be neighboring to the current block. Similar to the enhanced regular merge mode, non-adjacent affine mode (NA-AFF) is introduced.

A first history-parameter table (HPT) is established. An entry of the first HPT stores a set of affine parameters: a, b, c and d, each of which is represented by a 16-bit signed integer. Entries in HPT is categorized by reference list and reference index. Five reference indices are supported for each reference list in HPT. In a formular way, the category of HPT (denoted as HPTCat) is calculated as

$$HPTCat ( RefList , RefIdx ) = 5 \times RefList + min ( RefIdx , 4 ) ,$$

wherein RefList and RefIdx represents a reference picture list (0 or 1) and a reference index, respectively. For each category, at most seven entries can be stored, resulting in 70 entries totally in HPT. At the beginning of each CTU row, the number of entries for each category is initialized as zero. After decoding an affine-coded CU with reference list RefListcur and RefIdxcur, the affine parameters are utilized to update entries in the category HPTCat(RefListcur, RefIdxcur) in a way similar to HMVP table updating.

A history-affine-parameter-based candidate (HAPC) is derived from one of the seven neighbouring 4×4 blocks denoted as A0, A1, A2, B0, B1, B2 or B3 in FIG. 4 and a set of affine parameters stored in a corresponding entry in the first HPT. The MV of a neighbouring 4×4 block served as the base MV. In a formulating way, the MV of the current block at position (x, y) is calculated as:

$$\{ \begin{matrix}{mv}^{h} ( x , y ) = a ( x - {x}_{base} ) + c ( y - {y}_{base} ) + {mv}_{base}^{h} \\ {mv}^{v} ( x , y ) = b ( x - {x}_{base} ) + d ( y - {y}_{base} ) + {mv}_{base}^{v}\end{matrix} ,$$

where (mv^{h}_{base}, mv^{v}_{base}) represents the MV of the neighbouring 4×4 block, (x_{base}, y_{base}) represents the center position of the neighbouring 4×4 block. (x, y) can be the top-left, top-right and bottom-left corner of the current block to obtain the corner-position MVs (CPMVs) for the current block, or it can be the center of the current block to obtain a regular MV for the current block.

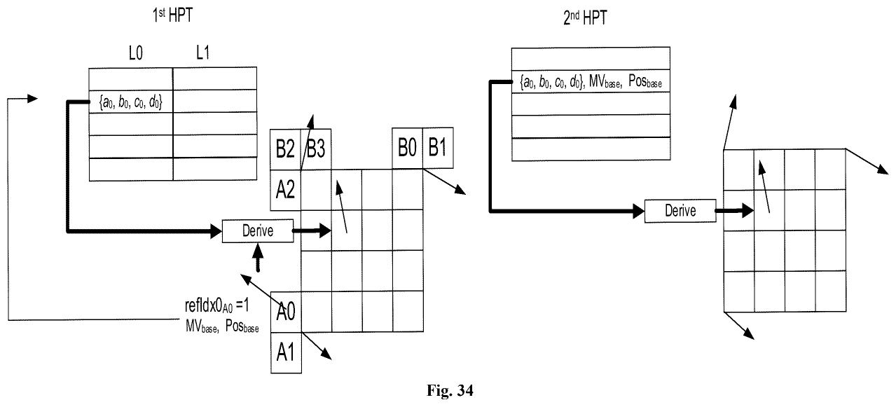

A second history-parameter table (HPT) with base MV information is also appended. There are nine entries in the second HPT, wherein an entry comprises a base MV, a reference index and four affine parameters for each reference list, and a base position. An additional merge HAPC can be generated from the second HPT with the base MV information the corresponding affine models stored in an entry. The difference between the first HPT and the second HPT is illustrated in FIG. 34.

Moreover, pair-wised affine merge candidates are generated by two affine merge candidates which are history-derived or not history-derived. A pair-wised affine merge candidates is generated by averaging the CPMVs of existing affine merge candidates in the list.

As a response to new HAPCs being introduced, the size of sub-block-based merge candidate list is increased from five to fifteen, which are all involved in the ARMC [10] process.

In NA-AFF, the pattern of obtaining non-adjacent spatial neighbors is shown in FIG. 6. Same as the existing non-adjacent regular merge candidates [8], the distances between non-adjacent spatial neighbors and current coding block in the NA-AFF are also defined based on the width and height of current CU.

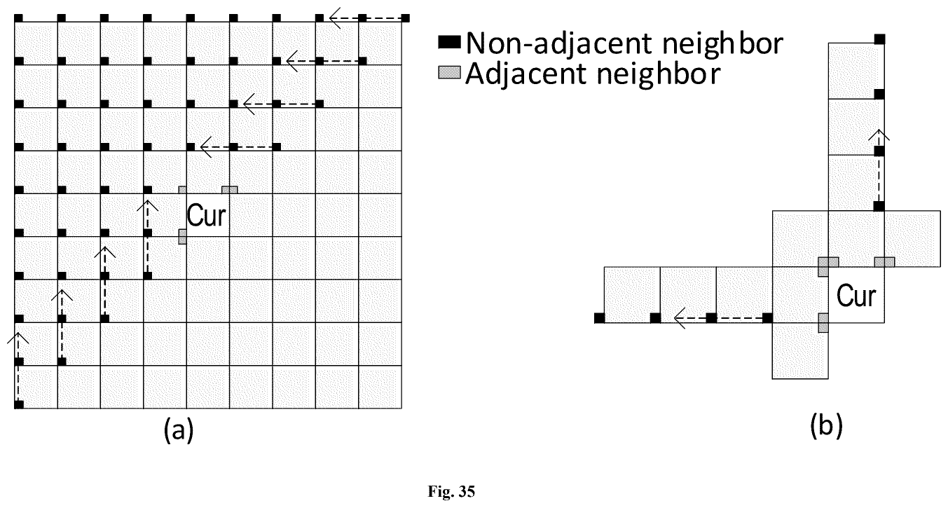

The motion information of the non-adjacent spatial neighbors in FIG. 6 is utilized to generate additional inherited and constructed affine merge/AMVP candidates. Specifically, for inherited candidates, the same derivation process of the inherited affine merge/AMVP candidates in the VVC is kept unchanged except that the CPMVs are inherited from non-adjacent spatial neighbors. The non-adjacent spatial neighbors are checked based on their distances to the current block, i.e., from near to far. At a specific distance, only the first available neighbor (that is coded with the affine mode) from each side (e.g., the left and above) of the current block is included for inherited candidate derivation. FIG. 35 illustrates spatial neighbors for deriving affine merge/AMVP candidates. Moreover, subpicture (a) of FIG. 35 illustrates spatial neighbors for deriving inherited candidates, and subpicture (b) of FIG. 35 illustrates spatial neighbors for deriving the first type of constructed candidates. As indicated by the dash arrows in subpicture (a) of FIG. 35, the checking orders of the neighbors on the left and above sides are bottom-to-up and right-to-left, respectively.

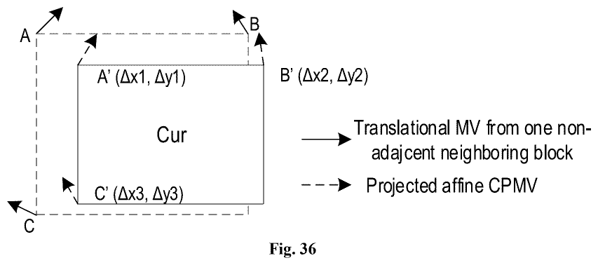

For the first type of constructed candidates, as shown in the subpicture (b) of FIG. 35, the positions of one left and above non-adjacent spatial neighbors are firstly determined independently; After that, the location of the top-left neighbor can be determined accordingly which can enclose a rectangular virtual block together with the left and above non-adjacent neighbors. Then, as shown in the FIG. 36, the motion information of the three non-adjacent neighbors is used to form the CPMVs at the top-left (A), top-right (B) and bottom-left (C) of the virtual block, which is finally projected to the current CU to generate the corresponding constructed candidates.

The NA-AFF candidates are inserted into the existing affine merge candidate list and affine AMVP candidate list according to the following orders:

### Affine Merge Mode:

1. SbTMVP candidate, if available.
2. Inherited from adjacent neighbors.
3. Inherited from non-adjacent neighbors.
4. Constructed from adjacent neighbors.
5. The first type of constructed affine candidates from non-adjacent neighbors.
6. Zero MVs.

### Affine AMVP Mode:

1. Inherited from adjacent neighbors.
2. Constructed from adjacent neighbors.
3. Translational MVs from adjacent neighbors.
4. Translational MVs from temporal neighbors.
5. Inherited from non-adjacent neighbors.
6. The first type of constructed affine candidates from non-adjacent neighbors.
7. Zero MVs.

Due to the inclusion of the additional candidates generated by NA-AFF, the size of the affine merge candidate list is increased from 5 to 15. The subgroup size of ARMC for the affine merge mode is increased from 3 to 15.

### In NA-AFF:

1. The area from where the non-adjacent neighbors come is restricted to be within the current CTU (i.e., no additional storage requirements for line buffer).
2. The storage granularity for affine motion information, including CPMVs and reference indexes, is reduced from 8×8 to 16×16 (i.e., only the affine motion from the top-left 8×8 block is saved). Additionally, the saved CPMVs are projected to each 16×16 block before storage, such that the position and size information are not needed.
3. Only the top-left and top-right CPMVs are stored (i.e., always using 4-parameter affine model for NA-AFF).

### 2.1.32. Regression Based Affine Candidate Derivation Method

Regression based affine candidate derivation method is proposed. The subblock motion field from a previous coded affine CU and the motion vectors from the adjacent subblocks of current CU are used as the input for the regression process. The predicted CPMVs instead of the subblock motion field for current block are derived as output. The derived CPMVs can be added into the subblock merge candidate list or the affine AMVP list. The scanning pattern for the previously coded affine CU is the same as the non-adjacent scanning pattern that is used in the regular merge candidate list construction.

### 2.2. Transform and Coefficient Coding

2.2.1. Large Block-Size Transforms with High-Frequency Zeroing

In VVC, large block-size transforms, up to 64×64 in size, are enabled, which is primarily useful for higher resolution video, e.g., 1080p and 4K sequences. High frequency transform coefficients are zeroed out for the transform blocks with size (width or height, or both width and height) equal to 64, so that only the lower-frequency coefficients are retained. For example, for an M×N transform block, with M as the block width and N as the block height, when M is equal to 64, only the left 32 columns of transform coefficients are kept. Similarly, when N is equal to 64, only the top 32 rows of transform coefficients are kept. When transform skip mode is used for a large block, the entire block is used without zeroing out any values. In addition, transform shift is removed in transform skip mode. The VTM also supports configurable max transform size in SPS, such that encoder has the flexibility to choose up to 32-length or 64-length transform size depending on the need of specific implementation.

### 2.2.2. Multiple Transform Selection (MTS) for Core Transform

In addition to DCT-II which has been employed in HEVC, a Multiple Transform Selection (MTS) scheme is used for residual coding both inter and intra coded blocks. It uses multiple selected transforms from the DCT8/DST7. The newly introduced transform matrices are DST-VII and DCT-VIII. Table 6 shows the basis functions of the selected DST/DCT.

TABLE 6
Transform basis functions of DCT-II/VIII and DSTVII for N-point input

| Transform Type | Basis function Tᵢ(j), i, j = 0, 1, . . . , N −1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

In order to keep the orthogonality of the transform matrix, the transform matrices are quantized more accurately than the transform matrices in HEVC. To keep the intermediate values of the transformed coefficients within the 16-bit range, after horizontal and after vertical transform, all the coefficients are to have 10-bit.

In order to control MTS scheme, separate enabling flags are specified at SPS level for intra and inter, respectively. When MTS is enabled at SPS, a CU level flag is signalled to indicate whether MTS is applied or not. Here, MTS is applied only for luma. The MTS signaling is skipped when one of the below conditions is applied.
The position of the last significant coefficient for the luma TB is less than 1 (i.e., DC only).
The last significant coefficient of the luma TB is located inside the MTS zero-out region.

If MTS CU flag is equal to zero, then DCT2 is applied in both directions. However, if MTS CU flag is equal to one, then two other flags are additionally signalled to indicate the transform type for the horizontal and vertical directions, respectively. Transform and signalling mapping table as shown in Table 7. Unified the transform selection for ISP and implicit MTS is used by removing the intra-mode and block-shape dependencies. If current block is ISP mode or if the current block is intra block and both intra and inter explicit MTS is on, then only DST7 is used for both horizontal and vertical transform cores. When it comes to transform matrix precision, 8-bit primary transform cores are used. Therefore, all the transform cores used in HEVC are kept as the same, including 4-point DCT-2 and DST-7, 8-point, 16-point and 32-point DCT-2. Also, other transform cores including 64-point DCT-2, 4-point DCT-8, 8-point, 16-point, 32-point DST-7 and DCT-8, use 8-bit primary transform cores.

TABLE 7
Transform and signalling mapping table

| MTS_CU_{—} | MTS_Hor_{—} | MTS_Ver_{—} | Intra/inter | |
|---|---|---|---|---|
| flag | flag | flag | Horizontal | Vertical |
| 0 | | | DCT2 | |
| 1 | 0 | 0 | DST7 | DST7 |
| | 0 | 1 | DCT8 | DST7 |
| | 1 | 0 | DST7 | DCT8 |
| | 1 | 1 | DCT8 | DCT8 |

To reduce the complexity of large size DST-7 and DCT-8, High frequency transform coefficients are zeroed out for the DST-7 and DCT-8 blocks with size (width or height, or both width and height) equal to 32. Only the coefficients within the 16×16 lower-frequency region are retained.

As in HEVC, the residual of a block can be coded with transform skip mode. To avoid the redundancy of syntax coding, the transform skip flag is not signalled when the CU level MTS_CU_flag is not equal to zero. Note that implicit MTS transform is set to DCT2 when LFNST or MIP is activated for the current CU. Also the implicit MTS can be still enabled when MTS is enabled for inter coded blocks.

### 2.2.3. Low-Frequency Non-Separable Transform (LFNST)

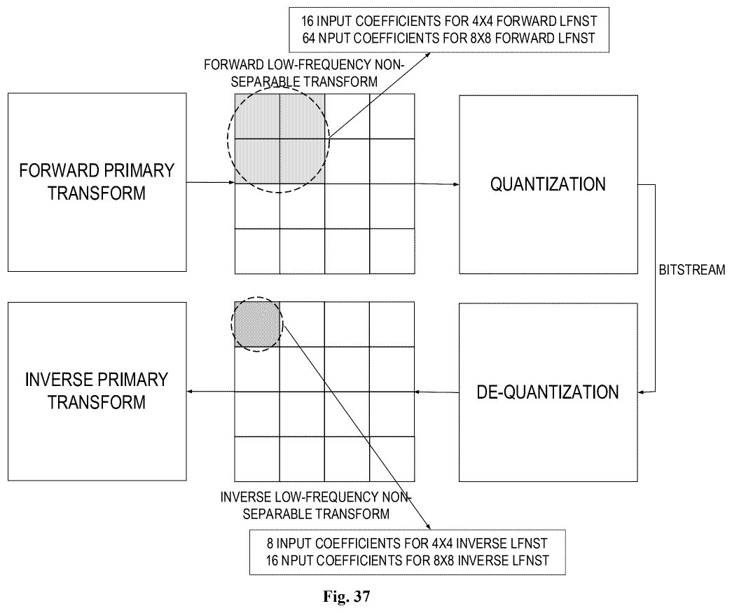

In VVC, LFNST is applied between forward primary transform and quantization (at encoder) and between de-quantization and inverse primary transform (at decoder side) as shown in FIG. 37. In LFNST, 4×4 non-separable transform or 8×8 non-separable transform is applied according to block size. For example, 4×4 LFNST is applied for small blocks (i.e., min (width, height)<8) and 8×8 LFNST is applied for larger blocks (i.e., min (width, height)>4).

Application of a non-separable transform, which is being used in LFNST, is described as follows using input as an example. To apply 4×4 LFNST, the 4×4 input block X

$$X = [ \begin{matrix}{X}_{00} & {X}_{01} & {X}_{02} & {X}_{03} \\ {X}_{10} & {X}_{11} & {X}_{12} & {X}_{13} \\ {X}_{20} & {X}_{21} & {X}_{22} & {X}_{23} \\ {X}_{30} & {X}_{31} & {X}_{32} & {X}_{33}\end{matrix} ] \qquad ( 3 - 31 )$$

is first represented as a vector [symbol] :

$$( 3 - 32 )$$

$$\vec{X} = {[ {X}_{00} {X}_{01} {X}_{02} {X}_{03} {X}_{10} {X}_{11} {X}_{12} {X}_{13} {X}_{20} {X}_{21} {X}_{22} {X}_{23} {X}_{30} {X}_{31} {X}_{32} {X}_{33} ]}^{T}$$

The non-separable transform is calculated as [symbol] =T· [symbol] , where [symbol] indicates the transform coefficient vector, and T is a 16×16 transform matrix. The 16×1 coefficient vector [symbol] is subsequently re-organized as 4×4 block using [symbol] the scanning order for that block (horizontal, vertical or diagonal). The coefficients with smaller index will be placed with the smaller scanning index in the 4×4 coefficient block.

### 2.2.3.1. Reduced Non-Separable Transform

LFNST (low-frequency non-separable transform) is based on direct matrix multiplication approach to apply non-separable transform so that it is implemented in a single pass without multiple iterations. However, the non-separable transform matrix dimension needs to be reduced to minimize computational complexity and memory space to store the transform coefficients. Hence, reduced non-separable transform (or RST) method is used in LFNST. The main idea of the reduced non-separable transform is to map an N (N is commonly equal to 64 for 8×8 NSST) dimensional vector to an R dimensional vector in a different space, where N/R (R<N) is the reduction factor. Hence, instead of N×N matrix, RST matrix becomes an R×N matrix as follows:

$${T}_{R \times N} = [ \begin{matrix}{t}_{11} & {t}_{12} & {t}_{13} & … & {t}_{1 N} \\ {t}_{21} & {t}_{22} & {t}_{23} & & {t}_{2 N} \\ & ⋮ & & ⋱ & ⋮ \\ {t}_{R 1} & {t}_{R 2} & {t}_{R 3} & … & {t}_{RN}\end{matrix} ] \qquad ( 3 - 33 )$$

where the R rows of the transform are R bases of the N dimensional space. The inverse transform matrix for RT is the transpose of its forward transform. For 8×8 LFNST, a reduction factor of 4 is applied, and 64×64 direct matrix, which is conventional 8×8 non-separable transform matrix size, is reduced to 16×48 direct matrix. Hence, the 48×16 inverse RST matrix is used at the decoder side to generate core (primary) transform coefficients in 8×8 top-left regions. When 16×48 matrices are applied instead of 16×64 with the same transform set configuration, each of which takes 48 input data from three 4×4 blocks in a top-left 8×8 block excluding right-bottom 4×4 block. With the help of the reduced dimension, memory usage for storing all LFNST matrices is reduced from 10 KB to 8 KB with reasonable performance drop. In order to reduce complexity LFNST is restricted to be applicable only if all coefficients outside the first coefficient sub-group are non-significant. Hence, all primary-only transform coefficients have to be zero when LFNST is applied. This allows a conditioning of the LFNST index signalling on the last-significant position, and hence avoids the extra coefficient scanning in the current LFNST design, which is needed for checking for significant coefficients at specific positions only. The worst-case handling of LFNST (in terms of multiplications per pixel) restricts the non-separable transforms for 4×4 and 8×8 blocks to 8×16 and 8×48 transforms, respectively. In those cases, the last-significant scan position has to be less than 8 when LFNST is applied, for other sizes less than 16. For blocks with a shape of 4×N and N×4 and N>8, the proposed restriction implies that the LFNST is now applied only once, and that to the top-left 4×4 region only. As all primary-only coefficients are zero when LFNST is applied, the number of operations needed for the primary transforms is reduced in such cases. From encoder perspective, the quantization of coefficients is remarkably simplified when LFNST transforms are tested. A rate-distortion optimized quantization has to be done at maximum for the first 16 coefficients (in scan order), the remaining coefficients are enforced to be zero.

### 2.2.3.2. LFNST Transform Selection

There are totally 4 transform sets and 2 non-separable transform matrices (kernels) per transform set are used in LFNST. The mapping from the intra prediction mode to the transform set is pre-defined as shown in Table 8. If one of three CCLM modes (INTRA_LT_CCLM, INTRA_T_CCLM or INTRA_L_CCLM) is used for the current block (81<=predModeIntra<=83), transform set 0 is selected for the current chroma block. For each transform set, the selected non-separable secondary transform candidate is further specified by the explicitly signalled LFNST index. The index is signalled in a bit-stream once per Intra CU after transform coefficients.

TABLE 8
Transform selection table

| IntraPredMode | Tr. set index |
|---|---|
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

2.2.3.3. LFNST Index Signaling and Interaction with Other Tools

Since LFNST is restricted to be applicable only if all coefficients outside the first coefficient sub-group are non-significant, LFNST index coding depends on the position of the last significant coefficient. In addition, the LFNST index is context coded but does not depend on intra prediction mode, and only the first bin is context coded. Furthermore, LFNST is applied for intra CU in both intra and inter slices, and for both Luma and Chroma. If a dual tree is enabled, LFNST indices for Luma and Chroma are signaled separately. For inter slice (the dual tree is disabled), a single LFNST index is signaled and used for both Luma and Chroma.

Considering that a large CU greater than 64×64 is implicitly split (TU tiling) due to the existing maximum transform size restriction (64×64), an LFNST index search could increase data buffering by four times for a certain number of decode pipeline stages. Therefore, the maximum size that LFNST is allowed is restricted to 64×64. Note that LFNST is enabled with DCT2 only. The LFNST index signaling is placed before MTS index signaling.

The use of scaling matrices for perceptual quantization is not evident that the scaling matrices that are specified for the primary matrices may be useful for LFNST coefficients. Hence, the uses of the scaling matrices for LFNST coefficients are not allowed. For single-tree partition mode, chroma LFNST is not applied.

### 2.2.4. Subblock Transform (SBT)

In VTM, subblock transform is introduced for an inter-predicted CU. In this transform mode, only a sub-part of the residual block is coded for the CU. When inter-predicted CU with cu_cbf equal to 1, cu_sbt_flag may be signaled to indicate whether the whole residual block or a sub-part of the residual block is coded. In the former case, inter MTS information is further parsed to determine the transform type of the CU. In the latter case, a part of the residual block is coded with inferred adaptive transform and the other part of the residual block is zeroed out.

When SBT is used for an inter-coded CU, SBT type and SBT position information are signaled in the bitstream.

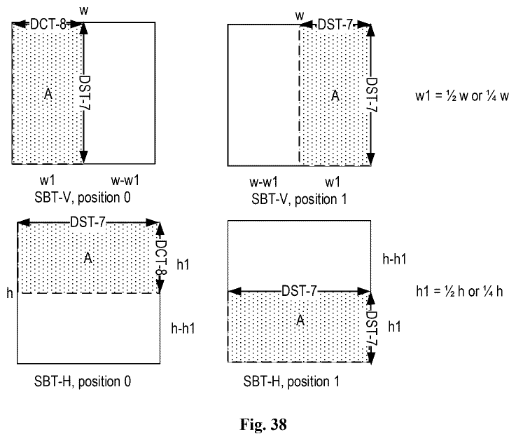

There are two SBT types and two SBT positions, as indicated in FIG. 38. For SBT-V (or SBT-H), the TU width (or height) may equal to half of the CU width (or height) or ¼ of the CU width (or height), resulting in 2:2 split or 1:3/3:1 split. The 2:2 split is like a binary tree (BT) split while the 1:3/3:1 split is like an asymmetric binary tree (ABT) split. In ABT splitting, only the small region contains the non-zero residual. If one dimension of a CU is 8 in luma samples, the 1:3/3:1 split along that dimension is disallowed. There are at most 8 SBT modes for a CU.

Position-dependent transform core selection is applied on luma transform blocks in SBT-V and SBT-H (chroma TB always using DCT-2). The two positions of SBT-H and SBT-V are associated with different core transforms. More specifically, the horizontal and vertical transforms for each SBT position is specified in FIG. 38. For example, the horizontal and vertical transforms for SBT-V position 0 is DCT-8 and DST-7, respectively. When one side of the residual TU is greater than 32, the transform for both dimensions is set as DCT-2. Therefore, the subblock transform jointly specifies the TU tiling, cbf, and horizontal and vertical core transform type of a residual block.

The SBT is not applied to the CU coded with combined inter-intra mode.

### 2.2.5. Maximum Transform Size and Zeroing-Out of Transform Coefficients

Both CTU size and maximum transform size (i.e., all MTS transform kernels) are extended to 256, where the maximum intra coded block can have a size of 128×128. The maximum CTU size is set to 256 for UHD sequences and it is set to 128, otherwise. In the primary transformation process, there is no normative zeroing out operation applied on transform coefficients. However, if LFNST is applied, the primary transform coefficients outside the LFNST region are normatively zeroed-out.

### 2.2.6. Enhanced MTS for Intra Coding

In the current VVC design, for MTS, only DST7 and DCT8 transform kernels are utilized which are used for intra and inter coding.

Additional primary transforms including DCT5, DST4, DST1, and identity transform (IDT) are employed. Also MTS set is made dependent on the TU size and intra mode information. 16 different TU sizes are considered, and for each TU size 5 different classes are considered depending on intra-mode information. For each class, 1, 4 or 6 different transform pairs are considered. Number of intra MTS candidates are adaptively selected (between 1, 4 and 6 MTS candidates) depending on the sum of absolute value of transform coefficients. The sum is compared against the two fixed thresholds to determine the total number of allowed MTS candidates:
1 candidate: sum<=th0.
4 candidates: th0<sum<=th1.
6 candidates: sum>th1.

Note, although a total of 80 different classes are considered, some of those different classes often share exactly same transform set. So there are 58 (less than 80) unique entries in the resultant LUT.

For angular modes, a joint symmetry over TU shape and intra prediction is considered. So, a mode i (i>34) with TU shape A×B will be mapped to the same class corresponding to the mode j=(68−i) with TU shape B×A. However, for each transform pair the order of the horizontal and vertical transform kernel is swapped.

For example, for a 16×4 block with mode 18 (horizontal prediction) and a 4×16 block with mode 50 (vertical prediction) are mapped to the same class. However, the vertical and horizontal transform kernels are swapped. For the wide-angle modes the nearest conventional angular mode is used for the transform set determination. For example, mode 2 is used for all the modes between −2 and −14. Similarly, mode 66 is used for mode 67 to mode 80.

2.2.7. Secondary Transformation: LFNST Extension with Large Kernel

The LFNST design in VVC is extended as follows:
The number of LFNST sets (S) and candidates (C) are extended to S=35 and C=3, and the LFNST set (lfnstTrSetIdx) for a given intra mode (predModeIntra) is derived according to the following formula:
   For predModeIntra<2, lfnstTrSetIdx is equal to 2;
   lfnstTrSetIdx=predModeIntra, for predModeIntra in [0,34];
   lfnstTrSetIdx=68−predModeIntra, for predModeIntra in [35,66].
Three different kernels, LFNST4, LFNST8, and LFNST16, are defined to indicate LFNST kernel sets, which are applied to 4×N/N×4 (N≥4), 8×N/N×8 (N≥8), and M×N (M, N≥16), respectively.

The kernel dimensions are specified by:

$$( LFSNT 4 , LFNST 8 * , LFNST 16 \text{*)} = ( 16 \times 16 , 32 \times 64 , 32 \times 96 )$$

The forward LFNST is applied to top-left low frequency region, which is called Region-Of-Interest (ROI). When LFNST is applied, primary-transformed coefficients that exist in the region other than ROI are zeroed out, which is not changed from the VVC standard.

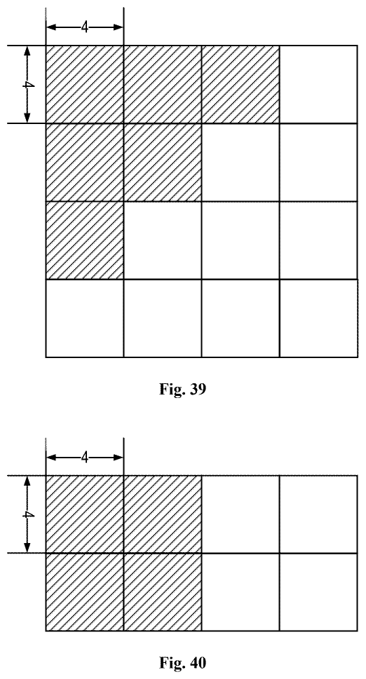

The ROI for LFNST16 is depicted in FIG. 39. It consists of six 4×4 sub-blocks, which are consecutive in scan order. Since the number of input samples is 96, transform matrix for forward LFNST16 can be R×96. R is chosen to be 32 in this contribution, 32 coefficients (two 4×4 sub-blocks) are generated from forward LFNST16 accordingly, which are placed following coefficient scan order.

The ROI for LFNST8 is shown in FIG. 40. The forward LFNST8 matrix can be R×64 and R is chosen to be 32. The generated coefficients are located in the same manner as with LFNST16.

The mapping from intra prediction modes to these sets is shown in Table 9,

TABLE 9
Mapping of intra prediction modes to LFNST set index

| Intra pred. mode | −14 | −13 | −12 | −11 | −10 | −9 | −8 | −7 | −6 | −5 | −4 | −3 | −2 | −1 | 0 |
|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 0 |
| Intra pred. mode | 18 | 19 | 20 | 21 | 22 | 23 | 24 | 25 | 26 | 27 | 28 | 29 | 30 | 31 | 32 |
| LFNST set index | 18 | 19 | 20 | 21 | 22 | 23 | 24 | 25 | 26 | 27 | 28 | 29 | 30 | 31 | 32 |

| Intra pred. mode | 1 | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|---|
| LFNST set index | 1 | 2 | 3 | 4 | 5 | 6 | 7 | 8 | 9 | 10 | 11 | 12 | 13 | 14 | 15 | 16 | 17 |
| Intra pred. mode | 33 | 34 | 35 | 36 | 37 | 38 | 39 | 40 | 41 | 42 | 43 | 44 | 45 | 46 | 47 | 48 | 49 |
| LFNST set index | 33 | 34 | 33 | 32 | 31 | 30 | 29 | 28 | 27 | 26 | 25 | 24 | 23 | 22 | 21 | 20 | 19 |

| Intra pred. mode | 50 | 51 | 52 | 53 | 54 | 55 | 56 | 57 | 58 | 59 | 60 | 61 | 62 | 63 | 64 | 65 |
|---|---|---|---|---|---|---|---|---|---|---|---|---|---|---|---|---|
| LFNST set index | 18 | 17 | 16 | 15 | 14 | 13 | 12 | 11 | 10 | 9 | 8 | 7 | 6 | 5 | 4 | 3 |

| Intra pred. mode | 66 | 67 | 68 | 69 | 70 | 71 | 72 | 73 | 74 | 75 | 76 | 77 | 78 | 79 | 80 |
|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 2 |

### 2.2.8. Sign Prediction

The basic idea of the coefficient sign prediction method is to calculate reconstructed residual for both negative and positive sign combinations for applicable transform coefficients and select the hypothesis that minimizes a cost function.

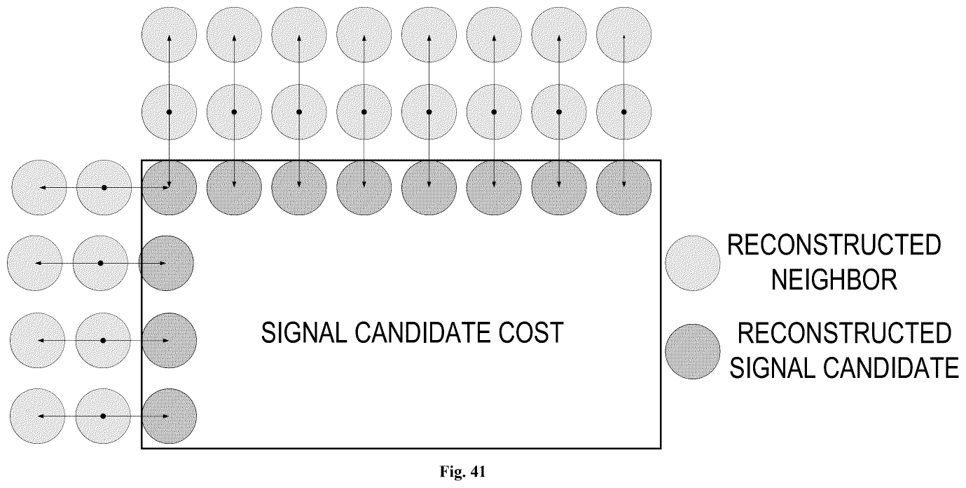

To derive the best sign, the cost function is defined as discontinuity measure across block boundary shown on FIG. 41. It is measured for all hypotheses, and the one with the smallest cost is selected as a predictor for coefficient signs.

The cost function is defined as a sum of absolute second derivatives in the residual domain for the above row and left column as follows:

$$cost = {\sum }_{x = 0}^{w} \vert ( - {R}_{x , - 1} + 2 {R}_{x , 0} - {P}_{x , 1} ) - {r}_{x , 1} \vert + {\sum }_{y = 0}^{h} \vert ( - {R}_{- 1 , y} + 2 {R}_{0 , y} - {P}_{1 , y} ) - {r}_{1 , y} \vert$$

where R is reconstructed neighbors, P is prediction of the current block, and r is the residual hypothesis. The term (−R₋₁+2 R₀−P₁) can be calculated only once per block and only residual hypothesis is subtracted. The transform coefficients with the largest K qIdx value of the top-left 4×4 area are selected. qIdx value is the transform coefficient level after compensating the impact from the multiple quantizers in DQ. A larger qIdx value will produce a larger de-quantized transform coefficient level. qIdx is derived as follows:

$$qIdx = ( abs ( level ) << 1 ) - ( state \& 1 ) ;$$

where level is the transform coefficient level parsed from the bitstream and state is a variable maintained by the encoder and decoder in DQ.

The sign prediction area was extended to maximum 32×32. Signs of top-left M×N block are predicted. The value of M and N is computed as follows:

$$M = min ( w , max W )$$

$$N = min ( h , max H )$$

where, w and h are the width and height of the transform block. The maximum area for sign prediction is not always set to 32×32. Encoder sets the maximum area (maxW, maxH) based on configuration, sequence class and QP, and signaled the area in SPS.

The maximum number of predicted signs is kept unchanged. The sign prediction is also applied to LFNST blocks. And for LFNST block, a maximum of 4 coefficients in the top-left 4×4 area are allowed to be sign predicted.

### 3. PROBLEMS/ISSUES

There are several issues in the existing video coding techniques, which would be further improved for higher coding gain.
1. In ECM-6.0, affine candidates can be derived from adjacent based affine candidates, history based affine candidates, non-adjacent based affine candidates, and regression based affine candidates. Similarity check is conducted for the affine candidate derivation. However, difference similar checking rules are used for affine candidates' derivation. Which may not be optimal.
2. In ECM-6.0, blended mode such as CIIP, OBMC are applied to both camera captured video and screen content video, which may not be efficient.
3. In ECM-6.0, KLT is allowed for explicit inter MTS mode. Specifically, two KLT options (i.e., KLT0 and KLT1) of inter MTS kernels are used to replace DST7 and DCT8 if an inter coded TU is less or equal to 16×16. This design may be changed for a higher coding efficiency.
4. In ECM-6.0, KLT is allowed for inter MTS mode, but the usage of KLT doesn't depend on what kind of inter prediction technique is used to the video unit, which may be further improved.
5. In ECM-6.0, the following intra mode derivation/mapping for intra MTS and LFNST indexing may be improved.
   1) LFNST is applied to chroma component in dual-tree case. For CCLM modes, the collocated luma mode is used for LFNST transform set and transpose flag indexing.
   2) For MIP mode, planar mode is used for LFNST transform set and transpose flag indexing.
   3) MIP is treated as a special mode for intra MTS transform class and intra MTS transform pair indexing.
   4) IntraTMP is allowed to use implicit MTS (e.g., DST7) and LFNST (treated as Planar mode).
   5) In blending mode such as TIMD blended mode and DIMD blended mode, only the first intra mode is considered for MTS/LFNST indexing.

### 4. EMBODIMENTS OF THE PRESENT DISCLOSURE

The detailed embodiments below should be considered as examples to explain general concepts. These embodiments should not be interpreted in a narrow way. Furthermore, these embodiments can be combined in any manner.

The terms ‘video unit’ or ‘coding unit’ or ‘block’ may represent a coding tree block (CTB), a coding tree unit (CTU), a coding block (CB), a CU, a PU, a TU, a PB, a TB.

The term “KLT” may refer to a type of transform. For example, it may refer to Karhunen-Loeve Transform. For example, it may refer to any transform type which is not DCT or DST or Hadmard. The coefficient matrix associated with a certain KLT may be on-line trained or pre-defined (e.g., off-line trained) from some prior knowledge (e.g., residues/coefficients from already decoded neighboring blocks).

In this present disclosure, regarding “a block coded with mode N”, here “mode N” may be a certain prediction mode (e.g., MODE_INTRA, MODE_INTER, MODE_PLT, MODE_IBC, and etc.), or a certain prediction technique (e.g., AMVP, Merge, SMVD, BDOF, PROF, DMVR, AMVR, TM, Affine, CIIP, GPM, GPM intra, MHP, OBMC, LIC, GEO, TPM, MMVD, BCW, HMVP, SbTMVP, subblock coding, hypothesis coding, and etc.), or a certain transform process (IDTX, DCT-X, DST-Y, KLT-Z, wherein X/Y/Z is constant), or a certain filter process (deblocking, SAO, bilateral filter, adaptive loop filter, CCSAO, CC-ALF, etc.).

It is noted that the terminologies mentioned below are not limited to the specific ones defined in existing standards. Any variance of the coding tool is also applicable.
4.1. On the first issue of affine candidates' derivation, the following methods are proposed:
   a. Same logic/rule/procedure of similarity/identity/pruning check may be used for all affine candidates' derivation.
      a. For example, it may refer to affine merge candidates' derivation.
      b. For example, it may refer to affine amvp candidates' derivation.
      c. For example, it may refer to both affine merge and affine amvp candidates' derivation.
      d. For example, it may refer to the derivation of history based affine candidates, non-adjacent based affine candidates, and regression based affine candidates.
   b. The logic/rule/procedure of similarity/identity/pruning check may refer to compare one or more of the following elements associated with a first affine candidate and those with a second affine candidate:
      a. Inter direction (prediction direction);
      b. Affine type (e.g., 6-parameter affine or 4-parameter affine);
      c. Subblock merge type (e.g., sbTMVP or affine);
      d. Bcw index;
      e. LIC flag;
      f. Reference index;
      g. Motion vector (e.g., horizontal component and/or the vertical component);
      h. Control point motion vectors (CPMVs);
      i. the first CPMV (e.g., top-left CPMV) and/or the second CPMV (e.g., top-right CPMV) and/or the third CPMV (e.g., bottom-left CPMV);
      j. Horizontal and/or vertical displacement between the first and the second CPMV (e.g., absolute difference between the horizontal and/or vertical component of the first and the second CPMV);
      k. Horizontal and/or vertical displacement between the first and the third CPMV (e.g., absolute difference between the horizontal and/or vertical component of the first and the third CPMV).
   c. Identical check may be conducted to the comparison of an element listed in bullet b.
      a. For example, if the element associated with a second candidate is identical to that associated with a first candidate, the second candidate is not added to an affine candidate list.
   d. Similarity check may be conducted to a comparison listed in bullet b.
      a. For example, if the element associated with a second candidate is similar to that associated with a first candidate, the second candidate is not added to an affine candidate list.
      b. For example, the “similar” may refer to a threshold-based comparison.
         i. For example, absolute difference is smaller than a threshold.
         ii. For example, absolute difference is no greater than a threshold.
      c. For example, the threshold may be dependent on the block dimensions such as width and/or height.
         i. For example, the threshold is adaptively determined by block width/height.
         ii. For example, smaller threshold may be set for smaller block dimension, while greater threshold may be set for larger block dimension.
      d. For example, the threshold may be a pre-defined fixed value (such as 0 or 1).
      e. For example, the similarity check may be conducted for horizontal components and vertical components of motion vectors, respectively.
      f. For example, the similarity check may be conducted for horizontal components and vertical components of control point motion vectors, respectively.
   e. Whether a similarity/identity/pruning check is applied to the horizontal and/or vertical displacement between the first and the third CPMV, may be dependent on the affine type (e.g., 6-parameter affine or 4-parameter affine).
      a. For example, only if the affine type of the first and second affine candidates are 6-parameter, the similarity/identity/pruning check of horizontal and/or vertical displacement between the first and the third CPMV may be conducted.
4.2. On the second issue of coding tool used for screen content tools, the following methods are proposed:
   a. At least one of the following coding tools may be disallowed or constrained or forbidden for a video unit.
      a) CIIP and/or its variant (e.g., CIIP PDPC, CIIP TM, CIIP TIMD, etc.).
      b) OBMC and/or its variant (e.g., OBMC TM, etc.).
      c) TIMD and/or its variant.
      d) DIMD and/or its variant.
      e) MHP and/or its variant.
      f) DMVR and/or its variant.
      g) interTM and/or its variant.
      h) CCALF and/or its variant.
      i) CCSAO and/or its variant.
   b. Whether it is disallowed or constrained or forbidden for a video unit may be dependent on profile/level/tier.
   c. Whether it is disallowed or constrained or forbidden for a video unit may be dependent on whether the video unit belongs to a certain video type.
      a) The certain video type may refer to screen content video.
   d. Furthermore, a coding tool may be disallowed or constrained or forbidden for a video sequence, or a group of pictures, or a picture, or a slice.
      a) Such constraint or disallowance may be reflected by a bitstream constraint.
      b) Such constraint or disallowance or allowance may be reflected by a syntax element (e.g., a flag) signalled in the bitstream.
   e. A syntax element (e.g., a flag) may be signalled in the bitstream to impose such constraint or disallowance or allowance for a certain coding tool listed in bullet a.
      a) The syntax element may be signalled at sequence level/group of pictures level/picture level/slice level/tile group level, such as in sequence header/picture header/SPS/VPS/DPS/DCI/PPS/APS/slice header/tile group header.
   f. A single syntax element (e.g., a flag) may be signalled to impose such constraint or disallowance or allowance for more than one coding tools listed in bullet a.
      a) The syntax element may be signalled at sequence level/group of pictures level/picture level/slice level/tile group level, such as in sequence header/picture header/SPS/VPS/DPS/DCI/PPS/APS/slice header/tile group header.
   g. Different weight values/factors/tables/sets may be allowed to blend multiple prediction hypotheses of a video unit which is coded with a coding tool X.
      a) For example, which weight value/factor/table/set is allowed to blend multiple prediction hypotheses of a video unit may be dependent on the content type.
      b) For example, a first weight value/factor/table/set may be allowed to blend multiple prediction hypotheses of a first video unit, while a second weight value/factor/table/set may be allowed to blend multiple prediction hypotheses of a second video unit.
      c) For example, the first video unit may belong to camera captured video sequence.
      d) For example, the second video unit may belong to screen content video sequence.
      e) For example, suppose there are two prediction hypotheses to be blended into a final prediction of a video unit:
         i. For a first type of video units, the final prediction block of the video unit coded with coding tool X may be “fully equal to the first prediction hypothesis” or “fully equal to the second prediction hypothesis”.
         1. For example, the allowed weight value/factor/table/set for a video unit may be equal to 0 or 1.
         ii. For a second type of video units, the final blended prediction block of the video unit coded with coding tool X may be “a fusion of both the first prediction hypothesis and the second prediction hypothesis”.
         1. For example, the allowed weight value/factor/table/set for a video unit may be equal to a fraction between 0 or 1 (e.g., the fraction value of the weight for a specific prediction hypothesis may be quantized to an integer in the codec).
      f) For example, the final prediction (e.g., blended) of the video unit with the coding tool X may be further blended/weighted/fused with another video unit coded with another coding tool.
      g) For example, the certain coding tool X may be CIIP and/or its variant.
      h) For example, the certain coding tool X may be GPM and/or its variant.
      i) For example, the certain coding tool X may be MHP and/or its variant.
      j) For example, the certain coding tool X may be OBMC and/or its variant.
      k) For example, the certain coding tool X may be TIMD blended mode and/or its variant.
      l) For example, the certain coding tool X may be DIMD blended mode and/or its variant.
4.3. On the third issue of the general usage of KLT for transform process, the following methods are proposed:
   a. More than two KLT kernels may be allowed in the codec.
   b. A KLT kernel may be allowed for primary transform, and/or secondary transform.
   c. A KLT kernel may be allowed for chroma components.
      a. For example, different KLT kernels may be used to luma and chroma components of a video unit.
         i. Alternatively, all color components of a video unit may share a same KLT kernel.
      b. For example, different KLT kernels may be used to chroma-Cb and chroma-Cr components of a video unit.
         i. Alternatively, chroma-Cb and chroma-Cr components of a video unit may share a same KLT kernel.
   d. A pair of {KLT, flip-KLT} may be allowed/used for {horizontal, vertical} or {vertical, horizontal} transform of a video unit.
      a. For example, {KLT, flip-KLT} denotes a pair of transform kernels contain a first KLT and a second KLT, wherein the transform coefficient matrix of the second KLT (i.e., flip-KLT) may be a transposed matrix of the transform coefficient matrix of the first KLT.
   e. The horizontal or vertical transform type of a video unit may be selected from {KLT-X, flip-KLT-X, DCT-Y, DST-Z}, wherein X/Y/Z are constant (e.g., Y=8, Z=7).
      a. For example, if more than one KLT kernel is defined in the codec, it may be denoted as KLT-X, such as X is equal to an integer value such as 1, 2, 3, . . . , n, that is, KLT-1, KLT-2, KLT-3, . . . , KLT-n.
      b. For example, for a transform block, KLT may be used for horizontal (or vertical) transform, while flip-KLT may be used for vertical (or horizontal) transform.
      c. For example, for a transform block, KLT may be used for horizontal (or vertical) transform, while non-KLT may be used for vertical (or horizontal) transform.
      d. For example, DCT2-KLT, KLT-DCT2 may be allowed for horizontal-vertical or vertical-horizontal transform of a block.
      e. For example, DST7-DCT2, DCT2-DST7, DCT8-DCT2, DCT2-DCT8 may be allowed for horizontal-vertical or vertical-horizontal transform of a block.
      f. For example, the video unit may be coded with a certain prediction/transform/filter mode/technique.
   f. For a certain mode coded video unit, KLT may be the only transform type.
      a. In one example, the certain mode may be SBT.
         i. In one example, for different SBT modes (SBT_horizontal_split, SBT_vertical_split, SBT_half_split, SBT_quad_split), KLT may be used for both horizontal dimension and vertical dimension.
      b. In one example, the certain mode may be MIP.
      c. In one example, a same KLT may be used for both horizontal dimension and vertical dimension of the certain mode coded video unit.
      d. In one example, different KLTs may be used for horizontal dimension and vertical dimension of the certain mode coded video unit.
   g. A KLT based transform type may be additionally allowed for a video unit.
      a. For example, it may be explicitly signalled in addition to the existing MTS options (e.g., MTS index from 0 to 5).
      b. For example, a first syntax element (e.g., a flag) may be signalled to indicate whether KLT is used to a video unit.
         i. Furthermore, alternatively, if KLT is used for a video unit, a second syntax element (e.g., a flag or an index) may be signalled to indicate whether and/or which KLT is used to horizontal and/or vertical transform.
      c. For example, a syntax element (e.g., an index) may be signalled to indicate which KLT is used for the video unit.
         i. For example, the syntax element may be signalled to indicate which KLT pair is used for horizontal transform and vertical transform for the video unit.
         ii. For example, the syntax element may be signalled to indicate which KLT is used for a specific dimension (e.g., either width or height) of the video unit.
         iii. For example, the syntax element may be signalled for both non-KLT and KLT transform.
         1. For example, index 0-1 indicate DCT2-DCT2 pair and transform skip; while index 2−N indicate non-DCT2-DCT2 pairs and non-transformSkip pairs including combinations of non-KLT and KLT.
         iv. For example, the syntax element may be signalled in case that the KLT is used to the video unit.
         1. For example, an index (possible values starting from 0) may be signalled to indicate which KLT pair is used (i.e., at least one direction of horizontal or vertical is using KLT).
         2. For example, in such case, the intra (and/or inter) MTS index may not be signalled (e.g., disabled) to the video unit.
      d. For example, which KLT based transform type is used for a video unit may be implicitly determined.
         i. For example, the implicit determination may be based on the dimension/shape/size of the video unit.
         ii. For example, for a certain length of block dimension (e.g., width or height), a specific KLT type is used in such direction without signalling.
   h. A KLT based transform type may be applied to replace a certain existing transform type for a video unit.
      a. For example, the existing transform type to be replaced may be DST7, or DCT8, or DCT2.
      b. For example, a separable transform maybe replaced by the KLT.
      c. For example, a primary transform and/or secondary transform maybe replaced by the KLT.
   i. For example, the KLT may be non-separable KLT.
   j. For example, the KLT may be separable KLT.
   k. For example, the video unit in which KLT is applied may be intra coded.
   l. For example, the video unit in which KLT is applied may be inter coded.
   m. For example, the KLT may be used as primary transform.
   n. For example, the KLT may be used as secondary transform.
4.4. On the fourth issue of the mode dependent KLT for transform process, the following methods are proposed:
   a. Which KLT kernel is used for a video unit may be dependent on a combination of at least one type of the following coding information:
      a. the coding mode of the video unit.
      b. the dimensions of the video unit.
      c. the motion vectors of the video unit.
      d. the quantization parameters of the video unit.
      e. the temporal layer of the video unit.
   b. Which KLT kernel is used for a video unit may be dependent on the coding mode of the video unit.
      a. For example, it may be based on whether SBT is used to the video unit.
      b. For example, it may be based on whether implicit MTS is used to the video unit.
      c. For example, it may be based on whether explicit MTS is used to the video unit.
      d. For example, it may be based on whether intra MTS is used to the video unit.
      e. For example, it may be based on whether inter MTS is used to the video unit.
      f. For example, it may be based on whether LFNST is used to the video unit.
      g. For example, it may be based on whether IBC and/or its variant mode is used to the video unit.
      h. For example, it may be based on whether PLT and/or its variant mode is used to the video unit.
      i. For example, it may be based on whether intra prediction mode is used to the video unit.
      j. For example, it may be based on whether ISP and/or its variant mode is used to the video unit.
      k. For example, it may be based on whether MIP and/or its variant mode is used to the video unit.
      l. For example, it may be based on whether DIMD and/or its variant mode is used to the video unit.
      m. For example, it may be based on whether TIMD and/or its variant mode is used to the video unit.
      n. For example, it may be based on whether LM/CCLM/CCCM/GLM and/or its variant mode is used to the video unit.
      o. For example, it may be based on whether inter prediction mode is used to the video unit.
      p. For example, it may be based on whether AMVP mode is used to the video unit.
      q. For example, it may be based on whether merge mode is used to the video unit.
      r. For example, it may be based on whether inter/intra/IBC template matching and/or its variant mode is used to the video unit.
      s. For example, it may be based on whether DMVR and/or its variant mode is used to the video unit.
      t. For example, it may be based on whether subblock prediction mode is used to the video unit.
      u. For example, it may be based on whether affine and/or its variant mode is used to the video unit.
      v. For example, it may be based on whether sbTMVP and/or its variant mode is used to the video unit.
      w. For example, it may be based on whether a blended/fused/multi-hypothesis mode and/or its variant mode is used to the video unit.
         i. In one example, it may be based on whether the blended/fused/multi-hypothesis mode contains an intra coded part, such as GPM inter-intra, GPM intra, CIIP, MHP with intra, split GPM, and etc.
      x. For example, it may be based on whether a GPM and/or its variant mode is used to the video unit.
      y. For example, it may be based on whether a CIIP and/or its variant mode is used to the video unit.
      z. For example, it may be based on whether a MHP and/or its variant mode is used to the video unit.
      aa. For example, it may be based on whether a OBMC and/or its variant mode is used to the video unit.
      bb. For example, it may be based on whether a LIC and/or its variant mode is used to the video unit.
   c. Whether to use KLT and/or which KLT kernel is used for a video unit may be dependent on the dimensions of the video unit.
      a. Different KLTs may be applied for blocks with different dimensions.
      b. For example, it may be based on whether the width (W) and/or height (H) of the video unit meet a pre-defined condition, such as one or more combinations of the followings:
         i. W<T1 or W<=T1, wherein T1 could be 8 or 16 or 32 or 64.
         ii. W>T2 or W>=T2, wherein T2 could be 2 or 4 or 8.
         iii. H<T3 or H<=T3, wherein T3 could be 8 or 16 or 32 or 64.
         iv. H>T4 or H>=T4, wherein T4 could be 2 or 4 or 8.
         v. W/H<T5 or W/H<=T5, wherein T5 could be ⅛ or ¼ or ½ or 1 or 2 or 4 or 8 or 16.
         vi. W/H>T6 or W/H>=T6, wherein T6 could be ⅛ or ¼ or ½ or 1 or 2 or 4 or 8 or 16.
         vii. H/W<T7 or H/W<=T7, wherein T7 could be ⅛ or ¼ or ½ or 1 or 2 or 4 or 8 or 16.
         viii. H/W>T8 or H/W>=T8, wherein T8 could be ⅛ or ¼ or ½ or 1 or 2 or 4 or 8 or 16.
         ix. W==T9, wherein T9 could be 8 or 16 or 32 or 64.
         x. H==T10, wherein T10 could be 8 or 16 or 32 or 64.
   d. Which KLT kernel is used for a video unit may be dependent on the motion vectors of the video unit.
      a. In one example, it depends on the magnitude of motion vector(s).
   e. Which KLT kernel is used for a video unit may be dependent on the quantization parameters of the video unit.
      a. In one example, it depends on the base QP derived/signaled in a syntax level higher than slice level (e.g., the PPS, or the SPS).
      b. In one example, it depends on the slice QP.
      c. In one example, it depends on the QP of the coding unit.
   f. Which KLT kernel is used for a video unit may be dependent on the temporal layer of the video unit.
      a. In one example, it depends on whether it is at temporal layer 0, or 1, or 2, or . . . .
   g. Different KLT kernels may be allowed for different video units, depending on coding mode and/or dimensions of the video unit.
      a. In one example, a first KLT set may be used for a first mode set, while a second KLT set may be used for a second mode set.
         i. For example, the first KLT set contains at least one type of KLT kernel.
         ii. For example, the second KLT set contains at least one type of KLT kernel.
         iii. For example, the first mode set contains at least one type of prediction/transform/filter mode.
         iv. For example, the second mode set contains at least one prediction/transform/filter mode.
      b. In one example, video units coded with more than one different type of prediction/transform/filter modes may use a same KLT kernel.
      c. Alternatively, video units coded with different types of prediction/transform/filter modes may use different KLT kernels.
      d. For example, one type of prediction/transform/filter mode may be subblock based prediction mode (e.g., affine, sbTMVP, and etc.).
      e. For example, one type of prediction/transform/filter mode may be affine based prediction modes (e.g., affine amvp, affine merge, and etc.).
      f. For example, one type of prediction/transform/filter mode may be blended/fused/multi-hypothetic based prediction modes (e.g., GPM inter-intra, GPM intra, CIIP, and etc.).
      g. For example, one type of prediction/transform/filter mode may be SBT and its variant.
      h. For example, one type of prediction/transform/filter mode may be ISP and its variant.
      i. For example, one type of prediction/transform/filter mode may be IBC and its variant.
4.5. On the fifth issue of the intra mode derivation/mapping for intra MTS and LFNST indexing, the following methods are proposed:
   a. An intra mode derived from neighboring samples' information may be used for chroma transform process.
      a. For example, the chroma transform process may refer to primary transform (e.g., intra MTS, inter MTS, KLT, DCT2, . . . ) on chroma components in single-tree and/or dual-tree case.
      b. For example, the chroma transform process may refer to secondary transform (e.g., LFNST) on chroma components in single-tree and/or dual-tree case.
      c. For example, a template constructed from above and/or left neighboring samples may be used to derive an intra mode.
         i. The gradient of template samples may be used.
         ii. The largest histogram amplitude values built from the gradients (e.g., histogram of gradients).
         iii. A DIMD based method may be used.
         iv. A TIMD based method may be used.
         v. An intra mode may be determined from template samples (e.g., according to SAD/SATD cost based measurements), based on a pre-set of intra mode candidates.
         vi. How many rows/columns and/or which neighboring samples are used may be based on multiple reference line index.
         vii. How many rows/columns and/or which neighboring samples are used may be pre-defined (e.g., one row/column, or, four row/column, etc.).
         viii. Different rows/columns of neighboring samples may have different weights for cost calculation.
      d. The derived intra mode may be generated for a video unit coded with a mode below:
         i. CCLM mode and/or its variant.
         ii. CCCM mode and/or its variant.
         iii. GLM mode and/or its variant.
         iv. TIMD chroma mode and/or its variant.
         v. DIMD chroma mode and/or its variant.
         vi. Planar mode and/or its variant.
         vii. A chroma intra mode with mode index greater than a certain number which denotes an angular intra mode (such as the number is equal to 80).
      e. The derived intra mode may be used for the MTS transform class index derivation.
      f. The derived intra mode may be used for the MTS transform pair index derivation.
      g. The derived intra mode may be used for the MTS transform index derivation.
      h. The derived intra mode may be used for the LFNST transform set index derivation.
      i. The derived intra mode may be used for the LFNST transpose flag derivation.
   b. An intra mode derived from neighboring samples' information may be used for luma transform process.
      a. For example, the luma transform process may refer to primary transform (e.g., intra MTS, inter MTS, KLT, DCT2, . . . ) on luma components.
      b. For example, the luma transform process may refer to secondary transform (e.g., LFNST) on luma components.
      c. For example, a template constructed from above and/or left neighboring samples may be used to derive an intra mode.
         i. The gradient of template samples may be used.
         ii. The largest histogram amplitude values built from the gradients (e.g., histogram of gradients).
         iii. A DIMD based method may be used.
         iv. A TIMD based method may be used.
         v. An intra mode may be determined from template samples (e.g., according to SAD/SATD cost based measurements), based on a pre-set of intra mode candidates.
         vi. How many rows/columns and/or which neighboring samples are used may be based on multiple reference line index.
         vii. How many rows/columns and/or which neighboring samples are used may be pre-defined (e.g., one row/column, or, four row/column, etc.).
         viii. Different rows/columns of neighboring samples may have different weights for cost calculation.
      d. The derived intra mode may be generated for a video unit coded with a mode below:
         i. Intra template matching and/or its variant.
         ii. MIP mode and/or its variant.
         iii. ISP mode and/or its variant.
         iv. A prediction blended from at least one intra mode and another mode.
         v. TIMD blended mode and/or its variant.
         vi. DIMD blended mode and/or its variant.
         vii. GPM intra mode and/or its variant.
         viii. Split GPM mode and/or its variant.
         ix. CIIP mode and/or its variant.
         x. MHP with intra mode blending.
         xi. Screen content coding tools with intra mode blending.
         xii. Planar mode.
         xiii. Planar horizontal mode.
         xiv. Planar vertical mode.
      e. The derived intra mode may be used for the MTS transform class index derivation.
      f. The derived intra mode may be used for the MTS transform pair index derivation.
      g. The derived intra mode may be used for the MTS transform index derivation.
      h. The derived intra mode may be used for the LFNST transform set index derivation.
      i. The derived intra mode may be used for the LFNST transpose flag derivation.
   c. An intra mode derived from current block's prediction samples may be used for transform process.
      a. The prediction samples may refer to the prediction of current video unit.
      b. The prediction samples may refer to the prediction of template samples of the current video unit.
      c. The transform process may refer to primary transform (e.g., intra MTS, inter MTS, KLT, DCT2, . . . ).
      d. The transform process may refer to secondary transform (e.g., LFNST).
      e. The derived intra mode may be generated for a video unit coded with a mode below:
         i. Intra template matching and/or its variant.
         ii. MIP mode and/or its variant.
         iii. ISP mode and/or its variant.
         iv. A prediction blended from at least one intra mode and another mode.
         v. TIMD blended mode and/or its variant.
         vi. DIMD blended mode and/or its variant.
         vii. GPM intra mode and/or its variant.
         viii. Split GPM mode and/or its variant.
         ix. CIIP mode and/or its variant.
         x. MHP with intra mode blending.
         xi. Screen content coding tools with intra mode blending.
         xii. Planar mode.
         xiii. Planar horizontal mode.
         xiv. Planar vertical mode.
         xv. CCLM mode and/or its variant.
         xvi. CCCM mode and/or its variant.
         xvii. GLM mode and/or its variant.
         xviii. A chroma intra mode with mode index greater than a certain number which denotes an angular intra mode (such as the number is equal to 80).
      f. The derived intra mode may be used for the MTS transform class index derivation.
      g. The derived intra mode may be used for the MTS transform pair index derivation.
      h. The derived intra mode may be used for the MTS transform index derivation.
      i. The derived intra mode may be used for the LFNST transform set index derivation.
      j. The derived intra mode may be used for the LFNST transpose flag derivation.
   d. For example, a derived intra mode may be used to index the intra MTS transform class and/or transform pair and/or transform set for MIP coded blocks.
      a. The derived intra mode may be based on the prediction samples of the MIP block before MIP prediction upsampling.
      b. The derived intra mode may be based on the prediction samples of the MIP block after MIP matrix vector multiplication.
      c. The derived intra mode may be based on the horizontal/vertical gradient of prediction samples of the MIP block.
      d. The derived intra mode may be based on the largest histogram amplitude values built from the gradients (e.g., histogram of gradients) of the MIP block.
      e. The derived intra mode may be based on the neighboring samples values of the MIP block.
      f. Alternatively, the derived intra mode may be a fixed/pre-defined mode (e.g., in addition to Planar mode) regardless the current prediction samples and neighboring samples of the current block.
   e. For example, a derived intra mode may be used to index the LFNST transform set and/or LFNST transpose flag for intra template matching (e.g., intraTMP, intraTM, etc.) coded blocks.
      a. The derived intra mode may be based on the prediction samples of the intraTMP coded block.
      b. The derived intra mode may be based on the horizontal/vertical gradient of prediction samples of the intraTMP coded block.
      c. The derived intra mode may be based on the largest histogram amplitude values built from the gradients (e.g., histogram of gradients) of the intraTMP coded block.
      d. The derived intra mode may be based on the neighboring samples values of the intraTMP coded block.
      e. The derived intra mode may be based on the intra mode of the reference block of the intraTMP coded block.
      f. The derived intra mode may be based on the gradients of the reference block of the intraTMP coded block.
      g. The derived intra mode may be based on the angular of the block vector (or motion vector) of the intraTMP coded block.
      h. The derived intra mode may be based on the intra mode information stored in the history based intra mode buffer for the intraTMP coded block.
      i. Alternatively, the derived intra mode may be a fixed/pre-defined mode (e.g., in addition to Planar mode) regardless the current prediction samples and neighboring samples of the current block.
   f. For example, an MTS index may be signalled for intra template matching (e.g., intraTMP, intraTM, etc.) coded blocks.
      a. For example, an intra MTS index may be signalled for the intraTMP coded block.
      b. For example, an inter MTS index may be signalled for the intraTMP coded block.
      c. A derived intra mode may be used to index the MTS transform set, MTS transform class, MTS transform pair for intraTMP coded block.
         i. The derived intra mode may be based on the prediction samples of the intraTMP coded block.
         ii. The derived intra mode may be based on the horizontal/vertical gradient of prediction samples of the intraTMP coded block.
         iii. The derived intra mode may be based on the largest histogram amplitude values built from the gradients (e.g., histogram of gradients) of the intraTMP coded block.
         iv. The derived intra mode may be based on the neighboring samples values of the intraTMP coded block.
         v. The derived intra mode may be based on the intra mode of the reference block of the intraTMP coded block.
         vi. The derived intra mode may be based on the gradients of the reference block of the intraTMP coded block.
         vii. The derived intra mode may be based on the angular of the block vector (or motion vector) of the intraTMP coded block.
         viii. The derived intra mode may be based on the intra mode information stored in the history based intra mode buffer for the intraTMP coded block.
         ix. Alternatively, the derived intra mode may be a fixed/pre-defined mode (e.g., in addition to Planar mode) regardless the current prediction samples and neighboring samples of the current block.
      d. Alternatively, an implicit MTS kernel may be applied for intraTMP coded blocks.
         i. For example, it may be determined based on the derived intra modes.
         ii. For example, it may be determined based on the block shape/size/dimension (e.g., width/height).
         iii. For example, it may be determined based on the value of transform coefficients.
         iv. For example, no syntax element (e.g., index) is signalled for such MTS kernel.
      e. Furthermore, KLT may be used for intraTMP coded blocks.
      f. Alternatively, primary transform kernels in addition to DCT2 may be restricted for intraTMP coded blocks.
   g. For example, the intra MTS transform class and/or the intra MTS transform pair and/or the LFNST transform set and/or the LFNST transpose flag of a TIMD blend mode may be derived based on the final prediction samples of the TIMD block.
      a. Alternatively, it may be derived based on the neighboring samples information (such as gradients, TIMD information, DIMD information, and etc.).
      b. Alternatively, it may be based on a fixed/pre-defined mode (e.g., in addition to Planar mode) regardless the current prediction samples and neighboring samples of the current block.
   h. For example, the intra MTS transform class and/or the intra MTS transform pair and/or the LFNST transform set and/or the LFNST transpose flag of a DIMD blend mode may be derived based on the final prediction samples of the DIMD block.
      a. Alternatively, it may be derived based on the neighboring samples information (such as gradients, and etc.).
      b. Alternatively, it may be based on a fixed/pre-defined mode (e.g., in addition to Planar mode) regardless the current prediction samples and neighboring samples of the current block.
   i. For example, the intra MTS transform class and/or the intra MTS transform pair and/or the LFNST transform set and/or the LFNST transpose flag of a Planar (and/or planar horizontal, and/or planar vertical) mode may be derived based on the final prediction samples of the block.
      a. Alternatively, it may be derived based on the neighboring samples information (such as gradients, TIMD information, DIMD information, and etc.).
      b. Alternatively, it may be based on a fixed/pre-defined mode (e.g., in addition to Planar mode) regardless the current prediction samples and neighboring samples of the current block.
4.6. In one example, how to code the residual block may depend on the selected transform.
4.7. In one example, KLT may be separable or non-separable.
4.8. In one example, whether or how to apply KLT may be dependent on the sum of absolute value of transform coefficients.
   a. For example, whether to allow KLT to an intra (and/or inter) coded block may be based on the sum of absolute value of transform coefficients of the block.
   b. For example, whether to allow KLT to a certain block size/dimension/shape/direction may be based on the sum of absolute value of transform coefficients of the block.
   c. For example, whether to apply a specific KLT based transform kernel/set/pair to an intra (and/or inter) coded block may be based on the sum of absolute value of transform coefficients of the block.
   d. For example, the number of allowed KLT transform kernel/set/pairs may be determined based on the sum of absolute value of transform coefficients of the block.
   e. For example, the sum of absolute value of transform coefficients of the block may be compared with at least one threshold.
      a. The threshold may be pre-defined.
      b. The threshold may be equal to a fixed value.
      c. The threshold may be adaptive determined based on a pre-defined rule (e.g., block size/dimensions, sequence resolution, prediction mode, whether it is screen content, etc.).

### General Aspects

4.9. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
4.10. Whether to and/or how to apply the disclosed methods above may be signalled at PB/TB/CB/PU/TU/CU/VPDU/CTU/CTU row/slice/tile/sub-picture/other kinds of region contain more than one sample or pixel.
4.11. The coded bin of the syntax elements signalled in the disclosed methods may be context coded, or by-pass coded.
4.12. Whether to and/or how to apply the disclosed methods above may be dependent on coded information, such as block size, colour format, single/dual tree partitioning, colour component, slice/picture type.

More details of the embodiments of the present disclosure will be described below which are related to transform, screen content coding (SCC) and affine in image/video coding. The embodiments of the present disclosure should be considered as examples to explain the general concepts and should not be interpreted in a narrow way. Furthermore, these embodiments can be applied individually or combined in any manner.

As used herein, the term “block” may represent a color component, a sub-picture, a picture, a slice, a tile, a coding tree unit (CTU), a CTU row, groups of CTU, a coding unit (CU), a prediction unit (PU), a transform unit (TU), a coding tree block (CTB), a coding block (CB), a prediction block (PB), a transform block (TB), a sub-block of a video block, a sub-region within a video block, a video processing unit comprising multiple samples/pixels, and/or the like. A block may be rectangular or non-rectangular.

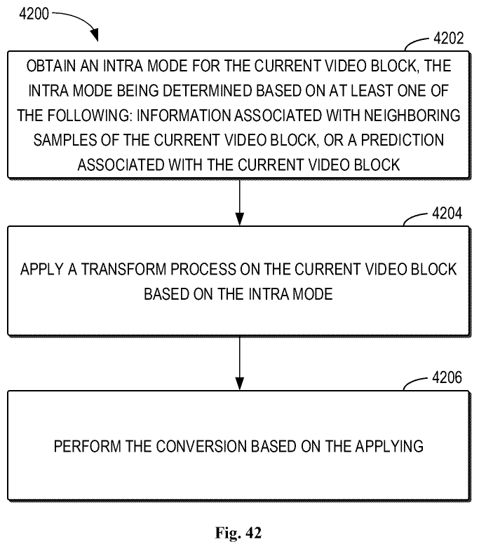

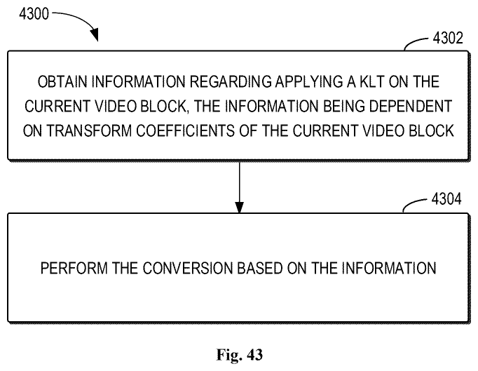

FIG. 42 illustrates a flowchart of a method 4200 for video processing in accordance with some embodiments of the present disclosure. The method 4200 may be implemented during a conversion between a current video block of a video and a bitstream of the video. As shown in FIG. 42, the method 4200 starts at 4202 where an intra mode for the current video block is obtained. The intra mode is determined based on information associated with neighboring samples of the current video block, and/or a prediction associated with the current video block.

In some embodiments, the information associated with neighboring samples of the current video block may comprise reconstructed values of the neighboring samples, a prediction mode of the neighboring samples, a transform type of the neighboring samples, and/or any other suitable coded or reconstructed information of the neighboring samples.

In some additional or alternative embodiments, the prediction associated with the current video block may comprise a prediction of the current video block or a prediction of template samples of the current video block. It should be understood that the above examples are described merely for purpose of description. The scope of the present disclosure is not limited in this respect.

At 4204, a transform process is applied on the current video block based on the intra mode. By way of example, a transform set or a transform kernel used in the transform process may be selected from a pre-defined look up table based on an index of the intra mode. It should be understood that the above illustrations are described merely for purpose of description. The scope of the present disclosure is not limited in this respect.

At 4206, the conversion is performed based on the applying. In some embodiments, the conversion may include encoding the current video block into the bitstream. Alternatively or additionally, the conversion may include decoding the current video block from the bitstream.

In view of the above, an intra mode used for a transform process is determined by considering information associated with neighboring samples of a video block and/or a prediction associated with the video block. Compared with the conventional solution, the proposed method can advantageously improve the coding efficiency.

In some embodiments, the intra mode may be determined based on the prediction associated with the current video block. In such a case, the transform process may comprise a primary transform (e.g., intra MTS, inter MTS, KLT, DCT2, or the like) and/or a secondary transform (e.g., LFNST or the like). Moreover, the current video block may be coded with at least one of the following modes: an intra template matching mode, a matrix weighted intra prediction (MIP) mode, an intra sub-partitions (ISP) mode, a mode where a prediction may be blended from at least one intra mode and another mode, a template-based intra mode derivation (TIMD) blended mode, a decoder-side intra mode derivation (DIMD) blended mode, a geometric partitioning mode (GPM) intra mode, a split GPM mode, a combined inter and intra prediction (CIIP) mode, a multi-hypothesis prediction (MHP) with intra mode blending, a screen content coding tool with intra mode blending, a planar mode, a planar horizontal mode, a planar vertical mode, a cross-component linear model (CCLM) mode, a convolutional cross-component model (CCCM) mode, a gradient-based linear model (GLM) mode, a chroma intra mode with a mode index greater than a predetermined number which denotes an angular intra mode. By way of example rather than limitation, the predetermined number may be 80. It should be understood that the above examples are described merely for purpose of description. The scope of the present disclosure is not limited in this respect.

Additionally or alternatively, the intra mode may be determined based on the information associated with neighboring samples of the current video block. In such a case, the transform process may comprise a luma transform process and/or a chroma transform process. For example, the luma transform process may comprise a primary transform on luma components and/or a secondary transform on luma components. The chroma transform process may comprise a primary transform on chroma components in a single-tree case, a primary transform on chroma components in a dual-tree case, a secondary transform on chroma components in a single-tree case, and/or a secondary transform on chroma components in a dual-tree case.

In some embodiments, the neighboring samples may comprise a template including above neighboring samples and/or left neighboring samples of the current video block. For example, the information associated with the neighboring samples of the current video block may comprise a gradient of samples in the template, and/or the largest histogram amplitude value determined based on gradients of samples in the template. Additionally or alternatively, the intra mode may be determined from a set of intra mode candidates based on the template.

In some embodiments, a DIMD-based scheme or a TIMD-based scheme may be used to determine the intra mode. In some further embodiments, information regarding at least one of the following may be dependent on a multiple reference line index or pre-defined: the number of rows of neighboring samples used for determining the intra mode, the number of columns of neighboring samples used for determining the intra mode, or neighboring samples used for determining the intra mode.

In some embodiments, different rows of neighboring samples may be associated with different weights for cost calculation, and/or different columns of neighboring samples may be associated with different weights for cost calculation.

In some embodiments, the intra mode may be determined based on the information associated with neighboring samples of the current video block. In such a case, the current video block may be coded with at least one of the following modes: an intra template matching mode, an MIP mode, an ISP mode, a mode where a prediction may be blended from at least one intra mode and another mode, a TIMD blended mode, a DIMD blended mode, a GPM intra mode, a split GPM mode, a CIIP mode, an MHP with intra mode blending, a screen content coding tool with intra mode blending, a planar mode, a planar horizontal mode, or a planar vertical mode. It should be understood that the above examples are described merely for purpose of description. The scope of the present disclosure is not limited in this respect.

In some embodiments, the intra mode may be used for determining a multiple transform selection (MTS) transform class index, an MTS transform pair index, an MTS transform index, a low-frequency non-separable transform (LFNST) transform set index, and/or an LFNST transpose flag.

In some embodiments, the current video block may be coded with an MIP mode, and at least one of the following may be selected for the current video block based on the intra mode: an intra MTS transform class, a transform pair, or a transform set.

In some embodiments, the prediction associated with the current video block used for determining the intra mode may comprise prediction samples of the current video block before an MIP prediction upsampling, and/or prediction samples of the current video block after MIP matrix vector multiplication.

In some embodiments, the current video block may be coded with an MIP mode. In such a case, the intra mode may be determined based on at least one of the following: a horizontal gradient or a vertical gradient of samples of a prediction for the current video block, the largest histogram amplitude value determined based on gradients of the current video block, or neighboring samples values of the current video block.

In some embodiments, the current video block may be coded with an intra template matching mode. In one example, the intra template matching mode may be a template matching based prediction mode for intra coding blocks (intraTMP). In another example, the intra template matching mode may be intraTM. It should be understood that the above examples are described merely for purpose of description. The scope of the present disclosure is not limited in this respect.

In such a case, at least one of the following may be selected for the current video block based on the intra mode: an LFNST transform set, an LFNST transpose flag, an MTS transform set, an MTS transform class, or an MTS transform pair. In addition, the intra mode may be determined based on at least one of the following: prediction samples of the current video block, a horizontal gradient of prediction samples of the current video block, a vertical gradient of prediction samples of the current video block, the largest histogram amplitude value determined based on gradients of the current video block, neighboring samples values of the current video block, an intra mode of a reference video block for the current video block, gradients of the reference video block, an angular of a block vector for the current video block, an angular of a motion vector for the current video block, or intra mode information stored in a history-based intra mode buffer for the current video block.

In some embodiments, an intra mode for a further video block of the video different from the current video block may be pre-defined and/or fixed. For example the intra mode may be independent from prediction samples and neighboring samples of the further video block.

In some embodiments, the current video block may be coded with an intra template matching, and an MTS index for the current video block may be indicated in the bitstream. By way of example, the MTS index may comprise an intra MTS index. Additionally or alternatively, the MTS index may comprise an inter MTS index. Furthermore, an MTS kernel may be applied on the current video block. For example, the MTS kernel may be determined based on the intra mode, a shape of the current video block, a size of the current video block, a dimension of the current video block, a width of the current video block, a height of the current video block, values of transform coefficients of the current video block, and/or the like. In some embodiments, no syntax element (such as, index, flag or the like) may be signaled for the MTS kernel.

In some embodiments, the current video block may be coded with an intra template matching mode. In such a case, a Karhunen-Loeve transform (KLT) may be applied on the current video block. As used herein, the term “KLT” may refer to a type of transform. For example, it may refer to Karhunen-Loeve Transform. For example, it may comprise any suitable transform type which is not DCT or DST or Hadmard. Moreover, primary transform kernels in addition to discrete cosine transform type 2 (DCT2) may be disabled or restricted for the current video block.

In some embodiments, the current video block may be coded with a TIMD blended mode. In such a case, at least one of the following may be determined based on final prediction samples of the current video block: an intra MTS transform class of the TIMD blended mode, an intra MTS transform pair of the TIMD blended mode, an LFNST transform set of the TIMD blended mode, or an LFNST transpose flag of the TIMD blended mode.

In some alternative embodiments, the current video block may be coded with a DIMD blended mode. In such a case, at least one of the following may be determined based on final prediction samples of the current video block: an intra MTS transform class of the DIMD blended mode, an intra MTS transform pair of the DIMD blended mode, an LFNST transform set of the DIMD blended mode, or an LFNST transpose flag of the DIMD blended mode.

In some further embodiments, at least one of the following may be determined based on final prediction samples of the current video block: an intra MTS transform class of a planar mode, an intra MTS transform pair of a planar mode, an LFNST transform set of a planar mode, or an LFNST transpose flag of a planar mode.

In some embodiments, at least one of the following may be determined based on further information associated with neighboring samples of the current video block: an intra MTS transform class, an intra MTS transform pair, an LFNST transform set, or an LFNST transpose flag. By way of example rather than limitation, the further information may comprise gradients of the neighboring samples, TIMD information of the neighboring samples, DIMD information of the neighboring samples, and/or the like.

In some further embodiments, at least one of the following may be determined based on a pre-defined mode: an intra MTS transform class, an intra MTS transform pair, an LFNST transform set, or an LFNST transpose flag.

In some embodiments, a coded bin of a syntax element related to the proposed method may be context coded. Alternatively, a coded bin of a syntax element related to the proposed method may be bypass coded. It should be understood that the above illustrations and/or examples are described merely for purpose of description. The scope of the present disclosure is not limited in this respect.

According to further embodiments of the present disclosure, a non-transitory computer-readable recording medium is provided. The non-transitory computer-readable recording medium stores a bitstream of a video which is generated by a method performed by an apparatus for video processing. In the method, an intra mode for a current video block of the video is obtained. The intra mode is determined based on at least one of the following: information associated with neighboring samples of the current video block, or a prediction associated with the current video block. A transform process is applied on the current video block based on the intra mode. Moreover, the bitstream is generated based on the applying.

According to still further embodiments of the present disclosure, a method for storing bitstream of a video is provided. In the method, an intra mode for a current video block of the video is obtained. The intra mode is determined based on at least one of the following: information associated with neighboring samples of the current video block, or a prediction associated with the current video block. A transform process is applied on the current video block based on the intra mode. Moreover, the bitstream is generated based on the applying, and stored in a non-transitory computer-readable recording medium.

FIG. 43 illustrates a flowchart of a method 4300 for video processing in accordance with some embodiments of the present disclosure. The method 4300 may be implemented during a conversion between a current video block of a video and a bitstream of the video. As shown in FIG. 43, the method 4300 starts at 4302 where information regarding applying a Karhunen-Loeve transform (KLT) on the current video block is obtained. The information is dependent on transform coefficients of the current video block.

In some embodiments, the information may comprise whether to apply the KLT on the current video block, how to apply the KLT on the current video block, and/or the like. This will be described in detail below. By way of example rather than limitation, the information may be dependent on a sum of absolute value of the transform coefficients, the number of non-zero-coefficients in the transform coefficients, the largest non-zero-coefficient in the transform coefficients, a position of the last non-zero-coefficient in the transform coefficients, and/or the like.

At 4304, the conversion is performed based on the information. In some embodiments, the conversion may include encoding the current video block into the bitstream. Alternatively or additionally, the conversion may include decoding the current video block from the bitstream.

In view of the above, information regarding applying a KLT on a video block is dependent on transform coefficients of the video block. Compared with the conventional solution, the proposed method can advantageously improve the coding efficiency.

In some embodiments, the current video block may be intra coded or inter coded. In such a case, the information may comprise at least one of the following: whether to allow the KLT to be applied on the current video block, whether to apply a specific KLT based transform kernel on the current video block, whether to apply a specific KLT based transform set on the current video block, or whether to apply a specific KLT based transform pair on the current video block.

Additionally or alternatively, the information may comprise whether to allow KLT to a specific block size, whether to allow KLT to a specific block dimension, whether to allow KLT to a specific block shape, whether to allow KLT to a specific direction, the number of allowed KLT transform kernels, the number of allowed KLT transform sets, and/or the number of allowed KLT transform pairs.

In some embodiments, the sum of absolute value of the transform coefficients may be compared with at least one threshold. In one example, the at least one threshold may be pre-defined. In another example, the at least one threshold may be equal to a fixed value. In a further example, the at least one threshold may be determined based on a pre-defined rule. By way of example rather than limitation, the at least one threshold may be determined based on a size of the current video block, a dimension of the current video block, a sequence resolution of the current video block, a prediction mode of the current video block, information regarding whether the current video is screen content, and/or the like.

In some embodiments, a KLT-based transform type used for the current video block may be implicitly determined. For example, the KLT-based transform type may be determined based on a size of the current video block, a dimension of the current video block, a shape of the current video block, and/or the like. Alternatively, for a certain length of block dimension (e.g., width or height), a specific KLT-based transform type may be used in such direction without signaling. In one example, if a width of the current video block is equal to a first value, a KLT-based transform type may be used in a direction along the width of the current video block without being indicated in the bitstream. In a further example, if a height of the current video block is equal to a second value, a KLT-based transform type may be used in a direction along the height of the current video block without being indicated in the bitstream.

In some embodiments, a separable transform, a primary transform, and/or a secondary transform may be replaced by the KLT. For example, the KLT may be a non-separable KLT or a separable KLT. Additionally, the KLT may be applied to the current video block, and the current video block may be intra coded or inter coded. In some embodiments, the KLT may be applied to the current video block as a primary transform or a secondary transform.

In some embodiments, a first syntax element indicating whether the KLT is applied on the current video block may be comprised in the bitstream. If the KLT is applied on the current video block, the bitstream may comprise a second syntax element indicating at least one of the following: whether a KLT is used for a horizontal transform, whether a KLT is used for a vertical transform, the KLT used for the horizontal transform, or the KLT used for the vertical transform.

In some alternative or additional embodiments, a third syntax element indicating the KLT used for the current video block may be comprised in the bitstream. Alternatively, only if the KLT is applied on the current video block, a third syntax element indicating the KLT may be comprised in the bitstream.

In some embodiments, the third syntax element may indicate one of the following: a KLT pair used for a horizontal transform and a vertical transform for the current video block, a KLT used for the horizontal transform for the current video block, or a KLT used for the vertical transform for the current video block.

In some embodiments, the third syntax element may be signaled for both non-KLT transform and KLT transform. By way of example rather than limitation, the third syntax element may be an index. In this case, index 0 to 1 may indicate a DCT2-DCT2 pair and a transform skip. Moreover, index 2 to N may indicate a non-DCT2-DCT2 pairs and a non-transform skip pairs including combinations of non-KLT and KLT, and N may be an integer.

In some embodiments, an intra MTS index for the current video block and/or an inter MTS index for the current video block may be absent from the bitstream. For example, the intra MTS index and/or the inter MTS index may be not signaled, and disabled for the current video block.

In some embodiments, a coded bin of a syntax element related to the proposed method may be context coded. Alternatively, a coded bin of a syntax element related to the proposed method may be bypass coded. It should be understood that the above illustrations and/or examples are described merely for purpose of description. The scope of the present disclosure is not limited in this respect.

According to further embodiments of the present disclosure, a non-transitory computer-readable recording medium is provided. The non-transitory computer-readable recording medium stores a bitstream of a video which is generated by a method performed by an apparatus for video processing. In the method, information regarding applying a Karhunen-Loeve transform (KLT) on a current video block of the video is obtained. The information is dependent on transform coefficients of the current video block. Moreover, the bitstream is generated based on the information.

According to still further embodiments of the present disclosure, a method for storing bitstream of a video is provided. In the method, information regarding applying a Karhunen-Loeve transform (KLT) on a current video block of the video is obtained. The information is dependent on transform coefficients of the current video block. Moreover, the bitstream is generated based on the information, and stored in a non-transitory computer-readable recording medium.

Implementations of the present disclosure can be described in view of the following clauses, the features of which can be combined in any reasonable manner.

Clause 1. A method for video processing, comprising: obtaining, for a conversion between a current video block of a video and a bitstream of the video, an intra mode for the current video block, the intra mode being determined based on at least one of the following: information associated with neighboring samples of the current video block, or a prediction associated with the current video block; applying a transform process on the current video block based on the intra mode; and performing the conversion based on the applying.

Clause 2. The method of clause 1, wherein the prediction associated with the current video block comprises a prediction of the current video block or a prediction of template samples of the current video block.

Clause 3. The method of any of clauses 1-2, wherein the intra mode is determined based on the prediction associated with the current video block, and the transform process comprises at least one of a primary transform or a secondary transform.

Clause 4. The method of any of clauses 1-3, wherein the intra mode is determined based on the prediction associated with the current video block, and the current video block is coded with at least one of the following: an intra template matching mode, a matrix weighted intra prediction (MIP) mode, an intra sub-partitions (ISP) mode, a mode where a prediction is blended from at least one intra mode and another mode, a template-based intra mode derivation (TIMD) blended mode, a decoder-side intra mode derivation (DIMD) blended mode, a geometric partitioning mode (GPM) intra mode, a split GPM mode, a combined inter and intra prediction (CIIP) mode, a multi-hypothesis prediction (MHP) with intra mode blending, a screen content coding tool with intra mode blending, a planar mode, a planar horizontal mode, a planar vertical mode, a cross-component linear model (CCLM) mode, a convolutional cross-component model (CCCM) mode, a gradient-based linear model (GLM) mode, or a chroma intra mode with a mode index greater than a predetermined number which denotes an angular intra mode.

Clause 5. The method of clause 4, wherein the predetermined number is 80.

Clause 6. The method of any of clauses 1-2, wherein the intra mode is determined based on the information associated with neighboring samples of the current video block, and the transform process comprises at least one of a luma transform process or a chroma transform process.

Clause 7. The method of clause 6, wherein the luma transform process comprises at least one of a primary transform on luma components or a secondary transform on luma components, or wherein the chroma transform process comprises at least one of the following: a primary transform on chroma components in a single-tree case, a primary transform on chroma components in a dual-tree case, a secondary transform on chroma components in a single-tree case, or a secondary transform on chroma components in a dual-tree case.

Clause 8. The method of any of clauses 1-2 and 6-7, wherein the neighboring samples comprises a template including above neighboring samples and/or left neighboring samples of the current video block.

Clause 9. The method of clause 8, wherein the information associated with the neighboring samples of the current video block comprises at least one of the following: a gradient of samples in the template, or the largest histogram amplitude value determined based on gradients of samples in the template.

Clause 10. The method of clause 8, wherein the intra mode is determined from a set of intra mode candidates based on the template.

Clause 11. The method of any of clauses 1-2 and 6-10, wherein a DIMD-based scheme or a TIMD-based scheme is used to determine the intra mode.

Clause 12. The method of any of clauses 1-2 and 6-11, wherein information regarding at least one of the following is dependent on a multiple reference line index or pre-defined: the number of rows of neighboring samples used for determining the intra mode, the number of columns of neighboring samples used for determining the intra mode, or neighboring samples used for determining the intra mode.

Clause 13. The method of any of clauses 1-2 and 6-12, wherein different rows of neighboring samples are associated with different weights for cost calculation, or different columns of neighboring samples are associated with different weights for cost calculation.

Clause 14. The method of any of clauses 1-2 and 6-13, wherein the intra mode is determined based on the information associated with neighboring samples of the current video block, and the current video block is coded with at least one of the following: an intra template matching mode, an MIP mode, an ISP mode, a mode where a prediction is blended from at least one intra mode and another mode, a TIMD blended mode, a DIMD blended mode, a GPM intra mode, a split GPM mode, a CIIP mode, an MHP with intra mode blending, a screen content coding tool with intra mode blending, a planar mode, a planar horizontal mode, or a planar vertical mode.

Clause 15. The method of any of clauses 1-14, wherein the intra mode is used for determining at least one of the following: a multiple transform selection (MTS) transform class index, an MTS transform pair index, an MTS transform index, a low-frequency non-separable transform (LFNST) transform set index, or an LFNST transpose flag.

Clause 16. The method of any of clauses 1-15, wherein the current video block is coded with an MIP mode, and at least one of the following is selected for the current video block based on the intra mode: an intra MTS transform class, a transform pair, or a transform set.

Clause 17. The method of clause 16, wherein the prediction associated with the current video block comprises at least one of the following: prediction samples of the current video block before an MIP prediction upsampling, or prediction samples of the current video block after MIP matrix vector multiplication.

Clause 18. The method of any of clauses 1-17, wherein the current video block is coded with an MIP mode, and the intra mode is determined based on at least one of the following: a horizontal gradient or a vertical gradient of samples of a prediction for the current video block, the largest histogram amplitude value determined based on gradients of the current video block, or neighboring samples values of the current video block.

Clause 19. The method of any of clauses 1-15, wherein the current video block is coded with an intra template matching mode, and at least one of the following is selected for the current video block based on the intra mode: an LFNST transform set, an LFNST transpose flag, an MTS transform set, an MTS transform class, or an MTS transform pair.

Clause 20. The method of clause 19, wherein the intra mode is determined based on at least one of the following: prediction samples of the current video block, a horizontal gradient of prediction samples of the current video block, a vertical gradient of prediction samples of the current video block, the largest histogram amplitude value determined based on gradients of the current video block, neighboring samples values of the current video block, an intra mode of a reference video block for the current video block, gradients of the reference video block, an angular of a block vector for the current video block, an angular of a motion vector for the current video block, or intra mode information stored in a history-based intra mode buffer for the current video block.

Clause 21. The method of any of clauses 1-20, wherein an intra mode for a further video block of the video different from the current video block is pre-defined.

Clause 22. The method of any of clauses 1-21, wherein the current video block is coded with an intra template matching, and an MTS index for the current video block is indicated in the bitstream.

Clause 23. The method of clause 22, wherein the MTS index comprises an intra MTS index or an inter MTS index.

Clause 24. The method of any of clauses 1-21, wherein the current video block is coded with an intra template matching mode, and an MTS kernel is applied on the current video block.

Clause 25. The method of clause 24, wherein the MTS kernel is determined based on at least one of the following: the intra mode, a shape of the current video block, a size of the current video block, a dimension of the current video block, a width of the current video block, a height of the current video block, or values of transform coefficients of the current video block.

Clause 26. The method of any of clauses 24-25, wherein no syntax element is signaled for the MTS kernel.

Clause 27. The method of any of clauses 1-26, wherein the current video block is coded with an intra template matching mode, and a Karhunen-Loeve transform (KLT) is applied on the current video block.

Clause 28. The method of any of clauses 1-26, wherein the current video block is coded with an intra template matching mode, and primary transform kernels in addition to discrete cosine transform type 2 (DCT2) is disabled for the current video block.

Clause 29. The method of any of clauses 19-28, wherein the intra template matching mode comprises a template matching based prediction mode for intra coding blocks (intraTMP).

Clause 30. The method of any of clauses 1-29, wherein the current video block is coded with a TIMD blended mode, and at least one of the following is determined based on final prediction samples of the current video block: an intra MTS transform class of the TIMD blended mode, an intra MTS transform pair of the TIMD blended mode, an LFNST transform set of the TIMD blended mode, or an LFNST transpose flag of the TIMD blended mode.

Clause 31. The method of any of clauses 1-29, wherein the current video block is coded with a DIMD blended mode, and at least one of the following is determined based on final prediction samples of the current video block: an intra MTS transform class of the DIMD blended mode, an intra MTS transform pair of the DIMD blended mode, an LFNST transform set of the DIMD blended mode, or an LFNST transpose flag of the DIMD blended mode.

Clause 32. The method of any of clauses 1-29, wherein at least one of the following is determined based on final prediction samples of the current video block: an intra MTS transform class of a planar mode, an intra MTS transform pair of a planar mode, an LFNST transform set of a planar mode, or an LFNST transpose flag of a planar mode.

Clause 33. The method of any of clauses 1-29, wherein at least one of the following is determined based on further information associated with neighboring samples of the current video block: an intra MTS transform class, an intra MTS transform pair, an LFNST transform set, or an LFNST transpose flag.

Clause 34. The method of clause 33, wherein the further information comprises at least one of the following: gradients of the neighboring samples, TIMD information of the neighboring samples, or DIMD information of the neighboring samples.

Clause 35. The method of any of clauses 1-29, wherein at least one of the following is determined based on a pre-defined mode: an intra MTS transform class, an intra MTS transform pair, an LFNST transform set, or an LFNST transpose flag.

Clause 36. A method for video processing, comprising: obtaining, for a conversion between a current video block of a video and a bitstream of the video, information regarding applying a Karhunen-Loeve transform (KLT) on the current video block, the information being dependent on transform coefficients of the current video block; and performing the conversion based on the information.

Clause 37. The method of clause 36, wherein the information is dependent on a sum of absolute value of the transform coefficients.

Clause 38. The method of any of clauses 36-37, wherein the information comprises at least one of the following: whether to apply the KLT on the current video block, or how to apply the KLT on the current video block.

Clause 39. The method of any of clauses 36-38, wherein the current video block is intra coded or inter coded, and the information comprises at least one of the following: whether to allow the KLT to be applied on the current video block, whether to apply a specific KLT based transform kernel on the current video block, whether to apply a specific KLT based transform set on the current video block, or whether to apply a specific KLT based transform pair on the current video block.

Clause 40. The method of any of clauses 36-39, wherein the information comprises at least one of the following: whether to allow KLT to a specific block size, whether to allow KLT to a specific block dimension, whether to allow KLT to a specific block shape, whether to allow KLT to a specific direction, the number of allowed KLT transform kernels, the number of allowed KLT transform sets, or the number of allowed KLT transform pairs.

Clause 41. The method of any of clauses 37-40, wherein the sum of absolute value of the transform coefficients is compared with at least one threshold.

Clause 42. The method of clause 41, wherein the at least one threshold is pre-defined or equal to a fixed value.

Clause 43. The method of clause 41, wherein the at least one threshold is determined based on a pre-defined rule.

Clause 44. The method of clause 41, wherein the at least one threshold is determined based on at least one of the following: a size of the current video block, a dimension of the current video block, a sequence resolution of the current video block, a prediction mode of the current video block, or information regarding whether the current video is screen content.

Clause 45. The method of any of clauses 36-44, wherein a KLT-based transform type used for the current video block is implicitly determined.

Clause 46. The method of clause 45, wherein the KLT-based transform type is determined based on at least one of the following: a size of the current video block, a dimension of the current video block, or a shape of the current video block.

Clause 47. The method of clause 45, wherein if a width of the current video block is equal to a first value, a KLT-based transform type is used in a direction along the width of the current video block without being indicated in the bitstream, or if a height of the current video block is equal to a second value, a KLT-based transform type is used in a direction along the height of the current video block without being indicated in the bitstream.

Clause 48. The method of any of clauses 36-47, wherein at least one of the following is replaced by the KLT: a separable transform, a primary transform, or a secondary transform.

Clause 49. The method of any of clauses 36-48, wherein the KLT is a non-separable KLT or a separable KLT.

Clause 50. The method of any of clauses 36-49, wherein the KLT is applied to the current video block, and the current video block is intra coded or inter coded.

Clause 51. The method of any of clauses 36-49, wherein the KLT is applied to the current video block as a primary transform or a secondary transform.

Clause 52. The method of any of clauses 36-51, wherein a first syntax element indicating whether the KLT is applied on the current video block is comprised in the bitstream.

Clause 53. The method of any of clauses 36-52, wherein if the KLT is applied on the current video block, the bitstream comprises a second syntax element indicating at least one of the following: whether a KLT is used for a horizontal transform, whether a KLT is used for a vertical transform, the KLT used for the horizontal transform, or the KLT used for the vertical transform.

Clause 54. The method of any of clauses 36-53, wherein a third syntax element indicating the KLT used for the current video block is comprised in the bitstream.

Clause 55. The method of any of clauses 36-53, wherein if the KLT is applied on the current video block, a third syntax element indicating the KLT is comprised in the bitstream.

Clause 56. The method of any of clauses 54-55, wherein the third syntax element indicates one of the following: a KLT pair used for a horizontal transform and a vertical transform for the current video block, a KLT used for the horizontal transform for the current video block, or a KLT used for the vertical transform for the current video block.

Clause 57. The method of any of clauses 54-56, wherein the third syntax element is signaled for both non-KLT transform and KLT transform.

Clause 58. The method of clause 57, wherein the third syntax element comprises an index, index 0 to 1 indicate a DCT2-DCT2 pair and a transform skip, and index 2 to N indicate a non-DCT2-DCT2 pairs and a non-transform skip pairs including combinations of non-KLT and KLT, and N is an integer.

Clause 59. The method of any of clauses 54-58, wherein at least one of the following is absent from the bitstream: an intra MTS index for the current video block, or an inter MTS index for the current video block.

Clause 60. The method of any of clauses 1-59, wherein a coded bin of a syntax element related to the method is context coded or bypass coded.

Clause 61. The method of any of clauses 1-60, wherein the conversion includes encoding the current video block into the bitstream.

Clause 62. The method of any of clauses 1-60, wherein the conversion includes decoding the current video block from the bitstream.

Clause 63. An apparatus for video processing comprising a processor and a non-transitory memory with instructions thereon, wherein the instructions upon execution by the processor, cause the processor to perform a method in accordance with any of clauses 1-35.

Clause 64. A non-transitory computer-readable storage medium storing instructions that cause a processor to perform a method in accordance with any of clauses 1-35.

Clause 65. A non-transitory computer-readable recording medium storing a bitstream of a video which is generated by a method performed by an apparatus for video processing, wherein the method comprises: obtaining an intra mode for a current video block of the video, the intra mode being determined based on at least one of the following: information associated with neighboring samples of the current video block, or a prediction associated with the current video block; applying a transform process on the current video block based on the intra mode; and generating the bitstream based on the applying.

Clause 66. A method for storing a bitstream of a video, comprising: obtaining an intra mode for a current video block of the video, the intra mode being determined based on at least one of the following: information associated with neighboring samples of the current video block, or a prediction associated with the current video block; applying a transform process on the current video block based on the intra mode; generating the bitstream based on the applying; and storing the bitstream in a non-transitory computer-readable recording medium.

Clause 67. A non-transitory computer-readable recording medium storing a bitstream of a video which is generated by a method performed by an apparatus for video processing, wherein the method comprises: obtaining information regarding applying a Karhunen-Loeve transform (KLT) on a current video block of the video, the information being dependent on transform coefficients of the current video block; and generating the bitstream based on the information.

Clause 68. A method for storing a bitstream of a video, comprising: obtaining information regarding applying a Karhunen-Loeve transform (KLT) on a current video block of the video, the information being dependent on transform coefficients of the current video block; generating the bitstream based on the information; and storing the bitstream in a non-transitory computer-readable recording medium.

### Example Device

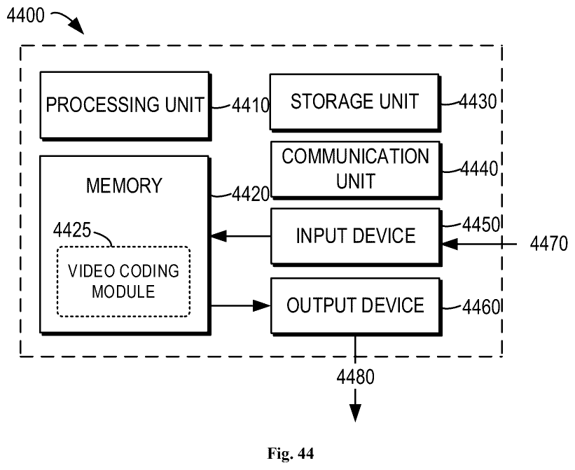

FIG. 44 illustrates a block diagram of a computing device 4400 in which various embodiments of the present disclosure can be implemented. The computing device 4400 may be implemented as or included in the source device 110 (or the video encoder 114 or 200) or the destination device 120 (or the video decoder 124 or 300).

It would be appreciated that the computing device 4400 shown in FIG. 44 is merely for purpose of illustration, without suggesting any limitation to the functions and scopes of the embodiments of the present disclosure in any manner.

As shown in FIG. 44, the computing device 4400 includes a general-purpose computing device 4400. The computing device 4400 may at least comprise one or more processors or processing units 4410, a memory 4420, a storage unit 4430, one or more communication units 4440, one or more input devices 4450, and one or more output devices 4460.

In some embodiments, the computing device 4400 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 4400 can support any type of interface to a user (such as “wearable” circuitry and the like).

The processing unit 4410 may be a physical or virtual processor and can implement various processes based on programs stored in the memory 4420. In a multi-processor system, multiple processing units execute computer executable instructions in parallel so as to improve the parallel processing capability of the computing device 4400. The processing unit 4410 may also be referred to as a central processing unit (CPU), a microprocessor, a controller or a microcontroller.

The computing device 4400 typically includes various computer storage medium. Such medium can be any medium accessible by the computing device 4400, including, but not limited to, volatile and non-volatile medium, or detachable and non-detachable medium. The memory 4420 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 4430 may be any detachable or non-detachable medium and may include a machine-readable medium such as a memory, flash memory drive, magnetic disk or another other media, which can be used for storing information and/or data and can be accessed in the computing device 4400.

The computing device 4400 may further include additional detachable/non-detachable, volatile/non-volatile memory medium. Although not shown in FIG. 44, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 4440 communicates with a further computing device via the communication medium. In addition, the functions of the components in the computing device 4400 can be implemented by a single computing cluster or multiple computing machines that can communicate via communication connections. Therefore, the computing device 4400 can operate in a networked environment using a logical connection with one or more other servers, networked personal computers (PCs) or further general network nodes.

The input device 4450 may be one or more of a variety of input devices, such as a mouse, keyboard, tracking ball, voice-input device, and the like. The output device 4460 may be one or more of a variety of output devices, such as a display, loudspeaker, printer, and the like. By means of the communication unit 4440, the computing device 4400 can further communicate with one or more external devices (not shown) such as the storage devices and display device, with one or more devices enabling the user to interact with the computing device 4400, or any devices (such as a network card, a modem and the like) enabling the computing device 4400 to communicate with one or more other computing devices, if required. Such communication can be performed via input/output (I/O) interfaces (not shown).

In some embodiments, instead of being integrated in a single device, some or all components of the computing device 4400 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 4400 may be used to implement video encoding/decoding in embodiments of the present disclosure. The memory 4420 may include one or more video coding modules 4425 having one or more program instructions. These modules are accessible and executable by the processing unit 4410 to perform the functionalities of the various embodiments described herein.

In the example embodiments of performing video encoding, the input device 4450 may receive video data as an input 4470 to be encoded. The video data may be processed, for example, by the video coding module 4425, to generate an encoded bitstream. The encoded bitstream may be provided via the output device 4460 as an output 4480.

In the example embodiments of performing video decoding, the input device 4450 may receive an encoded bitstream as the input 4470. The encoded bitstream may be processed, for example, by the video coding module 4425, to generate decoded video data. The decoded video data may be provided via the output device 4460 as the output 4480.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
obtaining, for a conversion between a current video block of a video and a bitstream of the video, an intra mode for the current video block, the intra mode being determined based on at least one of the following:
information associated with neighboring samples of the current video block, or
a prediction associated with the current video block;
applying a transform process on the current video block based on the intra mode; and
performing the conversion based on the applying.

2. The method of claim 1, wherein the prediction associated with the current video block comprises a prediction of the current video block or a prediction of template samples of the current video block.

3. The method of claim 1, wherein the intra mode is determined based on the prediction associated with the current video block, and the transform process comprises at least one of a primary transform or a secondary transform, or
wherein the intra mode is determined based on the prediction associated with the current video block, and the current video block is coded with at least one of the following:
an intra template matching mode,
a matrix weighted intra prediction (MIP) mode,
an intra sub-partitions (ISP) mode,
a mode where a prediction is blended from at least one intra mode and another mode,
a template-based intra mode derivation (TIMD) blended mode,
a decoder-side intra mode derivation (DIMD) blended mode,
a geometric partitioning mode (GPM) intra mode,
a split GPM mode,
a combined inter and intra prediction (CIIP) mode,
a multi-hypothesis prediction (MHP) with intra mode blending,
a screen content coding tool with intra mode blending,
a planar mode,
a planar horizontal mode,
a planar vertical mode,
a cross-component linear model (CCLM) mode,
a convolutional cross-component model (CCCM) mode,
a gradient-based linear model (GLM) mode, or
a chroma intra mode with a mode index greater than a predetermined number which denotes an angular intra mode.

4. The method of claim 1, wherein the intra mode is determined based on the information associated with neighboring samples of the current video block, and the transform process comprises at least one of a luma transform process or a chroma transform process.

5. The method of claim 4, wherein the luma transform process comprises at least one of a primary transform on luma components or a secondary transform on luma components, or
wherein the chroma transform process comprises at least one of the following:
a primary transform on chroma components in a single-tree case,
a primary transform on chroma components in a dual-tree case,
a secondary transform on chroma components in a single-tree case, or
a secondary transform on chroma components in a dual-tree case.

6. The method of claim 1, wherein the neighboring samples comprises a template including above neighboring samples and/or left neighboring samples of the current video block.

7. The method of claim 6, wherein the information associated with the neighboring samples of the current video block comprises at least one of the following: a gradient of samples in the template, or the largest histogram amplitude value determined based on gradients of samples in the template, or
wherein the intra mode is determined from a set of intra mode candidates based on the template.

8. The method of claim 1, wherein a DIMD-based scheme or a TIMD-based scheme is used to determine the intra mode, or
wherein information regarding at least one of the following is dependent on a multiple reference line index or pre-defined: the number of rows of neighboring samples used for determining the intra mode, the number of columns of neighboring samples used for determining the intra mode, or neighboring samples used for determining the intra mode, or
wherein different rows of neighboring samples are associated with different weights for cost calculation, or different columns of neighboring samples are associated with different weights for cost calculation, or
wherein the intra mode is determined based on the information associated with neighboring samples of the current video block, and the current video block is coded with at least one of the following:
an intra template matching mode,
an MIP mode,
an ISP mode,
a mode where a prediction is blended from at least one intra mode and another mode,
a TIMD blended mode,
a DIMD blended mode,
a GPM intra mode,
a split GPM mode,
a CIIP mode,
an MHP with intra mode blending,
a screen content coding tool with intra mode blending,
a planar mode,
a planar horizontal mode, or
a planar vertical mode.

9. The method of claim 1, wherein the intra mode is used for determining at least one of the following: a multiple transform selection (MTS) transform class index, an MTS transform pair index, an MTS transform index, a low-frequency non-separable transform (LFNST) transform set index, or an LFNST transpose flag, or
wherein the current video block is coded with an MIP mode, and at least one of the following is selected for the current video block based on the intra mode: an intra MTS transform class, a transform pair, or a transform set, or
wherein the current video block is coded with an MIP mode, and the intra mode is determined based on at least one of the following: a horizontal gradient or a vertical gradient of samples of a prediction for the current video block, the largest histogram amplitude value determined based on gradients of the current video block, or neighboring samples values of the current video block.

10. The method of claim 1, wherein the current video block is coded with an intra template matching mode, and at least one of the following is selected for the current video block based on the intra mode:
an LFNST transform set,
an LFNST transpose flag,
an MTS transform set,
an MTS transform class, or
an MTS transform pair.

11. The method of claim 10, wherein the intra mode is determined based on at least one of the following:
prediction samples of the current video block,
a horizontal gradient of prediction samples of the current video block,
a vertical gradient of prediction samples of the current video block,
the largest histogram amplitude value determined based on gradients of the current video block,
neighboring samples values of the current video block,
an intra mode of a reference video block for the current video block,
gradients of the reference video block,
an angular of a block vector for the current video block,
an angular of a motion vector for the current video block, or
intra mode information stored in a history-based intra mode buffer for the current video block.

12. The method of claim 1, wherein an intra mode for a further video block of the video different from the current video block is pre-defined, or
wherein the current video block is coded with an intra template matching, and an MTS index for the current video block is indicated in the bitstream.

13. The method of claim 1, wherein the current video block is coded with an intra template matching mode, and an MTS kernel is applied on the current video block.

14. The method of claim 13, wherein the MTS kernel is determined based on at least one of the following: the intra mode, a shape of the current video block, a size of the current video block, a dimension of the current video block, a width of the current video block, a height of the current video block, or values of transform coefficients of the current video block, or
wherein no syntax element is signaled for the MTS kernel.

15. The method of claim 1, wherein the current video block is coded with an intra template matching mode, and a Karhunen-Loeve transform (KLT) is applied on the current video block, or
wherein the current video block is coded with an intra template matching mode, and primary transform kernels in addition to discrete cosine transform type 2 (DCT2) is disabled for the current video block, or
wherein the current video block is coded with a TIMD blended mode, and at least one of the following is determined based on final prediction samples of the current video block: an intra MTS transform class of the TIMD blended mode, an intra MTS transform pair of the TIMD blended mode, an LFNST transform set of the TIMD blended mode, or an LFNST transpose flag of the TIMD blended mode, or
wherein the current video block is coded with a DIMD blended mode, and at least one of the following is determined based on final prediction samples of the current video block: an intra MTS transform class of the DIMD blended mode, an intra MTS transform pair of the DIMD blended mode, an LFNST transform set of the DIMD blended mode, or an LFNST transpose flag of the DIMD blended mode, or
wherein at least one of the following is determined based on final prediction samples of the current video block: an intra MTS transform class of a planar mode, an intra MTS transform pair of a planar mode, an LFNST transform set of a planar mode, or an LFNST transpose flag of a planar mode, or
wherein at least one of the following is determined based on further information associated with neighboring samples of the current video block: an intra MTS transform class, an intra MTS transform pair, an LFNST transform set, or an LFNST transpose flag, or
wherein at least one of the following is determined based on a pre-defined mode: an intra MTS transform class, an intra MTS transform pair, an LFNST transform set, or an LFNST transpose flag.

16. The method of claim 1, wherein a coded bin of a syntax element related to the method is context coded or bypass coded.

17. The method of claim 1, wherein the conversion includes encoding the current video block into the bitstream, or
wherein the conversion includes decoding the current video block from the bitstream.

18. An apparatus for video processing comprising a processor and a non-transitory memory with instructions thereon, wherein the instructions upon execution by the processor, cause the processor to perform acts comprising:
obtaining, for a conversion between a current video block of a video and a bitstream of the video, an intra mode for the current video block, the intra mode being determined based on at least one of the following:
information associated with neighboring samples of the current video block, or
a prediction associated with the current video block;
applying a transform process on the current video block based on the intra mode; and
performing the conversion based on the applying.

19. A non-transitory computer-readable storage medium storing instructions that cause a processor to perform acts comprising:
obtaining, for a conversion between a current video block of a video and a bitstream of the video, an intra mode for the current video block, the intra mode being determined based on at least one of the following:
information associated with neighboring samples of the current video block, or
a prediction associated with the current video block;
applying a transform process on the current video block based on the intra mode; and
performing the conversion based on the applying.

20. A non-transitory computer-readable recording medium storing a bitstream of a video which is generated by a method performed by an apparatus for video processing, wherein the method comprises:
obtaining an intra mode for a current video block of the video, the intra mode being determined based on at least one of the following:
information associated with neighboring samples of the current video block, or
a prediction associated with the current video block;
applying a transform process on the current video block based on the intra mode; and
generating the bitstream based on the applying.
